(19) United States
(12) Patent Application Publication
(10) Pub. No.: US 2022/0154953 A1
(43) Pub. Date: May 19, 2022

(54) AIR PURIFIER SYSTEMS AND METHODS

(71) Applicant: ICON INTEGRATED CONCEPTS LLC, Wilmington, DE (US)

(72) Inventors: Richard Herskovitz, Philadelphia, PA (US); Michael Herskovitz, Philadelphia, PA (US)

(73) Assignee: ICON INTEGRATED CONCEPTS LLC, Wilmington, DE (US)

(21) Appl. No.: 17/531,141

(22) Filed: Nov. 19, 2021

Related U.S. Application Data
(60) Provisional application No. 63/115,816, filed on Nov. 19, 2020.

(51) Int. Cl. F24F 8/108; F24F 8/22; F24F 11/52

(52) U.S. Cl. CPC F24F 8/108; F24F 2110/50; F24F 11/52; F24F 8/22

(57) ABSTRACT

Exemplary embodiments are directed to an air purifier system. The air purifier system includes a housing, a light source disposed within the housing, and an air guide positioned around the light source. The housing includes at least one intake opening and at least one outlet opening. The light source defines a light source length and is configured to emit light of a wavelength capable of killing pathogens in air passing the light source. The air guide redirects flow of air around the light source in a pathway having a length longer than the light source length.

### CROSS-REFERENCE TO RELATED APPLICATIONS

The present application claims the benefit of priority to U.S. Provisional Application No. 63/115,816, filed Nov. 19, 2020, which is hereby incorporated by reference in its entirety.

### TECHNICAL FIELD

The present disclosure relates generally to systems and methods for purifying air. More specifically, the present disclosure relates to air purifier systems and methods that ventilate air within a given space and simultaneously purify the air in an efficient and effective manner.

### BACKGROUND

Droplets or particles released into the air as individuals exhale can transmit a virus capable of infecting others in the surrounding space. Such viral transmission has been particularly problematic and of concern during the SARS-CoV-2 outbreak. Traditional air purifiers attempt to address such viral transmission by incorporating an air purifier and/or a ultraviolet light (e.g., a UV-C light) for disinfecting the air as it passes through the purifier. In general, such traditional air purifiers initially filter the air for both large and small particles. If an ultraviolet light is used, the air or particles in the air may never come in contact with the UV-C lamp, not all particles in the air may be exposed to the UV-C light, or the UV-C bulbs may lack the strength, the proper wavelength, and/or may not have sufficient dwell time to effectively kill the virus. Thus, traditional air purifiers depend primarily on filtration rather than the germicidal effects of the UV-C lamp to purify the air. However, because air filters cannot effectively capture all viral particles, the air output by traditional air purifiers cannot effectively purify the air. This results in a continued risk of viral transmission even after the air has passed through the air purifier.

### SUMMARY

In accordance with embodiments of the present disclosure, an exemplary air purifier system is provided. The air purifier system includes a housing, a light source disposed within the housing, and an air guide positioned around the light source. The housing includes at least one intake opening and at least one outlet opening. The light source defines a light source length and is configured to emit light of a wavelength capable of killing pathogens in air passing the light source. The air guide redirects flow of air around the light source in a pathway having a length longer than the light source length.

The at least one intake opening and the at least one outlet opening can be an array of circular openings, an array of rectangular openings, an array of elongated slots, an individual circular opening, or an individual rectangular opening. The light source can be an ultraviolet (UV-C) lamp or a light-emitting diode (LED). In some embodiments, the wavelength can be about, e.g., 253-280 nm inclusive, 254-280 nm inclusive, 255-280 nm inclusive, 256-280 nm inclusive, 257-280 nm inclusive, 258-280 nm inclusive, 259-280 nm inclusive, 260-280 nm inclusive, 261-280 nm inclusive, 262-280 nm inclusive, 263-280 nm inclusive, 264-280 nm inclusive, 265-280 nm inclusive, 266-280 nm inclusive, 270-280 nm inclusive, 271-280 nm inclusive, 272-280 nm inclusive, 273-280 nm inclusive, 274-280 nm inclusive, 275-280 nm inclusive, 276-280 nm inclusive, 277-280 nm inclusive, 278-280 nm inclusive, 279-280 nm inclusive, 253-279 nm inclusive, 253-278 nm inclusive, 253-277 nm inclusive, 253-276 nm inclusive, 253-275 nm inclusive, 253-274 nm inclusive, 253-273 nm inclusive, 253-272 nm inclusive, 253-271 nm inclusive, 253-270 nm inclusive, 253-269 nm inclusive, 253-268 nm inclusive, 253-267 nm inclusive, 253-266 nm inclusive, 253-265 nm inclusive, 253-264 nm inclusive, 253-263 nm inclusive, 253-262 nm inclusive, 253-261 nm inclusive, 253-260 nm inclusive, 253-259 nm inclusive, 253-258 nm inclusive, 253-257 nm inclusive, 253-256 nm inclusive, 253-255 nm inclusive, 253-254 nm inclusive, 260-280 nm inclusive, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, or the like. In some embodiments, the UV-C light source can provide a wavelength of about 253 or 254 nm, and the LED light source can provide a wavelength of about 265-280 nm, inclusive. The system can include a high efficiency particle air (HEPA) filter or a minimum efficiency reporting value (MERV-13) filter disposed within the housing. The system can include a fan disposed within the housing and configured to draw the air into the housing through the at least one intake opening, and output purified air out of the at least one outlet opening. The system can include a rechargeable power source for operating the light source. In some embodiments, the system can include one or more microwave emitters configured to emit microwaves in the housing at a frequency capable of killing the pathogens in the air passing through the housing.

In some embodiments, the air guide can be one or two continuous helical ramps surrounding the light source, the air guide extending along the light source length from one end to the opposing end. In such embodiments, the pathway created by the air guide can be a helical pathway. In such embodiments, the two continuous helical ramps can form a clockwise helical pathway and a counterclockwise helical pathway around the light source.

In some embodiments, the air guide can be a first set of baffles extending in a spaced manner from one inner wall of the housing, and a second set of baffles extending in a spaced manner from an opposing inner wall of the housing, the first and second set of baffles staggered around the light source along the light source length. In some embodiments, the air guide can include a first air guide half and a second air guide half positioned on opposing sides of the light source, each of the first and second air guide halves including a body with a cutout configured to at least partially receive the light source, a cut extending from the cutout, and a bend line for bending of the first and second air guide halves.

In some embodiments, the housing can include a door capable of being removed or pivoted to expose the light source and air guide. In some embodiments, the air guide can be internal walls within the housing defining a serpentine pathway for airflow within the housing. In some embodiments, the light guide can be inclined planes or deflectors radially spaced around the light source, the inclined planes or deflectors creating turbulent flow of air around the light source.

In some embodiments, the light source can include four light sources and the air guide can include four air guides positioned around the respective light source, the four light sources and air guides oriented at about 90 degrees relative to each other within the housing. The housing can be configured to be installed (i) within a heating, air conditioning and ventilation (HVAC) unit, (ii) within ductwork, (iii) within a ceiling, (iv) against a ceiling, (v) within a light fixture, (vi) within a wall, (vii) against a corner, (viii) at least partially under a table, or (ix) as a freestanding unit on a floor or table.

In accordance with embodiments of the present disclosure, an exemplary method of purifying air is provided. The method includes drawing air into an air purifier system through at least one intake opening of a housing. The air purifier system includes at least one outlet opening formed in the housing, a light source disposed within the housing, the light source defining a light source length, and an air guide positioned around the light source. The method includes emitting light from the light source of a wavelength capable of killing pathogens in the air passing the light source. The method includes redirecting flow of the air around the light source with the air guide in a pathway having a length longer than the light source length.

The method can include drawing air into and through the air purifier system with a fan. In some embodiments, the air guide can be one or two continuous helical ramps surrounding the light source, and the method can include creating a helical pathway of air around the light source. In some embodiments, the air guide can be inclined planes or deflectors radially spaced around the light source, and the method can include creating turbulent flow of air around the light source.

Other features and advantages will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed air purifier systems and methods, reference is made to the accompanying figures, wherein:

FIG. 1 is a perspective, partial cutaway view of an exemplary air purifier system in the form of a portable and/or tabletop battery powered unit in accordance with the present disclosure;

FIG. 2 is a side view of an exemplary purifier system of FIG. 1;

FIG. 3 is a side view of an exemplary purifier system of FIG. 1;

FIG. 4 is a top view of an exemplary purifier system of FIG. 1;

FIG. 5 is a perspective view of an exemplary air purifier system in the form of a portable and/or tabletop battery powered unit in accordance with the present disclosure;

FIG. 6 is a perspective, partial cutaway view of an exemplary air purifier system of FIG. 5;

FIG. 7 is a perspective view of an exemplary air purifier system in the form of a portable and/or tabletop battery powered unit in accordance with the present disclosure;

FIG. 8 is a perspective, partial cutaway view of an exemplary air purifier system of FIG. 7;

FIG. 9 is a perspective view of an exemplary air purifier system in the form of a portable and/or tabletop battery powered unit in accordance with the present disclosure;

FIG. 10 is a perspective, transparent view of an exemplary air purifier system of FIG. 9;

FIG. 11 is a perspective view of internal components of an exemplary air purifier system of FIG. 9;

FIG. 12 is a perspective view of internal components and airflow pathway of an exemplary air purifier system of FIG. 9;

FIG. 13 is a cross-sectional view of an exemplary air purifier system in the form of a room unit in accordance with the present disclosure;

FIG. 14 is a perspective view of an exemplary air purifier system of FIG. 13;

FIG. 15 is a top view of an exemplary air purifier system of FIG. 13;

FIG. 16 is a cross-sectional view of an exemplary air purifier system of FIG. 13;

FIG. 17 is a perspective view of internal components of an exemplary air purifier system of FIG. 13;

FIG. 18 is a side view of a helical pathways of an exemplary air purifier system of FIG. 13;

FIG. 19 is a perspective view of an exemplary air purifier system in the form of a ductwork insert in accordance with the present disclosure;

FIG. 20 is a perspective, transparent view of an exemplary air purifier system of FIG. 19;

FIG. 21 is a perspective view of internal components of an exemplary air purifier system of FIG. 19;

FIG. 22 is a perspective view of helical pathways of an exemplary air purifier system of FIG. 19;

FIG. 23 is a perspective view of an exemplary air purifier system in the form of a ductwork insert in accordance with the present disclosure;

FIG. 24 is a perspective, cross-sectional view of an exemplary air purifier system of FIG. 23;

FIG. 25 is a top, cross-sectional view of an exemplary air purifier system of FIG. 23;

FIG. 26 is a perspective, cross-sectional view of an exemplary air purifier system of FIG. 23;

FIG. 27 is a perspective view of curved or serpentine pathways of an exemplary air purifier system of FIG. 23;

FIG. 28 is a perspective view of an exemplary air purifier system in the form of a ductwork insert in accordance with the present disclosure;

FIG. 29 is a perspective, partial view of an exemplary purifier system of FIG. 28;

FIG. 30 is a top, cross-sectional view of an exemplary purifier system of FIG. 28;

FIG. 31 is a perspective view of internal components of an exemplary purifier system of FIG. 28;

FIG. 32 is a perspective view of an unfolded air guide of an exemplary purifier system of FIG. 28;

FIG. 33 is a perspective view of a folded air guide of an exemplary purifier system of FIG. 28;

FIG. 34 is a perspective, cross-sectional view of an exemplary air purifier system in the form of a ductwork insert in accordance with the present disclosure;

FIG. 35 is a perspective view of internal components of an exemplary purifier system of FIG. 34;

FIG. 36 is a perspective view of internal components of an exemplary purifier system of FIG. 34;

FIG. 37 is a perspective view of a curved pathways of an exemplary purifier system of FIG. 34;

FIG. 38 is a perspective view of an unfolded air guide of an exemplary purifier system of FIG. 34;

FIG. 39 is a perspective view of an unfolded air guide of an exemplary purifier system of FIG. 34;

FIG. 40 is a perspective view of a folded air guide of an exemplary purifier system of FIG. 34;

FIG. 41 is a perspective view of an exemplary air purifier system in the form of a ductwork insert in accordance with the present disclosure;

FIG. 42 is a perspective, cross-sectional view of an exemplary air purifier of FIG. 41;

FIG. 43 is a perspective, transparent view of internal components of an exemplary air purifier of FIG. 41;

FIG. 44 is a perspective view of internal components of an exemplary air purifier of FIG. 41;

FIG. 45 is a perspective view of helical pathways of an exemplary air purifier of FIG. 41;

FIG. 46 is a perspective view of an exemplary air purifier system in the form of a portable unit in accordance with the present disclosure;

FIG. 47 is a perspective view of an exemplary air purifier system of FIG. 46;

FIG. 48 is a perspective, cross-sectional view of an exemplary air purifier system of FIG. 46;

FIG. 49 is a perspective, cross-sectional view of an exemplary air purifier system of FIG. 46;

FIG. 50 is a perspective view of an exemplary air purifier system in the form of a portable unit in accordance with the present disclosure;

FIG. 51 is a perspective, cross-sectional view of an exemplary air purifier system of FIG. 50;

FIG. 52 is a top, cross-sectional view of an exemplary air purifier system of FIG. 50;

FIG. 53 is a perspective, partial view of an exemplary air purifier system in the form of an in-ceiling unit in accordance with the present disclosure;

FIG. 54 is a perspective, partial view of an exemplary air purifier system of FIG. 53;

FIG. 55 is a top view of an exemplary air purifier system of FIG. 53;

FIG. 56 is a perspective, partial view of an exemplary air purifier system in the form of an in-ceiling unit in accordance with the present disclosure;

FIG. 57 is a perspective, partial view of an exemplary air purifier system of FIG. 56;

FIG. 58 is a perspective view of an exemplary air purifier system of FIG. 56;

FIG. 59 is a perspective view of an exemplary air purifier system of FIG. 56;

FIG. 60 is a bottom view of an exemplary air purifier system of FIG. 56;

FIG. 61 is a side view of an exemplary air purifier system of FIG. 56;

FIG. 62 is a perspective, partial view of an exemplary air purifier system in the form of an in-ceiling unit in accordance with the present disclosure;

FIG. 63 is a perspective, cross-sectional view of an exemplary air purifier system of FIG. 62;

FIG. 64 is a perspective, cross-sectional view of an exemplary air purifier system of FIG. 62;

FIG. 65 is a perspective, cross-sectional view of an exemplary air purifier system of FIG. 62;

FIG. 66 is a perspective view of an exemplary air purifier system in the form of a below ceiling unit in accordance with the present disclosure;

FIG. 67 is a perspective view of an exemplary air purifier system of FIG. 66;

FIG. 68 is a perspective view of an exemplary air purifier system of FIG. 66;

FIG. 69 is a perspective, cross-sectional view of an exemplary air purifier system of FIG. 66;

FIG. 70 is a perspective, cross-sectional view of an exemplary air purifier system of FIG. 66;

FIG. 71 is a side, cross-sectional view of an exemplary air purifier system in the form of a below ceiling unit in accordance with the present disclosure;

FIG. 72 is a perspective view of an exemplary air purifier system of FIG. 71;

FIG. 73 is a perspective view of an exemplary air purifier system of FIG. 71;

FIG. 74 is a perspective, cross-sectional view of one version of a purification section of an exemplary air purifier system of FIG. 71;

FIG. 75 is a top, cross-sectional view of an exemplary air purifier system of FIG. 74;

FIG. 76 is a perspective, cross-sectional view of another version of a purification section of an exemplary air purifier system of FIG. 71;

FIG. 77 is a top, cross-sectional view of an exemplary air purifier system of FIG. 76;

FIG. 78 is a side view of an exemplary air purifier system of FIG. 71;

FIG. 79 is a perspective view of an exemplary air purifier system in the form of a below ceiling unit in accordance with the present disclosure;

FIG. 80 is a perspective, exploded view of an exemplary air purifier system of FIG. 79;

FIG. 81 is a perspective, cross-sectional view of an exemplary air purifier system of FIG. 79;

FIG. 82 is a perspective, cross-sectional view of an exemplary air purifier system of FIG. 79;

FIG. 83 is a top, cross-sectional view of an exemplary air purifier system of FIG. 79;

FIG. 84 is a perspective, partial view of an exemplary air purifier system of FIG. 79;

FIG. 85 is a perspective view of an exemplary air purifier system in the form of a standalone unit in accordance with the present disclosure;

FIG. 86 is a front view of an exemplary air purifier system of FIG. 85;

FIG. 87 is a perspective, cross-sectional view of an exemplary air purifier system of FIG. 85;

FIG. 88 is a perspective, partial view of an exemplary air purifier system of FIG. 85;

FIG. 89 is a perspective view of an exemplary air purifier system in the form of an in-wall unit in accordance with the present disclosure;

FIG. 90 is a perspective view of an exemplary air purifier system of FIG. 89;

FIG. 91 is a perspective view of an exemplary air purifier system of FIG. 89;

FIG. 92 is a perspective view of an exemplary air purifier system of FIG. 89;

FIG. 93 is a perspective view of an exemplary air purifier system in the form of a standalone unit in accordance with the present disclosure;

FIG. 94 is a perspective, partial view of an exemplary air purifier system of FIG. 93;

FIG. 95 is a top view of an exemplary air purifier system of FIG. 93;

FIG. 96 is a perspective, partial view of an exemplary air purifier system of FIG. 93;

FIG. 97 is a perspective, cross-sectional view of an exemplary air purifier system of FIG. 93;

FIG. 98 is a perspective, partial view of an exemplary air purifier system of FIG. 93;

FIG. 99 is a perspective view of a purification chamber of an exemplary air purifier system of FIG. 93;

FIG. 100 is a perspective, partial view of a purification chamber of FIG. 99;

FIG. 101 is a perspective, partial view of a purification chamber of FIG. 99;

FIG. 102 is a perspective, partial view of view of a purification chamber of FIG. 99;

FIG. 103 is a perspective view of an exemplary air purifier system in the form of a vertical, large room unit in accordance with the present disclosure;

FIG. 104 is a perspective, partial view of an exemplary air purifier system of FIG. 103;

FIG. 105 is a side, partial view of an exemplary air purifier system of FIG. 103;

FIG. 106 is a perspective, partial view of an exemplary air purifier system of FIG. 103;

FIG. 107 is a top view of an exemplary air purifier system of FIG. 103;

FIG. 108 is a top, partial view of an exemplary air purifier system of FIG. 103;

FIG. 109 is a top, cross-sectional view of an exemplary air purifier system of FIG. 103;

FIG. 110 is a perspective, partial view of an exemplary air purifier system of FIG. 103;

FIG. 111 is a perspective, partial view of an exemplary air purifier system of FIG. 103;

FIG. 112 is a side, partial view of an exemplary air purifier system of FIG. 103;

FIG. 113 is a side view of helical pathways of an exemplary air purifier system of FIG. 103;

FIG. 114 is a perspective view of an exemplary air purifier system in the form of a corner unit in accordance with the present disclosure;

FIG. 115 is a perspective, partial view of an exemplary air purifier system of FIG. 114;

FIG. 116 is a perspective, partial view of an exemplary air purifier system of FIG. 114;

FIG. 117 is a side, partial view of an exemplary air purifier system of FIG. 114;

FIG. 118 is a perspective, partial view of an exemplary air purifier system of FIG. 114;

FIG. 119 is a perspective view of a helical pathway of an exemplary air purifier system of FIG. 114;

FIG. 120 is a top, cross-sectional view of an exemplary air purifier system of FIG. 114;

FIG. 121 is a perspective view of an exemplary air purifier system in the form of a corner unit in accordance with the present disclosure;

FIG. 122 is a perspective, partial view of an exemplary air purifier system of FIG. 121;

FIG. 123 is a side, partial view of an exemplary air purifier system of FIG. 121;

FIG. 124 is a top, cross-sectional view of an exemplary air purifier system of FIG. 121;

FIG. 125 is a perspective view of an exemplary air purifier system in the form of an under table unit in accordance with the present disclosure;

FIG. 126 is a top view of an exemplary air purifier system of FIG. 125;

FIG. 127 is a side view of an exemplary air purifier system of FIG. 125;

FIG. 128 is a front view of an exemplary air purifier system of FIG. 125;

FIG. 129 is a perspective, transparent view of an exemplary air purifier system of FIG. 125;

FIG. 130 is a side, cross-sectional view of an exemplary air purifier system of FIG. 125;

FIG. 131 is a top, cross-sectional view of an exemplary air purifier system of FIG. 125;

FIG. 132 is a side, cross-sectional view of an exemplary air purifier system of FIG. 125;

FIG. 133 is a top, cross-sectional view of an exemplary air purifier system of FIG. 125;

FIG. 134 is a side, cross-sectional view of an exemplary air purifier system of FIG. 125;

FIG. 135 is a top, partial view of an exemplary air purifier system of FIG. 125;

FIG. 136 is a top, partial view of an exemplary air purifier system of FIG. 125;

FIG. 137 is a top, partial view of helical pathways of an exemplary air purifier system of FIG. 125;

FIG. 138 a front view of an exemplary air purifier system of FIG. 125;

FIG. 139 is a top view of an unfolded air guide of an exemplary air purifier system of FIG. 125;

FIG. 140 is a side view of a folded air guide of an exemplary air purifier system of FIG. 125;

FIG. 141 is a side view of helical pathways of an exemplary air purifier system of FIG. 125;

FIG. 142 is a perspective, cross-sectional view of an exemplary air purifier system of FIG. 125;

FIG. 143 is a perspective, cross-sectional view of an exemplary air purifier system of FIG. 125;

FIG. 144 is a perspective, partial view of an exemplary air purifier system of FIG. 125;

FIG. 145 is a perspective, partial view of an exemplary air purifier system of FIG. 125;

FIG. 146 is a perspective view of helical pathways of an exemplary air purifier system of FIG. 125;

FIG. 147 is a perspective view of an exemplary air purifier system in the form of an over table unit in accordance with the present disclosure;

FIG. 148 is a perspective, transparent view of an exemplary air purifier system of FIG. 147;

FIG. 149 is a side view of an exemplary air purifier system of FIG. 147;

FIG. 150 is a perspective, partial view of an exemplary air purifier system of FIG. 147;

FIG. 151 is a perspective, cross-sectional view of an exemplary air purifier system of FIG. 147;

FIG. 152 is a perspective, partial view of an exemplary air purifier system of FIG. 147;

FIG. 153 is a perspective, partial view of an exemplary air purifier system of FIG. 147;

FIG. 154 is a top, partial view of an exemplary air purifier system of FIG. 147;

FIG. 155 is a perspective, partial view of an exemplary air purifier system of FIG. 147;

FIG. 156 is a perspective view of an exemplary air purifier system in the form of a high output unit in accordance with the present disclosure;

FIG. 158 is a front view of an exemplary air purifier system of FIG. 157;

FIG. 159 is a perspective, partial view of an exemplary air purifier system of FIG. 157;

FIG. 160 is a front, partial view of an exemplary air purifier system of FIG. 157;

FIG. 161 is a perspective, partial view of an exemplary air purifier system of FIG. 157;

FIG. 162 is a top, partial view of an exemplary air purifier system of FIG. 157;

FIG. 163 is a perspective, partial view of an exemplary air purifier system of FIG. 157;

FIG. 164 is a perspective view of a helical pathway of an exemplary air purifier system of FIG. 157;

FIG. 165 is a side, partial view of an exemplary air purifier system of FIG. 157;

FIG. 166 is a top, partial view of an exemplary air purifier system of FIG. 157;

FIG. 167 is a perspective, partial view of an exemplary air purifier system of FIG. 157;

FIG. 168 is a front, partial view of an exemplary air purifier system of FIG. 157;

FIG. 169 is a perspective, partial view of an exemplary air purifier system of FIG. 157;

FIG. 170 is a diagrammatic view of an exemplary air purifier system of FIG. 157 incorporated into an HVAC unit;

FIG. 171 is a diagrammatic view of an exemplary air purifier system of FIG. 157 incorporated into an HVAC unit;

FIG. 172 is a perspective view of an exemplary air purifier system in the form of a standalone unit in accordance with the present disclosure;

FIG. 173 is a perspective, cross-sectional view of an exemplary air purifier system of FIG. 172;

FIG. 174 is a perspective, partial view of an exemplary air purifier system of FIG. 172;

FIG. 175 is a perspective, partial view of an exemplary air purifier system of FIG. 172;

FIG. 176 is a perspective, partial view of an exemplary air purifier system in the form of a standalone or wall mounted unit in accordance with the present disclosure;

FIG. 177 is a perspective, partial view of an exemplary air purifier system of FIG. 176;

FIG. 178 is a perspective view of a static mixer capable of being incorporated into the exemplary air purifier systems in accordance with the present disclosure;

FIG. 179 is a perspective, transparent view of a purification chamber of an exemplary air purifier system with a spiraling airflow pathway in accordance with the present disclosure;

FIG. 180 is a side, transparent view of a purification chamber of FIG. 179;

FIG. 181 is a perspective, transparent view of a purification chamber of FIG. 179;

FIG. 182 is a perspective, partial view of a purification chamber of an exemplary air purifier system with a turbulent airflow pathway in accordance with the present disclosure;

FIG. 183 is a perspective, partial view of a purification chamber of FIG. 182;

FIG. 184 is a perspective, partial view of a purification chamber of FIG. 182;

FIG. 185 is a front view of a purification chamber of FIG. 182;

FIG. 186 is a rear view of a purification chamber of FIG. 182;

FIG. 187 is a perspective, partial view of a purification chamber of FIG. 182; and

FIG. 188 is a side, cross-sectional view of a purification chamber of FIG. 192.

### DETAILED DESCRIPTION

Testing from the Centers for Disease Control and Prevention (CDC) and the American Society of Heating, Refrigerating and Air-Conditioning Engineers (ASHREA) has shown that commonly used Germicidal ultraviolet (UV-C) lamps generate a wavelength of predominantly 254-nm UV radiant energy, which is close to the peak germicidal wavelengths of 265 to 270 nm—both in the UV-C range, as compared to the longer wavelength ultraviolet (UV-A and UV-B) in sunlight. The Germicidal UV (GUV) radiant energy damages nucleic acids (DNA and RNA) by causing mutations that prevent replication, thus leading to the death of virtually all bacteria and inactivation of all viruses—both DNA and RNA types. The nuclei of the SARS-CoV-2 virus is extremely small and can bypass even high efficiency particulate air (HEPA) filters. Thus, HEPA filters on their own fail to provide an effective solution to purifying air from the SARS-CoV-2 virus. Germicidal effectiveness is proportional to the exposure dose (radiant exposure, typically in millijoules per square centimeter, mJ/cm², or joules per square meter, J/m²) which is the product of the dose-rate (irradiance), typically in mW/cm² or W/m² and time (from 1 μs to several hours). At a virus density comparable to that observed in SARS-CoV-2 infection, a UV-C dose of about 3.7 mJ/cm² was found to be sufficient to achieve a 3-log inactivation, and complete inhibition of all viral concentrations was observed with about 16.9 mJ/cm². (See, e.g., PubMed Central, Table 1: ACS Photonics, Overview of Recently Published CoV Inactivation Studies (Oct. 14, 2020)). Traditional systems generally lack effectiveness in sufficiently sanitizing air from pathogens that would provide safe spaces for individuals. Such lack of effectiveness may be due to insufficient radiance, excessive air flow speeds, insufficient dwell time, ineffective wavelengths, or the like, which contribute to a diminished or non-existent efficacy in sterilizing the air.

The exemplary air purifier systems discussed herein include a combination of filtering and UV-C germicidal lamps (i.e., light sources) to achieve improved air purification/sterilization with respect to viral pathogens, including transmission of pathogens associated with SARS-CoV-2. The UV-C germicidal lamps used in the air purifier systems can be, e.g., UV radiant energy light source having a wavelength of about 254 nm, light-emitting diode (LED) light source having a wavelength of about 270 nm, or the like. In some embodiments, the wavelength can be about, e.g., 253-280 nm inclusive, 254-280 nm inclusive, 255-280 nm inclusive, 256-280 nm inclusive, 257-280 nm inclusive, 258-280 nm inclusive, 259-280 nm inclusive, 260-280 nm inclusive, 261-280 nm inclusive, 262-280 nm inclusive, 263-280 nm inclusive, 264-280 nm inclusive, 265-280 nm inclusive, 266-280 nm inclusive, 270-280 nm inclusive, 271-280 nm inclusive, 272-280 nm inclusive, 273-280 nm inclusive, 274-280 nm inclusive, 275-280 nm inclusive, 276-280 nm inclusive, 277-280 nm inclusive, 278-280 nm inclusive, 279-280 nm inclusive, 253-279 nm inclusive, 253-278 nm inclusive, 253-277 nm inclusive, 253-276 nm inclusive, 253-275 nm inclusive, 253-274 nm inclusive, 253-273 nm inclusive, 253-272 nm inclusive, 253-271 nm inclusive, 253-270 nm inclusive, 253-269 nm inclusive, 253-268 nm inclusive, 253-267 nm inclusive, 253-266 nm inclusive, 253-265 nm inclusive, 253-264 nm inclusive, 253-263 nm inclusive, 253-262 nm inclusive, 253-261 nm inclusive, 253-260 nm inclusive, 253-259 nm inclusive, 253-258 nm inclusive, 253-257 nm inclusive, 253-256 nm inclusive, 253-255 nm inclusive, 253-254 nm inclusive, 260-280 nm inclusive, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, or the like. In some embodiments, a Philips UV-C lamp can be used. (See, e.g., Pure Protection, Philips UV-C lamps, 2019). However, it should be understood that any UV-C lamp capable of performing based on the noted characteristics can be used.

The systems control and sterilize/inactivate pathogenic particles by manipulating or controlling variables, such as air path, dwell time, exposure dose, air speed, filtration medium within specialized machines, combinations thereof, or the like. The systems generally incorporate a long air path and dwell time that ensures exposure of all (or substantially all) pathogenic particles to the light source. The long air path is achieved by a variety of air guides incorporated into a purification chamber. It should be understood that the different air guide configurations discussed herein can be interchanged between the systems to achieve effective purification results. With high irradiance, long dwell times due to low circulation velocity, and tight control and minimization of the distance from the light source, the systems are capable of exterminating active pathogens more efficiently and effectively as compared to traditional systems. The improves air purification provided by the exemplary systems meets or exceeds the current CDC and ASHRAE guidelines. In general, the exemplary systems can achieve an exposure dose of about 16.9, rendering about 99.9999% of pathogens inactive after passage through the system. (See, e.g., PubMed Central, Table 1: ACS Photonics, Overview of Recently Published CoV Inactivation Studies (Oct. 14, 2020)).

The air purifier systems disclosed herein all share common and divergent principals to achieve the effective and efficient purification results. Significantly longer air paths along the lamp are created, which results in more UV-C exposure to kill pathogens which are not filtered out of the air. While traditional filter/UV-C machines may have a dwell time of X given their straight air path, the helical or serpentine air path in the disclosed air purifier systems creates dwell times of 2× to 7× in the same space or volume. Such increase in dwell time is achieved using one or more air guides within the purification chamber. The increased travel paths for air particles through the air purifier systems increases the time that the live pathogens are exposed to the UV-C light. The design of the air purifier systems also controls the maximum distance away from the bulb that any air particle can be, ensuring all particles are exposed to the UV-C light source.

The air guide is positioned radially around the light source within the purification chamber. In some embodiments, the angle of the air guide (e.g., the ramp of the air guide) as measured relative to the central longitudinal axis of the light source can be about, e.g., 8-164 degrees inclusive, 10-164 degrees inclusive, 15-164 degrees inclusive, 20-164 degrees inclusive, 25-164 degrees inclusive, 30-164 degrees inclusive, 35-164 degrees inclusive, 40-164 degrees inclusive, 45-164 degrees inclusive, 50-164 degrees inclusive, 55-164 degrees inclusive, 60-164 degrees inclusive, 65-164 degrees inclusive, 70-164 degrees inclusive, 75-164 degrees inclusive, 80-164 degrees inclusive, 85-164 degrees inclusive, 90-164 degrees inclusive, 95-164 degrees inclusive, 100-164 degrees inclusive, 105-164 degrees inclusive, 110-164 degrees inclusive, 115-164 degrees inclusive, 120-164 degrees inclusive, 125-164 degrees inclusive, 130-164 degrees inclusive, 135-164 degrees inclusive, 140-164 degrees inclusive, 145-164 degrees inclusive, 150-164 degrees inclusive, 155-164 degrees inclusive, 160-164 degrees inclusive, 8-160 degrees inclusive, 8-155 degrees inclusive, 8-150 degrees inclusive, 8-145 degrees inclusive, 8-140 degrees inclusive, 8-135 degrees inclusive, 8-130 degrees inclusive, 8-125 degrees inclusive, 8-120 degrees inclusive, 8-115 degrees inclusive, 8-110 degrees inclusive, 8-105 degrees inclusive, 8-100 degrees inclusive, 8-95 degrees inclusive, 8-90 degrees inclusive, 8-85 degrees inclusive, 8-80 degrees inclusive, 8-75 degrees inclusive, 8-70 degrees inclusive, 8-65 degrees inclusive, 8-60 degrees inclusive, 8-55 degrees inclusive, 8-50 degrees inclusive, 8-45 degrees inclusive, 8-40 degrees inclusive, 8-35 degrees inclusive, 8-30 degrees inclusive, 8-25 degrees inclusive, 8-20 degrees inclusive, 8-15 degrees inclusive, 8-10 degrees inclusive, 20-140 degrees inclusive, 40-120 degrees inclusive, 60-100 degrees inclusive, 80-90 degrees inclusive, 8 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, 140 degrees, 145 degrees, 150 degrees, 155 degrees, 160 degrees, 164 degrees, or the like.

In embodiments having an air guide configured as a helix, the number of turns in the helix can be about, e.g., 1-18 inclusive, 2-18 inclusive, 3-18 inclusive, 4-18 inclusive, 5-18 inclusive, 6-18 inclusive, 7-18 inclusive, 8-18 inclusive, 9-18 inclusive, 10-18 inclusive, 11-18 inclusive, 12-18 inclusive, 13-18 inclusive, 14-18 inclusive, 15-18 inclusive, 16-18 inclusive, 17-18 inclusive, 1-17 inclusive, 1-16 inclusive, 1-15 inclusive, 1-14 inclusive, 1-13 inclusive, 1-12 inclusive, 1-11 inclusive, 1-10 inclusive, 1-9 inclusive, 1-8 inclusive, 1-7 inclusive, 1-6 inclusive, 1-5 inclusive, 1-4 inclusive, 1-3 inclusive, 1-2 inclusive, 3-16 inclusive, 5-14 inclusive, 7-12 inclusive, 9-10 inclusive, 1, 2, 3, 4, 5, 6, 7, 8, 9, 10, 11, 12, 13, 14, 15, 16, 17, or the like. In some embodiments, two air guides configured as a helix can be positioned in a single purification chamber.

In embodiments having an air guide configured as a baffle or deflector, the number of such air guides can be about, e.g., 4-13 inclusive, 5-13 inclusive, 6-13 inclusive, 7-13 inclusive, 8-13 inclusive, 9-13 inclusive, 10-13 inclusive, 11-13 inclusive, 12-13 inclusive, 4-12 inclusive, 4-11 inclusive, 4-10 inclusive, 4-9 inclusive, 4-8 inclusive, 4-7 inclusive, 4-6 inclusive, 4-5 inclusive, 5-12 inclusive, 6-11 inclusive, 7-10 inclusive, 8-9 inclusive, 4, 5, 6, 7, 8, 9, 10, 11, 12, 13, or the like.

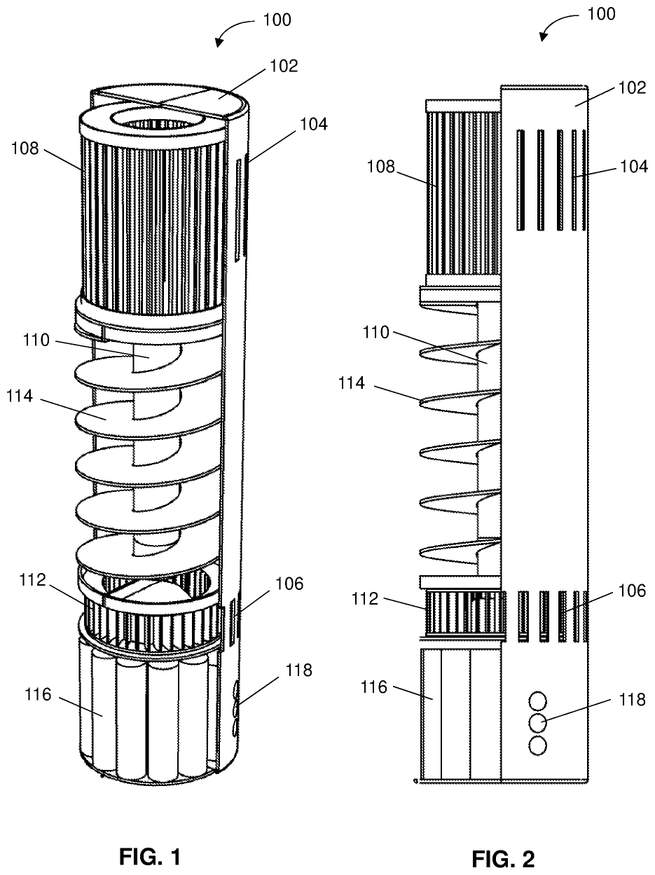

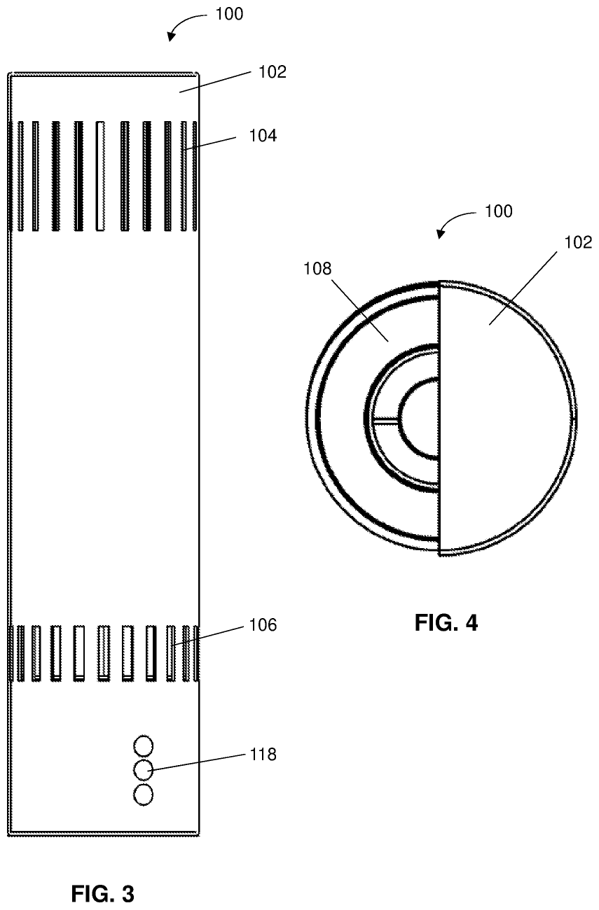

FIGS. 1-4 are perspective, side and top views of an exemplary air purifier system 100 in the form of a portable and/or tabletop battery powered unit. The system 100 is generally designed to collect and kill aerosolized pathogens which are at about mouth level, by drawing in air into the unit/device, filtering the air, irradiating the filtered air, and producing the purified air as output. Such system 100 can be used in, e.g., the home, businesses, restaurants, or the like. In some embodiments, the system 100 can serve a space of about 113 cubic feet, and can have an air flow output of about 8-10 cfm. In some embodiments, the system 100 can be programmed to purify the air in the surrounding space every, e.g., 5 minutes, 10 minutes, 12 minutes, or the like. In some embodiments, the system 100 (when actuated) can operate continuously to purify the air in the surrounding space. In some embodiments, the system 100 can be designed to capture and clean any aerosols which are directed at the central space of a table at mouth level, and dispense clean air below. The system 100 can intake pathogen laden air at mouth height (when placed on a table top) and expels scrubbed/clean air at the tabletop level. As discussed below, the air enters though intake slits, is sucked through a filter, flows down a helical ramp (the center of which is the UV-C bulb), and exits through slits in the base. The system 100 can operate using rechargeable batteries located in the base (although an AC adapter for connection to a power source can be used) providing enough power to last at least through typical meal service in a restaurant. The system 100 may be used indoors at restaurants and bars where power cords would be unsightly or unavailable.

With reference to FIGS. 1-4, the system 100 includes a housing 102 that extends around and substantially surrounds the internal components. In some embodiments, the housing 102 can define a substantially cylindrical configuration, although other configurations are also envisioned. The housing 102 includes intake slots or openings 104 formed in the side surface at or near a top of the system 100, the openings 104 leading into a hollow interior of the housing 102. The housing 102 includes output slots or openings 106 formed in the side surface at or near a bottom of the system 100 (e.g., opposing side from the openings 104). The openings 104, 106 are formed circumferentially to cover an entire 360 degrees of the housing 102. In some embodiments, the openings 104, 106 can be in the form of vertical slots extending substantially parallel to a central longitudinal axis of the system 100. In some embodiments, the length of the openings 104 can be greater than the length of the openings 106. Such length difference can ensure efficient intake of air for purification from the surrounding space, while providing a more directed output of purified air from the system 100.

Internally, the top of the system 100 includes an intake filter 108 to capture aerosols and pathogens taken in through the openings 104. Thus, the first form of purification involves filtration. The filter 108 can be, e.g., a HEPA filter, a minimum efficiency reporting value (MERV) 13 filter, or the like. The filter 108 can extend vertically within the system 100, with air passing into a central opening of the filter 108 aligned with the central longitudinal axis of the system 100. The system 100 includes a purification light source 110 (e.g., a UV-C lamp inside of a quartz tube or LED purification lamp) disposed centrally and extending from the bottom of the filter 108 to the top of a tangential or axial blower 112 (e.g., fan) disposed adjacent to the output openings 106. The system 100 includes an air guide 114 helically extending around the light source 110 from the filter 108 to the fan 112. In some embodiments, the air guides 114 define a continuous ramp configuration. It should be understood that the term “continuous” as used herein refers to a ramp that extends without significant gaps, but can be fabricated from more than a single piece of material (e.g., multiple pieces of sheet metal joined together to define a substantially continuous ramp surface). In some embodiments, the air guides 114 can be fabricated from, e.g., aluminum, cast plastic, or the like. The inner surfaces of the air guide 114 are positioned against the light source 110, and the outer surfaces of the air guide 114 are positioned against the inner surface of the housing 102 in a sealed manner to ensure air continues along the helical pathway for purification.

The helical configuration of the air guide creates a longer dwell time along the light source 110 (7 times longer than the lamp effective length), ensuring extended exposure of air to the light source 110 for purification. The system 100 includes a power source 116 (e.g., rechargeable batteries) disposed below the fan 112. The fan 112 distributes the clean air in a 360 degree radial angle through the openings 106, thereby capable of providing purified air to all sides of the system 100. The power source 116 is electrically connected to actuators 118 (e.g., buttons) for turning the system 100 on and off. In some embodiments, the actuators 118 can provide an option for an internal timer to control how long the system 100 will operate. The system 100 can include a charging port for charging the power source 116.

In operation, the user can position the system 100 in the desired location and turns on the system 100 by pressing the appropriate actuator 118. The power source 116 provides power to the fan 112 to begin circulation of air through the system 100, and also provides power to the light source 110. Air is taken in through the openings 104 and undergoes a first step of purification by passing through the filter 108. Air travels through the filter 108 and into the central passage within the filter 108. The fan 112 forces air to travel downward into the central section of the system 100, passing along the helical pathway formed by the air guide 114. As the air travels along the air guide 114, UV light emitted by the light source 110 provides a second step of purification to the air, thereby killing and/or removing any remaining pathogens in the air. The length of the helical pathway (as compared to a straight downward path) ensures pathogens are exposed to the UV light for a longer period of time. At the end of the helical pathway, the purified (e.g., filtered and irradiated) air is exhausted out through the openings 106. In some embodiments, the output airflow of the system 100 can be about 4 cfm. In some embodiments, the light source 110 can include 48 1.7 MW LEDs.

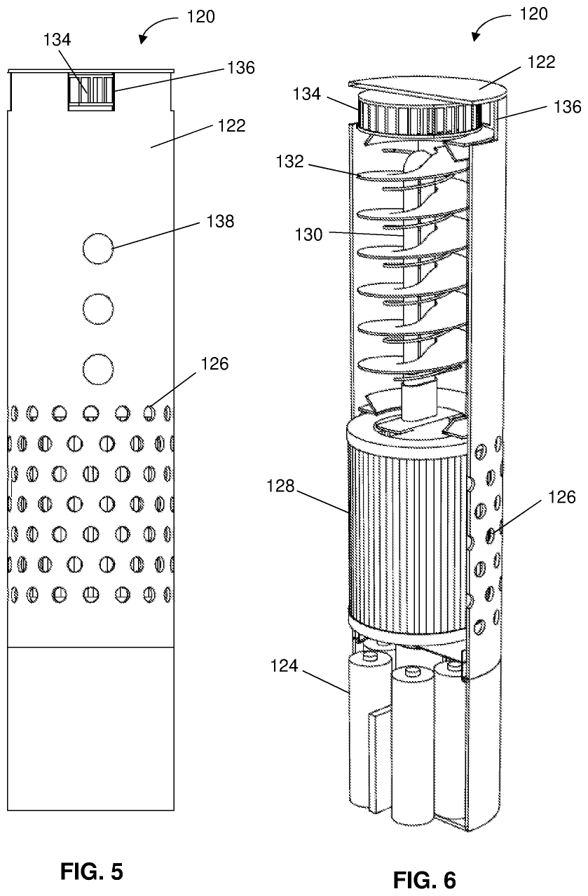

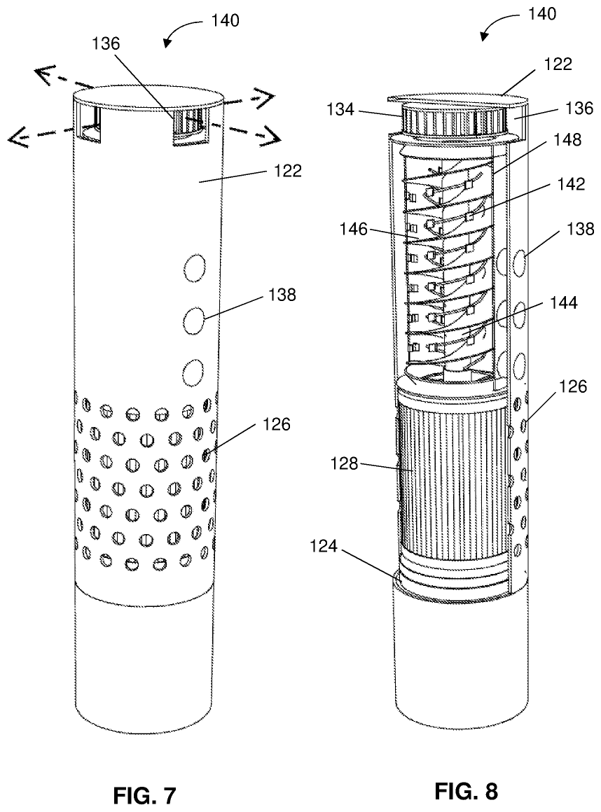

FIGS. 5-6 are perspective views of an exemplary purifier system 120 and FIGS. 7-8 are perspective views of an exemplary purifier system 140. The systems 120, 140 are substantially similar in structure and function, except for the distinctions noted here. Therefore, like reference numbers refer to like structures. The systems 120, 140 both include a housing 122. The base of the systems 120, 140 includes a power source 124 (e.g., rechargeable batteries). Directly above the base, the systems 120, 140 include a plurality of spaced, circular openings 126 for intake of air into the system 120. A filter 128 is positioned above the power source 124 and in-line with the central longitudinal axis.

In the system 120, extending above the filter 128 is a light source 130 (e.g., a UV lamp) with an air guide 132 disposed around the light source. The air guide 132 provides a single helical pathway which extends from the filter 128 to a blower or fan 134 disposed at the top of the housing 122. In contrast, the system 140 includes multiple light sources 142 in the form of LEDs mounted along a central post 144, and the air guide 146 provides a double helical pathway extending from the filter 128 to the fan 134. At or near the top edge of the system 120, 140, the housing 122 includes four radially spaced (e.g., by 90 degrees) outlet openings 136 which provide predetermined pathways for output of purified air. The systems 120, 140 include actuators 138 for regulating operation of the systems 120, 140.

The operation of the systems 120, 140 can be substantially similar to the system 100, except airflow is from the bottom of the unit towards the top. The system 120 can have an airflow output of about 10 cfm, with each outlet opening 136 having an airflow of about 2.5 cfm. The velocity at each outlet can be about 250 ft/min. The system 140 can have an airflow output of about 4 cfm, with each outlet opening 136 having an airflow of about 1 cfm. The velocity at each outlet can be about 200 ft/min. In some embodiments, one of the actuators 138 can be an LED configured to communicate with an internal sensor to represent the quality or purity of the surrounding air. For example, the systems 120, 140 can include an internal sensor that detects the particulate matter (PM) in the air (measured in micrograms per cubic meter of fine particles (PM2.5) received by the systems 120, 140, and illuminates the LED appropriately (e.g., green for zero or low number of PM, yellow for an average amount of PM, red for a high amount of PM). In some embodiments, the LED can illuminate green for detection of about 0-50 micrograms per cubic meter of fine particles, illuminate yellow for detection of about 51-100 micrograms per cubic meter of fine particles, and illuminate red for detection of about 101-200 micrograms per cubic meter of fine particles.

The light source 130 of the system 120 can be an 8 Watt UV-C CFL lamp with the CFL ballast extending into or aligned with the center of the filter 128, while the light source 142 of the system 140 can be 30 LEDs. The helical pathway of the system 120 can be a single helical path having a length of about 27 inches, while the helical pathway of the system 140 can be two helical paths each having a length of about 27 inches. In some embodiments, as shown for the system 140, a secondary internal chamber 148 can surround the air guide 146, the inner walls of the chamber 148 having a reflective aluminum coating to assist with reflection of the purifying wavelengths from the light source 142.

In some embodiments, the inner walls of the housing 122 itself can include a reflective aluminum coating (without the use of the chamber 148). In some embodiments, the central post 144 can include a reflective aluminum core to assist with reflection of light transmitted from the LEDs. The power source 124 can be a removable battery pack (e.g., 6 18650 lithium ion batteries with a charger circuit). In some embodiments, an external adapter plug can be used to power the system 120, 140. In some embodiments, the system 120, 140 can have an outer diameter of about 2.75 inches and a height (as measured between the top and bottom surfaces) of about 12.5 inches. The systems 120, 140 are intended to be oriented in a vertically positioned configuration on, e.g., a tabletop.

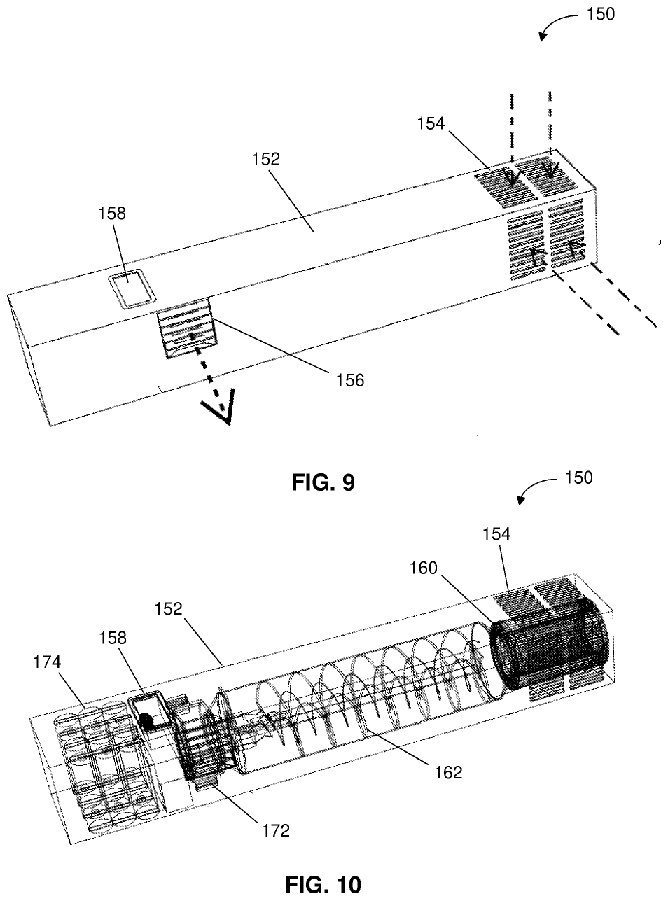

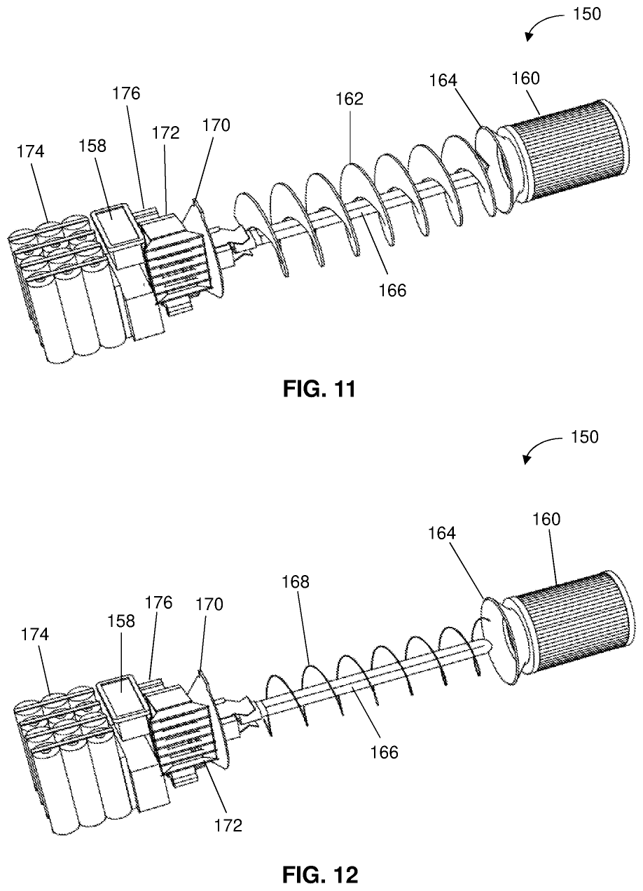

FIGS. 9-12 are perspective and transparent views of an exemplary air purifier system 150. The system 150 is configured to be oriented horizontally for use. The system 150 includes a housing 152 defining a substantially rectangular configuration. One end of the housing 152 includes inlet openings 154 (e.g., slots, grates, or the like) on adjacent side surfaces such that the system 150 receives air from two directions oriented about 90 degrees apart. Beyond the midway point of the system 150, the housing 152 includes an outlet opening 156 on only one side of the housing 152. The outlet opening 156 is formed in a side of the housing 152 having one of the openings 154. One side surface of the system 150 includes an actuator 158 for operating the system 150.

The system 150 includes an air filter 160 disposed within the housing 152 and positioned adjacent to the inlet openings 154. The end of the filter 160 oriented towards the helical air guide 162 includes a conical or funnel-shaped section 164 configured to direct air from the filter 160 towards the purification section defined by the light source 166 and the air guide 162. The air guide 162 results in the airflow forming a helical pathway 168 (as shown in FIG. 12) towards the distal end of the light source 166. At the distal end of the light source 166, the system 150 includes a conical or funnel-shape section 170 inwardly directed towards the blower or fan 172. The section 170 directs the air into the inlet of the fan 172. The system 150 includes a power source 174 in the form of rechargeable batteries. The system 150 can include a female electrical plug 176 configure to receive a corresponding male plug of an adapter for powering the system 150.

The system 150 can have an air flow of about 12 cfm and an airflow outlet velocity of about 300 ft/min. The helical baffle (e.g., air guide) can transform the effective length of the UV-C tube from about 4.72 inches to about 27 inches, thereby extending the time during which pathogens are exposed to the UV light. The power source 174 can be 9 18650 lithium ion batteries having a charger circuit. The light source 166 includes a CFL ballast.

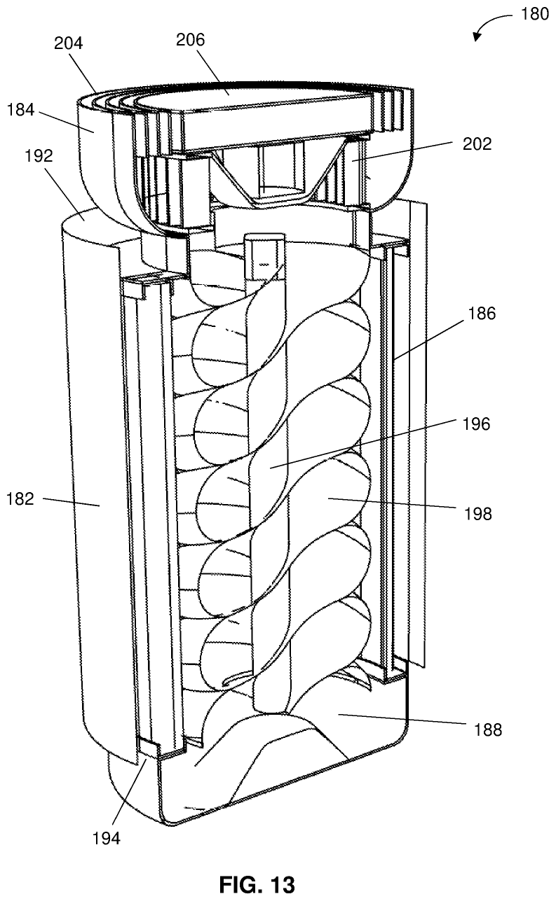

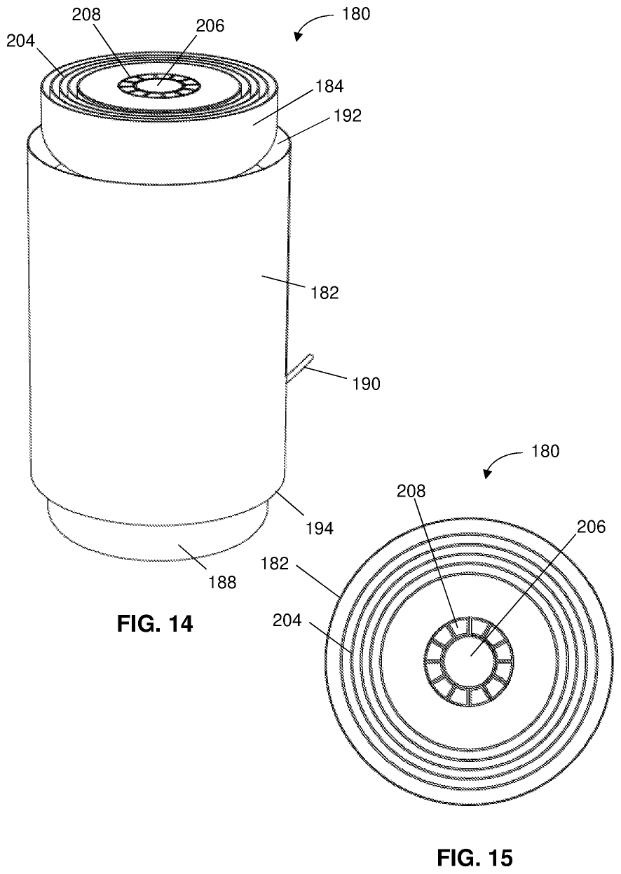

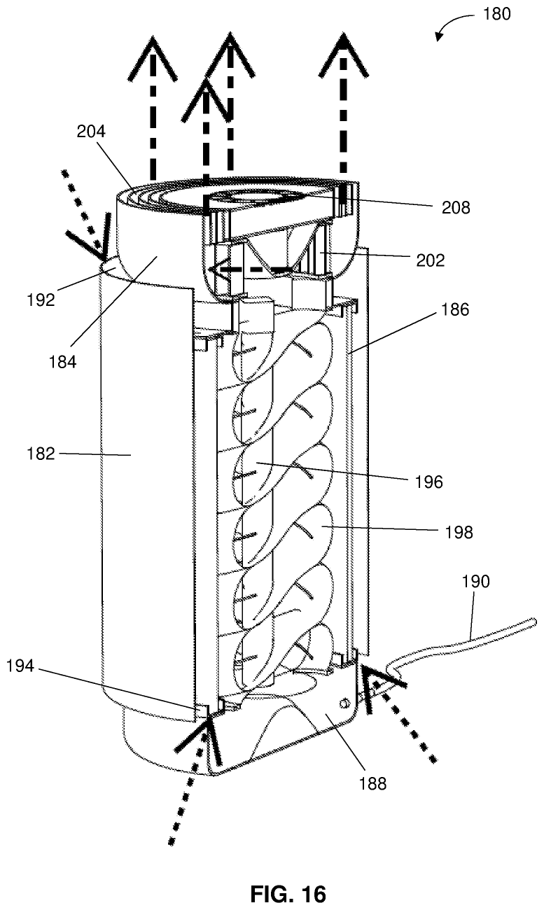

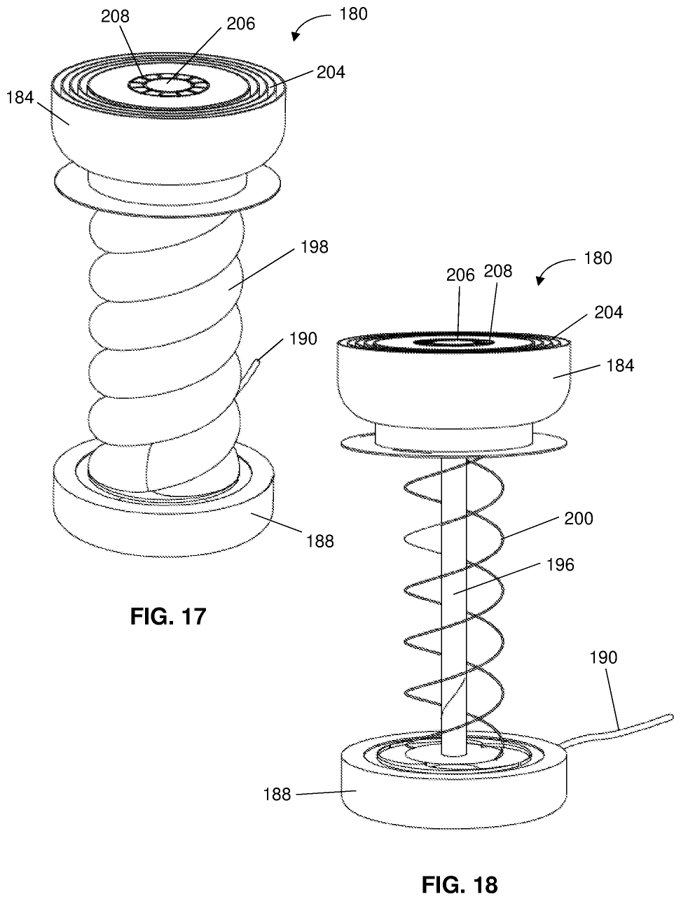

FIGS. 13-18 are cross-sectional, perspective and detailed views of an exemplary air purifier system 180 in the form of a room purification unit (e.g., a room-sized double-helix air purifier). In some embodiments, assuming a space of about 10×15×9 ft or 1,359 cubic feet, and an assumed output of about 130 cfm, the air will be completely cleaned every 10 minutes. The system 180 can be AC powered. The system 180 intakes pathogen laden air at its base and top, and expels scrubbed/clean air from the center of the top towards the ceiling of a room. When placed on the floor near the center of a room (small to medium square footage) the system 180 creates a stream of clean air and air currents to disrupt and absorb aerosols and pathogens from people in the room. The UV-C bulb is central to a double helix air path. The helical tube and bulb sit in the center of a tubular filter. Air flows into the system 180, passes through the filter, then into the helical section for a uniform exposure to the UV-C lamp to kill about 99.8% or more of pathogens, then exits through the top. The design of the system 180 may be for residential and commercial applications (e.g., offices, boardrooms, living rooms, kitchens, small rooms, or the like).

The system 180 includes a primary, outer housing 182 and a secondary internal housing 184 disposed at least partially inside of the housing 182. The housing 182 defines a substantially cylindrical configuration with a hollow interior. The housing 184 supports (and provides a frame for) a tubular filter 186 disposed within the interior of the housing 182. The housing 184 and filter 186 sit on a base 188 at the bottom of the system 180. The base 188 can include electrical components therein configured to operate components of the system 180. In some embodiments, the base 188 can include a power source, such as rechargeable batteries. In some embodiments, an electrical cable 190 can be used to connect the system 180 to an external power source.

The housing 184 is offset from the inner walls of the housing 182 to define a circumferential gap or channel between the housings 182, 184. The gap or channel provides circumferential entry points 192, 194 and the top and bottom perimeters of the housing 182 such that air can be taken in by the system 180. The air travels into the gap or channel between the housings 182, 184 and through the filter 186. The filter 186 is aligned with the central vertical axis. Within the filter 186, the system 180 includes a light source 196 also aligned with the central vertical axis of the system 180. The system 180 includes air guides 198 surrounding the light source 196 and defining a double helical pathway 200 around the light source 196. Air passing through the filter 186 is therefore guided into the helical pathway 200 starting from the bottom of the system 180, and travels within the helical pathway 200 towards the top of the system 180.

A blower or fan 202 is disposed at the top of the system 180 within the housing 184, and actuation of the fan 202 causes movement of the airflow through the system 180. At the top of the system 180, the housing 184 includes circumferential, concentrically formed openings 204 for outlet of the purified air from the top of the system 180. The system 180 includes actuators 206 at the top surface for user control of the system 180. In some embodiments, the system 180 can include an array of LED indicators 208 for visual indication of the operation status of the system 180 and/or the quality of the air taken in by the system 180.

In some embodiments, the light source 196 can be an 18 Watt T5 UV-C tube with a four pin single ended quartz tube. In some embodiments, the system 180 can purify air in an approximately 80 ft² area. In some embodiments, the system 180 can provide for 80 cfm and the HEPA filter 186 can surround the double helix configuration of the air guides 198. In some embodiments, the overall diameter of the system 180 can be about 10 inches and the overall height of the system 180 can be about 16 inches. The fan 202 can be a centrifugal blower wheel in a custom enclosure providing 360 degrees of upward dispersion (e.g., substantially parallel dispersion to the central vertical axis of the system 180). In particular, the housing 184 can include a curved section surrounding the bottom of the fan 202 such that air output by the fan 202 is directly upwards through the openings 204. The air guides 198 can be fabricated from intertwined curved cast plastic helical chambers configured to fit around the UV-C lamp. The power source can be 120-240 V. The system 180 can collect and kill aerosolized pathogens which are substantially at mouth level, using a laminar flow of purified air, by drawing in air from the base of the unit and producing filtered and irradiated light from the top of the apparatus. The air enters through the lower intake, passes through a HEPA filter, is drawn through a double helical chamber with UV-C irradiance, and finally exists through a top outlet.

In some embodiments, the exemplary systems can be configured and dimensioned to be incorporated into existing or new HVAC (or similar) systems that incorporate air-transmitting ductwork. Incorporation of the systems into existing ductwork can necessitate a minimal amount of replacement of existing parts, allowing for the system to be incorporated in essentially any as-built environment. Such systems can include a helical arrangements and/or baffles. The system velocity can determine the length and strength of the UV-C lamp, as well as size and distance from the lamp. Such systems can operate on an AC powered with ballast, and the cfm can substantially match existing duct output.

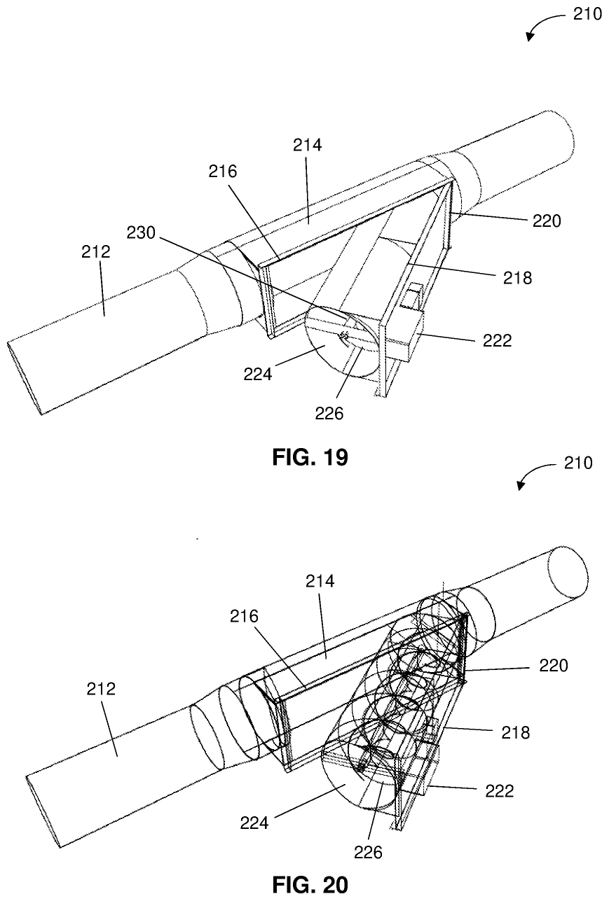

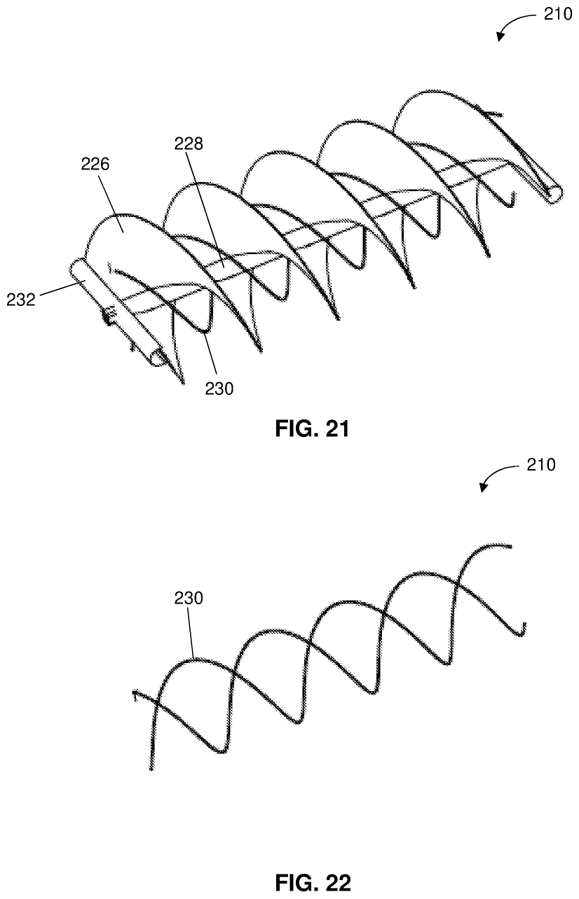

FIGS. 19-22 are perspective, transparent and partial views of an exemplary air purifier system 210 in the form of a ductwork insert. The system 210 can be incorporated into a retrofit or new construction of a forced air system in a residential, commercial or office setting. In some embodiments, the system 210 can be placed inline in a round air duct (e.g., a 10 inch diameter duct) connected to a duct run (e.g., 6 inches, 8 inches, or 10 inches with a 14 inch or 16 inch unit). Pathogen laden air flows in one end of the system 210 and air that has been exposed to UV treatment exits from the other, opposing end of the system 210. The system 210 does not filter the air, instead relying on a high intensity UV-C bulb and extended dwell time to kill airborne pathogens. Compared to a similar traditional systems that also uses a straight 48 inch air path, the helical design of the system 210 offers an approximately 329% longer path and therefore a 329% increase in dwell time.

With reference to FIGS. 19-22, the system 210 is incorporated in-between inlet and outlet ductwork 212. In some embodiments, the diameter of the ductwork 212 can be about 12 inches. The system 210 includes a housing 214 with a hollow interior and an opening 216 (e.g., a rectangular opening) on the side of the housing 214. The system 210 includes a panel or door 218 capable of being pivoted at a hinge point 220 to open and close the opening 216. On the outer surface of the door 218, the system 210 includes a junction box 222 enclosing electrical components associated with the system (e.g., ballast, control module, or the like). The junction box 222 can include controls and/or actuators on the outer surface to allow for regulation of the system 210. The inner surface of the door 218 includes purification equipment. Pivoting of the door 218 into the open position allows for repairs or maintenance of the purification equipment.

The system 210 includes a cylindrical duct 224 which defines the outer pathway of air through the system 210. Within the duct 224, the system 210 includes air guides 226 in a double helix configuration. The outer diameter of the air guides 226 can be about 14 inches such that the air guides 226 are positioned against the inner surface of the duct 224 in a substantially sealed manner. The system 210 includes a light source 228 (e.g., a UV-C lamp) disposed within the duct 224 and extending the length of the duct 224. The light source 228 can include support beams 232 extending substantially perpendicularly to the main lamp of the light source 228 on opposing ends of the light source 228 for mounting of the light source 228 within the duct 224. The air guides 226 and the light source 228 substantially align relative to the central longitudinal axis of the duct 224. The system 210 relies on the blower or fan of the HVAC system to draw air through the system 210. As air passes through the system 210, the air guides 226 cause the air to pass via a helical pathway 230 (e.g., a double helical pathway), ensuring all pathogens are exposed to the light emitted from the light source 228.

In some embodiments, the light source 228 can be a single 33 inch, 87 Watt, T5 4 pin bulb. In some embodiments, the light source 228 can be a UV-C bulb surrounded by a 2 inch diameter quartz tube. In some embodiments, the air guides 226 can be formed from aluminum. In some embodiments, the air guides 226 can be formed from a plastic casting. Ribs can be used in combination with the air guides 226 to maintain rigidity of the helical structure. The duct 224 can be formed from traditional HVAC materials, such as aluminum or a steel spiral. Both helical pathways 230 can be about 66 inches in length. Complete irradiation can be achieved at an output of about 700 cfm or greater. No filter is used by the system 210, due to the use of traditional filters in the HVAC unit or within the existing ductwork.

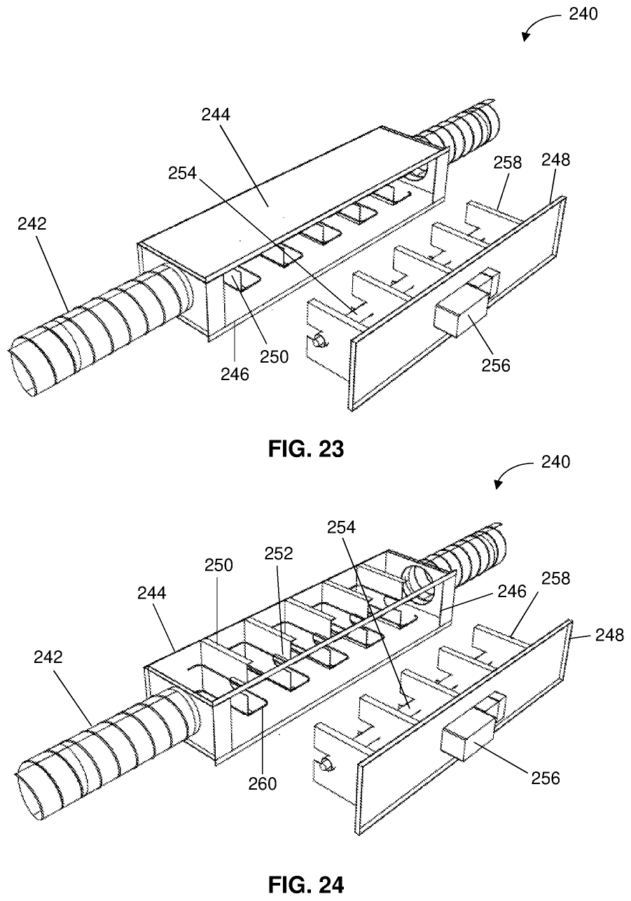

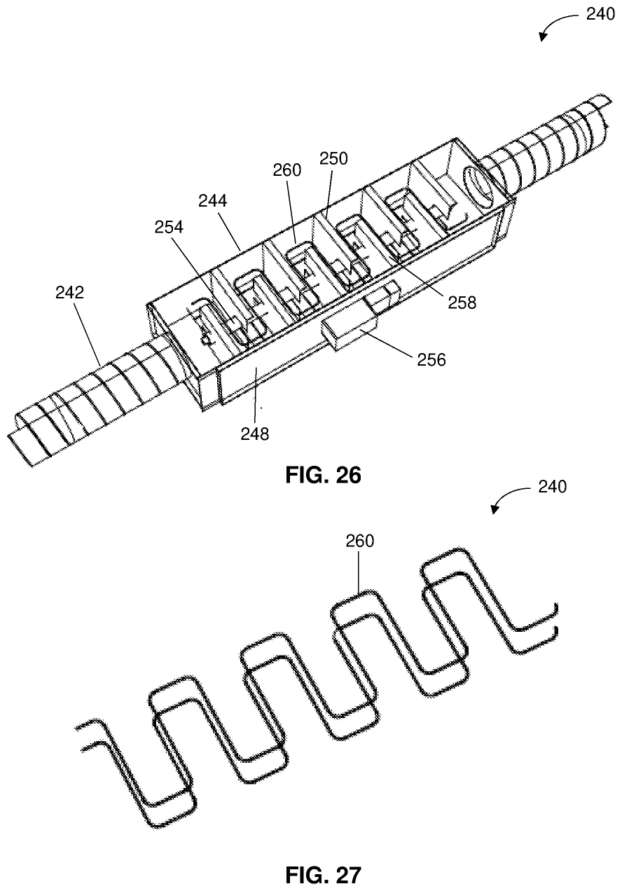

FIGS. 23-27 are perspective, cross-sectional and partial views of an exemplary air purifier system 240 in the form of a ductwork insert. The system 240 includes a box with baffles for incorporation into round or rectangular ducts. The system 240 can be inserted in an existing duct run. The air enters the box at one end, is directed through a series of baffles which increase the air's path to about 210% of the UV-C bulb's length, and thereby doubles the dwell time around the UV-C light source. The system 240 does not filter, instead relying on a high intensity UV-C bulb and extended dwell time to kill airborne pathogens. The system 240 can be retrofitted into existing HVAC systems, both residential and commercial. The side of the housing is removable to allow for cleaning and re-lamping.

The system 240 is incorporated in-between inlet and outlet ductwork 242. The system 240 includes a substantially rectangular housing 244 with a hollow interior and an opening 246 along one side of the housing 244. One side of the housing 244 is formed as a door or panel 248 that is removable from the remaining portion of the housing 244 such that internal components of the system 240 can be replaced or repaired. In some embodiments, the panel 248 can pivot along a hinge point. The panel 248 is configured to cover and seal the opening 246 in the closed position. Rather than a helical pathway, the system 240 is configured to form a curved or serpentine airflow.

Within the interior of the housing 244, the system 240 includes a first set of baffles (e.g., air guides 250) in the form of linear extensions extending from the side wall towards the center of the hollow interior of the duct 244. The air guides 250 are spaced from each other and extend beyond the central longitudinal axis of the duct 244 (e.g., more than half of the width of the duct 244). Each air guide 250 includes a semi-circular cutout 252 formed therein configured to at least partially fit around a light source 254. The cutout 252 is therefore complementary to the cross-sectional shape of the light source 254.

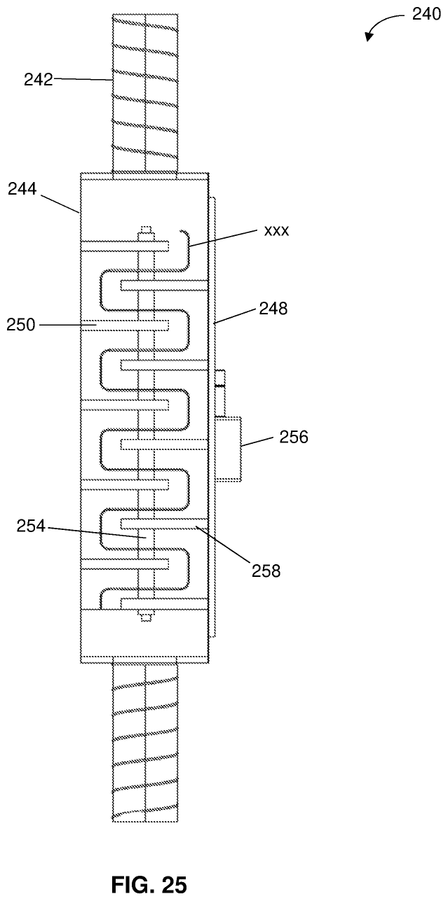

The outer surface of the panel 248 includes a junction box 256 configured to include electrical equipment for operation of the system 240. The junction box 256 can include controls for operation of the system 240. The inner surface of the panel 248 includes a second set of baffles (e.g., air guides 258) having a substantially similar configuration as the air guides 250, except extending in the opposing direction within the hollow interior of the duct 244. The light source 254 is mounted to the cutouts of the air guides 258 such that removal of the panel 248 results in removal of the air guides 258 and light source 254 from the duct 244. In some embodiments, the light source 254 can be mounted to the cutouts of the air guides 250 such that removal of the panel 248 only removes the corresponding air guides 258. As illustrated in FIG. 25, the extension of the opposing air guides 250, 258 results in a serpentine or maze-like internal passage along the centrally extending light source 254, forcing the air to flow in a curved or serpentine pathway 260.

In some embodiments, the housing 244 (e.g., duct) can be about 10 inches by 16 inches (e.g., an air purifier box), and can be fed by a round or rectangular duct. The housing 244 can have an open area of air flow of about 9.9 inches×5 inches, with the pathway 260 length of about 139 inches. The airflow speed can be about 500 cfm. The light source 254 can be a UV-C lamp, e.g., a TUV 115 W-VHO, a 115 Watt 48 inch lamp, or the like. The UV-C lamp can be positioned inside of a quartz tube. In some embodiments, the system 240 can operate at about 500 cfm.

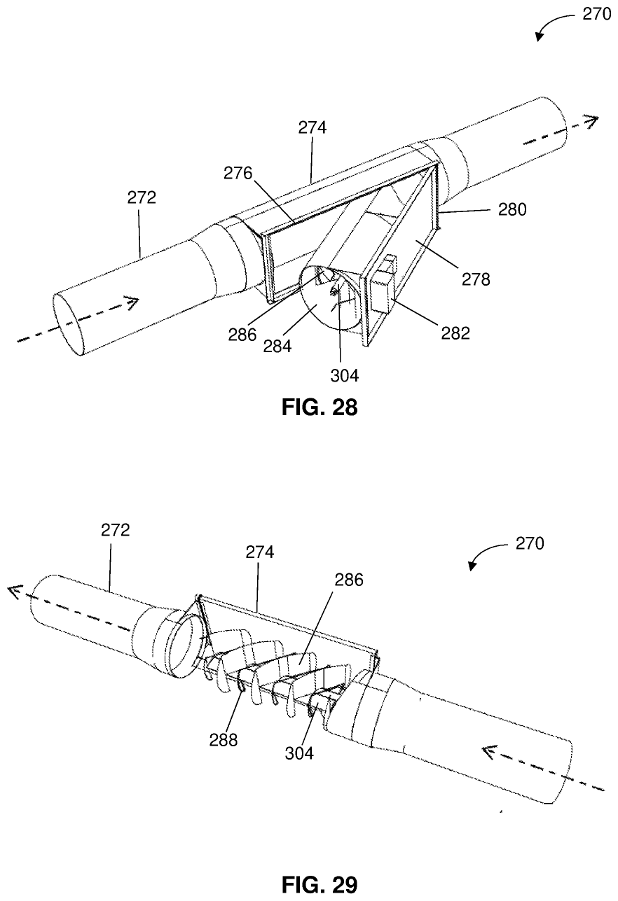

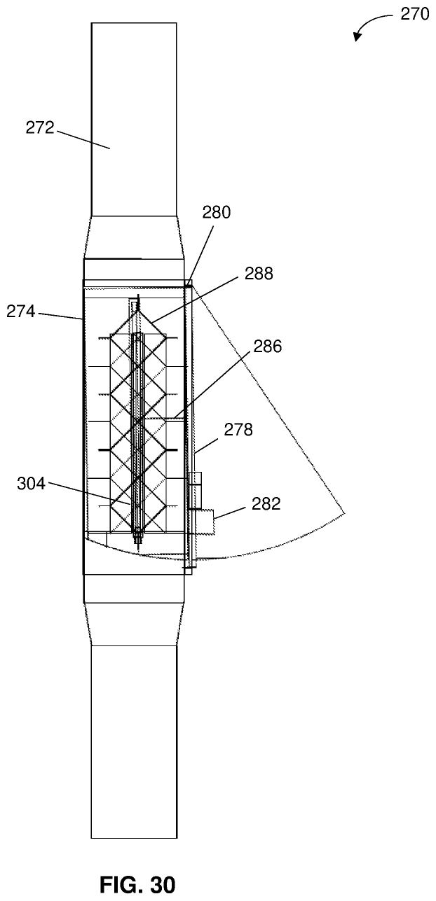

FIGS. 28-33 are perspective, cross-sectional and detailed views of an exemplary air purifier system 270 in the form of a ductwork insert. The germicidal air cleaner of FIGS. 28-33 includes a flat helix for use in round ducts. is the system 270 can be placed inline in a 16″ round air duct connected to a 10″ duct run (or sizes 8″ run with a 14″ unit, 10″ run with a 16″ unit). Pathogen laden air flows in one end and air that has been exposed to UV treatment exits from the other. The system 270 does not filter, instead relying on a high intensity UV-C bulb and extended dwell time to kill airborne pathogens. Compared to similar systems that use a straight 48″ air path, the helical design offers a 270 inch path (or a 565% longer path), and therefore provides a 565% increase in dwell time. The system 270 can be retrofitted into existing HVAC systems, both residential and commercial.

With reference to FIGS. 28-33, the system 270 includes ductwork 272 on opposing sides of a housing 274 that serves as a housing for the purification components of the system 270. The housing 274 can define a substantially cylindrical configuration with a substantially rectangular opening 276 extending the length of the housing 274 on one side. The opening 276 leads to the hollow interior of the housing 274. A door or panel 278 can be pivotably connected to the housing 274 at a hinge point 280 such that the panel 278 can be positioned between an open and closed position. In the closed position, the panel 278 seals the opening 276 to ensure no unpurified air leaks from the system 270. On an outer surface of the panel 278, the system 270 includes a junction box 282 with electronics and controls for operating the system 270. On the inner surface of the panel, 278, the system 270 includes a cylindrical duct 284. When the panel 278 is in the closed position, the duct 284 mates with the ductwork 272 endpoints in a sealed manner to ensure air flows without leaking through the duct 284 for purification.

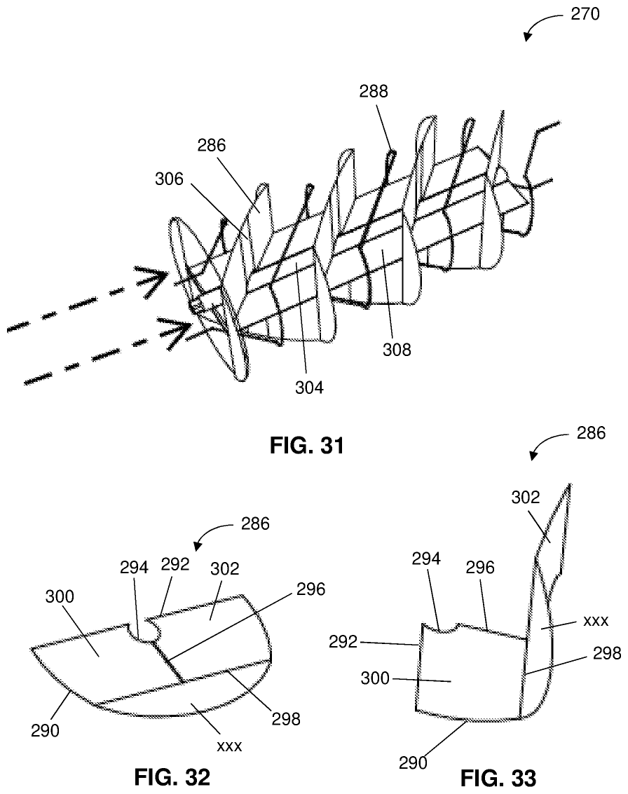

The system 270 includes air guides 286 (e.g., ramped, flat components) that create a substantially helical pathway 288 for the airflow through the duct 284. As illustrated in FIGS. 32-33, the air guides 286 can be formed from flat sheet metal stamped or cut initially to include a substantially rounded edge 290 connected to a flat bottom edge 292. The air guides 286 include a semi-circular cutout 294 at a central position of the bottom edge 292, a cut 296 extending upward from the cutout 294, and a bend line 298 extending perpendicularly to the cut 296 between the opposing rounded edge 290. During assembly, the air guide 286 can be bent at the bend line 298 to separate first and second ramped sections 300, 302 along the cut 296. Multiple air guides 286 in this configuration can be assembled on opposing sides of a light source 304 in an orientation angled relative to the central longitudinal axis of the system 270 and light source 304. The flat edge 292 of the first ramped section 300 can be coupled to the flat edge 292 of a second ramped section 302 of another air guide 286 using couplers 306 (as illustrated in FIG. 31), thereby forming a substantially continuous, ramped structured surrounding the light source 304. The cutouts 294 mate around the light source 304, and all components are connected in a sealed manner to prevent leaks, ensuring a long dwell time. In some embodiments, friction, caulking, welding, monolithic casting, combinations thereof, or the like, can be used to achieve the sealed assembly of the components. Flat dividers 308 can be positioned on opposing sides and along the length of the light source 304 to provide separation between the top and bottom pathways 288 around the light source 304. It should be understood that other ramped or curved air guides discussed herein can be formed using a similar manner.

In some embodiments, the system 270 can have a housing 274 of about 16 inches in diameter, and receives an infeed duct of about 14 inches in diameter. The system 270 can operate from 1,000 to 1,800 cfm with inactivation of pathogens of about 99.9999%. The light source 304 can be a 33 inch GPHA842T6 single ended 4 pin lamp, operating at about 130 Watts. Dual paths of airflow can enter the ramped air guide 286 structure, with two pathways 288 extending in clockwise and counterclockwise directions around the light source 304.

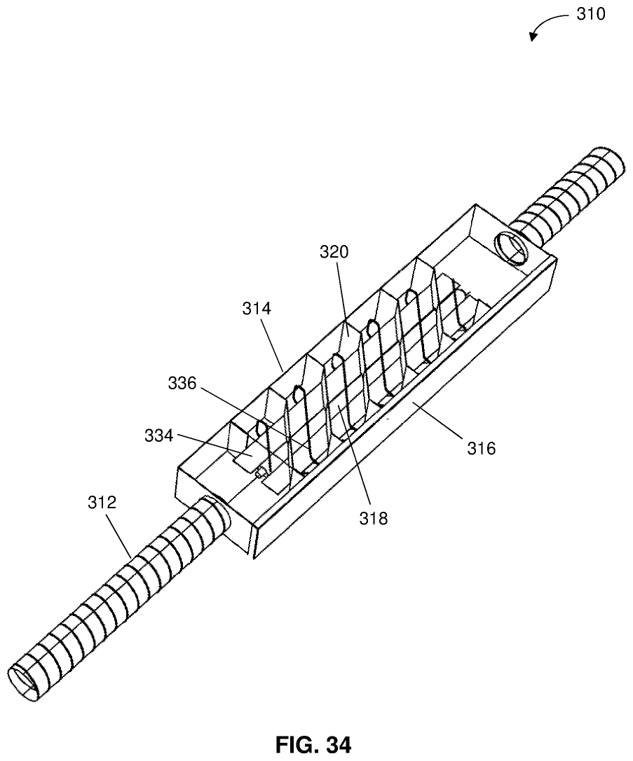

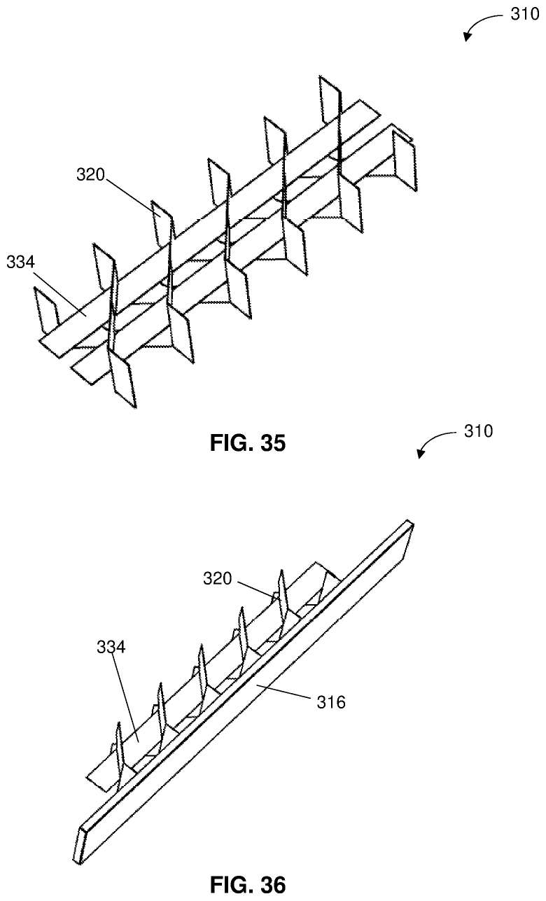

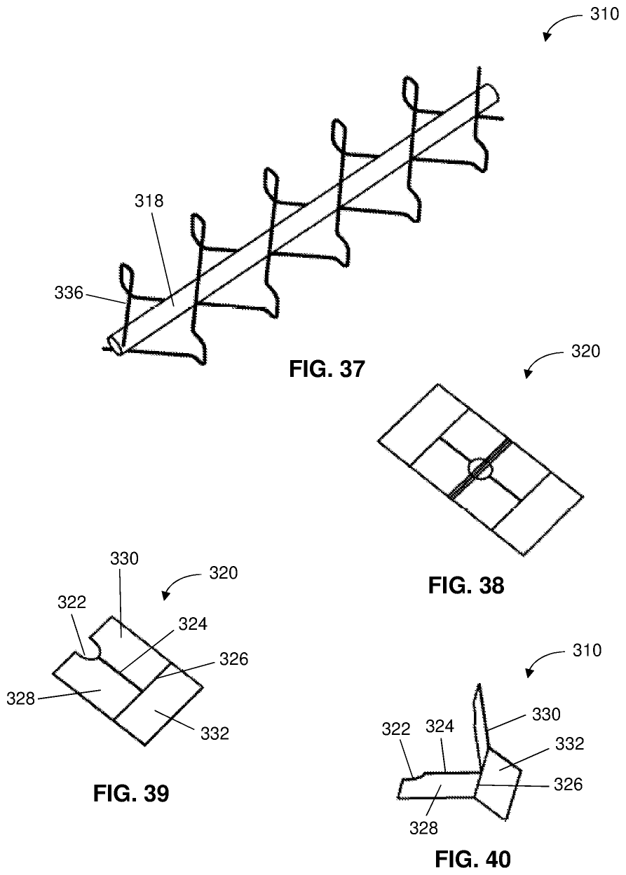

FIGS. 34-40 are perspective, cross-sectional and details views of an exemplary air purifier system 310 in the form of a ductwork insert. The germicidal air cleaner box includes a flat helix designed for use in rectangular ducts. The system 310 can be placed inline in a 8″×16″ rectangular air duct connected to a 8″ duct run (or other sizes). Pathogen laden air flows in one end and air that has been exposed to UV treatment exits from the other end. The system 310 does not filter, instead relying on a high intensity UV-C bulb and extended dwell time to kill airborne pathogens. Compared to similar systems that utilizes a straight 48″ air path, the helical design offers a pathway length of about 205″ (or about 465% longer path), and therefore results in a 465% increase in dwell time. The system 310 can be retrofitted into existing HVAC systems, both residential and commercial.

With reference to FIGS. 34-40, the system 310 is similar to the other ductwork insert systems except for the distinctions noted herein. The system 310 therefore includes ductwork 312 on opposing sides of a housing 314. The housing 314 can define a substantially rectangular configuration, and can include a removable side door or panel 316. Within the hollow interior of the housing 314, the system 310 includes a light source 318 extending the length of the housing 314 and aligned with a central longitudinal axis of the ductwork 312. The system 310 includes air guides 320 in the form of a ramped, flat helix extending around the light source 318. The air guides can be formed similar to the ramped air guides discussed with respect to FIGS. 31-33.

In particular, as illustrated in FIGS. 38-40, each ramp guide 320 can define a substantially rectangular configuration with a semi-circular cutout 322 on one edge, a cut 324 extending from the cutout 324, and a fold line 326 extending perpendicularly relative to the cut 324. Bending of the ramp guide 320 forms opposing ramped sections 328, 330, and a top ramped section 332. As shown in FIG. 38, two ramp guides 320 may be fabricated from a single piece of flat, sheet metal material. The ramp guides 320 can be coupled together in an opposing orientation around the light source 318, with the ramped sections 328 extending at an angle relative to the central longitudinal axis and the ramped sections 332 extending substantially perpendicular to the central longitudinal axis. Two divider panels 334 can be positioned on opposing sides of the light source 318 to separate the pathway 336 flow above and below the light source 318. The system 310 forms two pathways 336 moving in clockwise and counterclockwise directions around the light source 318. In some embodiments, the system 310 can have an output of about 700 cfm and can use a light source 318 in the form of a 75 Watts UV-C lamp.

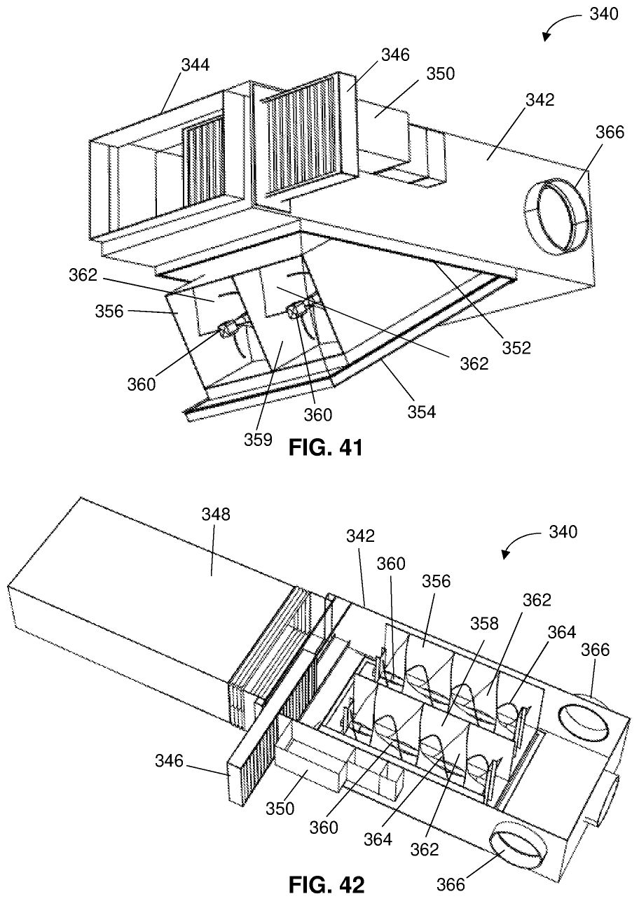

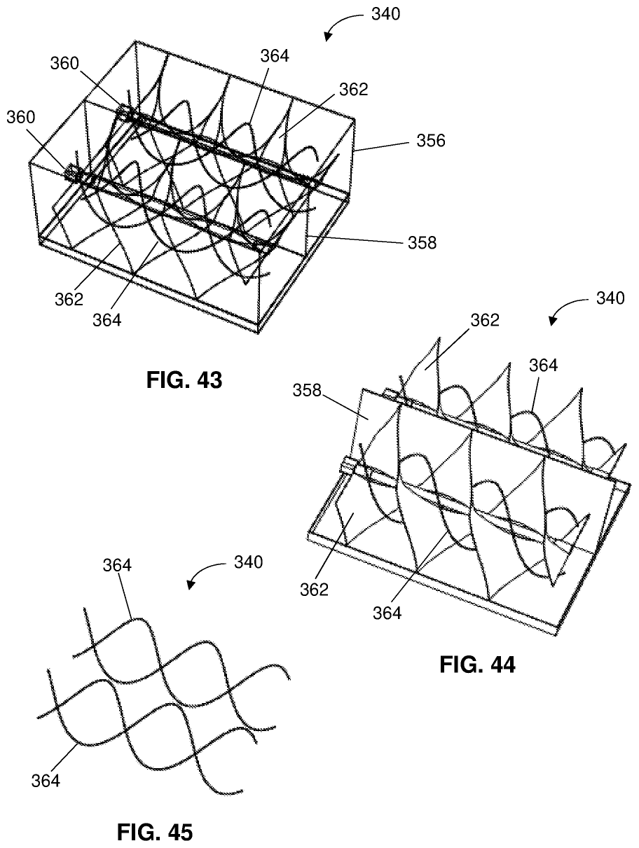

FIGS. 41-45 are perspective, cross-sectional and detailed views of an exemplary air purifier system 340 in the form of a ductwork insert. The system 340 can be used with brand ducts for patient rooms, as an example. The system 340 can provide a 560 cfm supply with low friction. The system 340 can be about 40 inches long, 18 inches wide, and 10 inches deep. The system 340 can use two GPH436 T5/HO 48 Watt UV-C lamps as light sources for purification. Outlets for air can be either round or rectangular. The system 340 includes a dual chamber aluminum reactor or purification core with double helix pathways in each to maximize airflow and purification. The aluminum surface can be reflective to increase effectiveness of purification by 30-60%. The effective length of the lamps can be about 13.78 inches, with the helix pathway increasing the pathway by 240% to about 33 inches each.

The system 340 includes a housing 342 defining a substantially rectangular configuration. A front face of the housing 342 includes an intake opening 344, with the internal surface of the housing 342 at the intake opening 344 having brackets capable of receiving an optional air filter 346 (e.g., a 2×10×18 inch HEPA or MERV filter). The intake opening 344 is capable of connecting to surrounding ductwork 348. A junction box 350 can be positioned on an outer surface of the housing 342. The system 340 includes a bottom opening 352 and a door or panel 354 capable of being opened or closed to expose the opening 352 and provide access to internal components of the system 340.

Mounted to the panel 354, the system 340 includes two adjacent purification chambers 356 positioned adjacent to each other and sharing a central separating wall 358. The walls can be formed from traditional ductwork material (with or without aluminum coating), aluminum (to provide reflectivity), or the like. Each chamber 356 includes a light source 360 extending substantially the length of the chamber 356 and aligned along a central longitudinal axis of the chamber 356. Each chamber 356 includes air guides 362 curved in a helical manner around the respective light source 360 to define two pathways 364 in opposing directions in each chamber 356. The system 340 therefore supports four separate pathways 364 (e.g., two in the clockwise direction and two in the counterclockwise direction). The outlet of the system 340 can be two round duct openings 366 oriented in opposing directions, although alternative configurations are envisioned (e.g., rectangular or square openings in the same direction).

In some embodiments, the systems of FIGS. 19-45 can be used to collect and kill aerosolized pathogens which are circulating inside of small to medium sized enclosures or spaces (e.g., 0-10,000 s/ft). The systems take in air from the HVAC system, and produce irradiated air from the exhaust of the unit. The air enters through the intake, flows through a helical, baffled, or double flat ramp air guide configuration within the purification chamber with UV-C irradiance, and then is output through the outlet of the system.

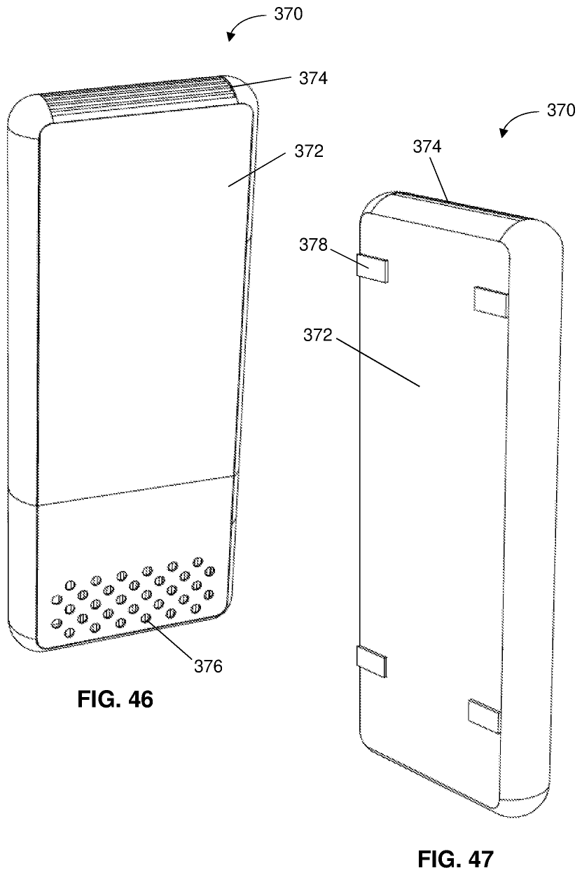

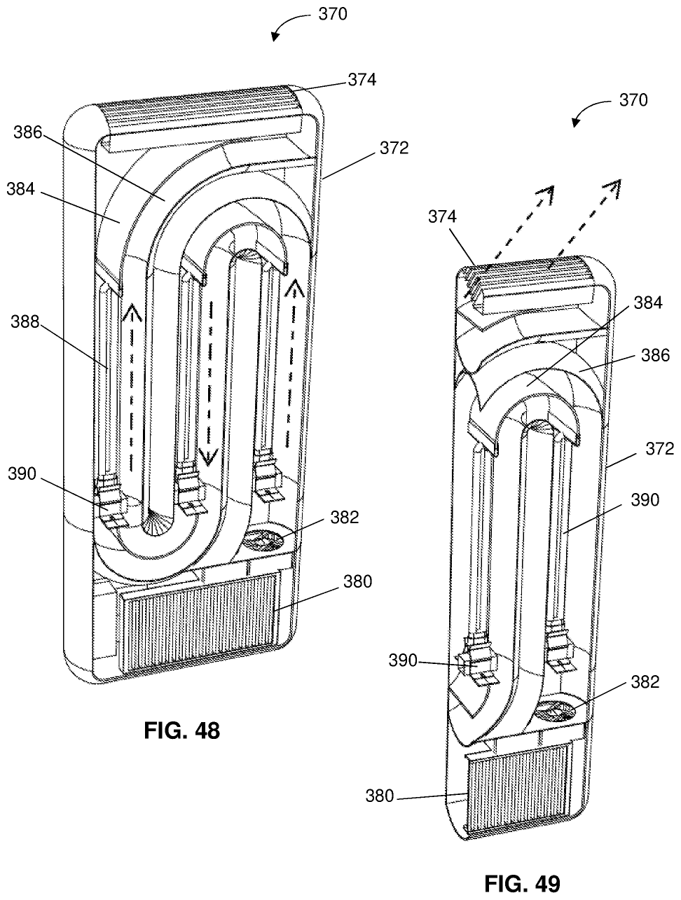

FIGS. 46-49 are perspective and cross-sectional views of an exemplary air purifier system 370 in the form of a portable unit. The portable air purifier uses a curved, maze or serpentine air path in the purification chamber to increase the dwell time. The system 370 can use a HEPA filter, a tangential fan, and a serpentine air path, along either LEDs or UV-C quartz tubes. The system 370 can be powered using either a 12 volt/120 volt source. In some embodiments, the system 370 can be powered from a car outlet and/or a wall plug. The approximate size for the system 370 can be about 2.25″ thick, 10.25″ wide×23″ long. In some embodiments, microwave emitters can be used in combination with or to replace the LED/UV-C light sources. In some embodiments, the system 370 can use three 8 Watt UV-C CFL lamps, 8 Watts each. In some embodiments, the air flow for the system 370 can be about 18 cfm. In some embodiments, the fan can be a 2-12 cfm axial DC fan, about 50 mm×22 mm in size. In some embodiments, a 12 V ballast can be used for the UV-C lamps.

In some embodiments, the system 370 can be used at the rear of a taxi or other vehicle. For example, the taxi can have a rear space having a volume of approximately 60 cubit feed, that the system 370 can output 30 cfm of clean air every 2 minutes, as an example. In some embodiments, the system 370 can be used in the rear of an ambulance (e.g., about 240 cubic feet of space in transportation area). In some embodiments, the system 370 can be mounted on a ceiling surface above a stretched location with the device intake being at a patient head location. In such scenarios, an output of about 40 cfm can clean the air every 6 minutes. Such embodiment can be longer than the taxi model, and would incorporate UV-C wattage. In some embodiments, the system 370 can be used adjacent to a hospital bed. For example, the exterior of the device can include a connection system (e.g., a hanger arrangement designed to hang on a hospital guardrail or bed frame, and oriented to evacuate the patient's breath at the head of the bed with continuous suction of about 40 cfm. The designs can incorporate a HEPA filter, tangential or centrifugal fan, and define an interior serpentine air path along UV-C or LED lamps (and/or microwaves).

With reference to FIGS. 46-49, the system 370 includes a housing 372 defining a substantially rectangular, flat configuration. One top edge of the housing 372 can include louvers or slotted openings 374 for output of purified air from the system 370, and an opposing front surface of the housing 372 can include an array of openings 376 for intake of air. In some embodiments, the rear surface of the housing 372 can include attachment structures 378 (e.g., clips, hangers, straps, adhesive pads, or the like) for attachment of the system 370 to a desired location. The system 370 includes a filter 380 positioned adjacent to the openings 376 such that all air taken in by the system 370 is initially filtered. A fan 382 positioned adjacent or above the filter 380 can drive intake and output of air.

The hollow interior of the housing 372 includes curved and linear inner walls 384, 386 (e.g., air guides) that define a substantially S-shaped airflow pathway (as indicated by the arrows). The pathway can initially start at the fan 382, with the inner walls of the housing 372 guiding airflow into the maze or serpentine passage formed by the walls 384, 386. Within the linear sections of the pathway, the system 370 includes light sources 388 secured to respective ballasts 390. Each of the light sources 388 extends substantially the entire linear length of the pathway between the walls 384, 386. In some embodiments, the light sources 388 can be incorporated into the structure of a central wall extending between the walls 384, 386 to provide purification on each respective serpentine passage. In some embodiments, the inner surfaces of the walls 384, 386 and housing 372 can be aluminum coated (or coated with a reflective coating) to allow for purification to occur within the curved sections of the pathway. In some embodiments, the UV-C light transmitted from the light sources 388 sufficiently extends into the curved sections of the pathway to provide substantially continuous or constant irradiation along the entire pathway. Upon purification, the air is output through the openings 374.

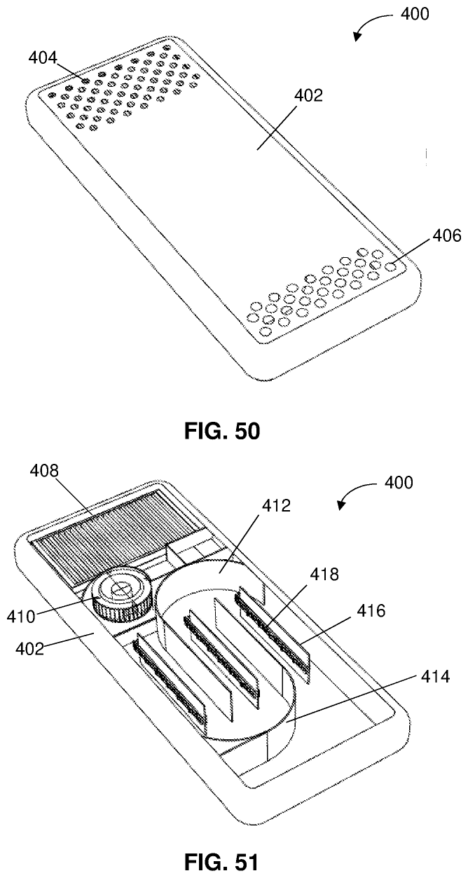

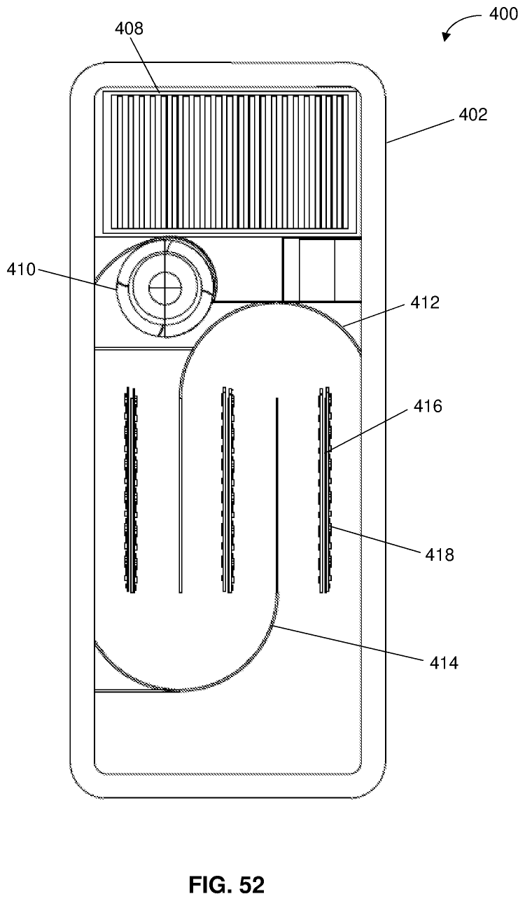

FIGS. 50-52 are perspective and cross-sectional views of an exemplary air purifier system 400 in the form of a portable unit. The system 400 can be substantially similar to the system 370, except for the distinctions noted herein. The system 400 includes a housing 402 with intake openings 404 and output openings 406 formed on the same front surface, but on opposing ends of the housing 402. The system 400 includes a filter 408 disposed adjacent to the openings 404 within the hollow interior of the housing 402. A fan 410 is positioned adjacent to the filter 408 and drives airflow through the system 400. The system 400 includes two substantially (or partially) U-shaped inner walls 412, 414. The walls 412, 414 face in opposite directions to create a maze or serpentine passage in-between the walls 412, 414 and inner walls of the housing 402. In-between the linear extensions of the walls 412, 414, the system 400 includes three support extensions 416 (e.g., substantially flat walls) extending from the bottom surface of the housing 402. Mounting on both sides of the extensions 416 are light sources 418 (e.g., LEDs). Thus, air is initially filtered, and subsequently passes through the serpentine passage for purification using the LEDs.

In some embodiments, the LEDs can be in the form of strips secured to the supporting wall. In some embodiments, the light source can be spaced by about 1.25 inches from the surrounding walls to ensure a higher dose of purification for the passing air flow. The portable units discussed herein can include an inner compartment for electronics and/or controls, including a rechargeable power source.

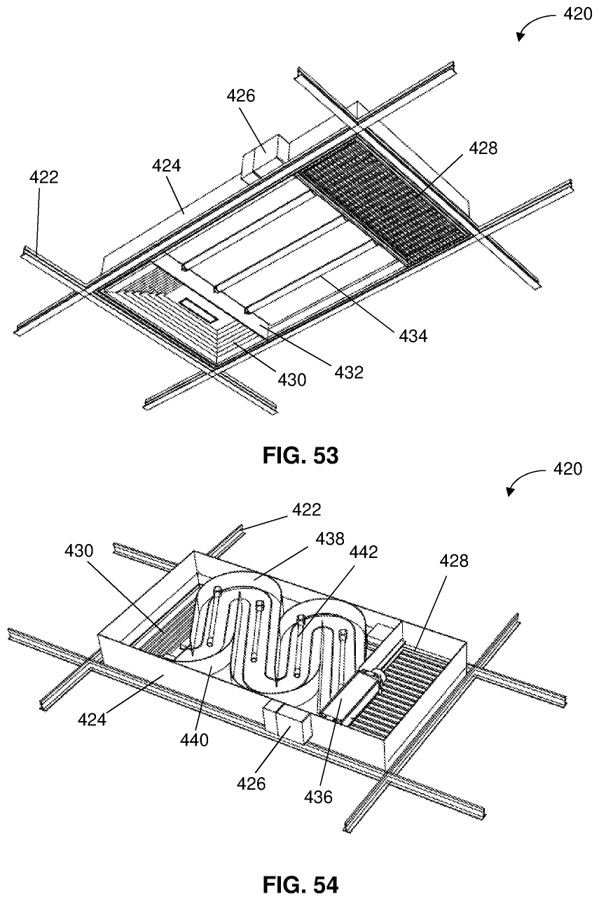

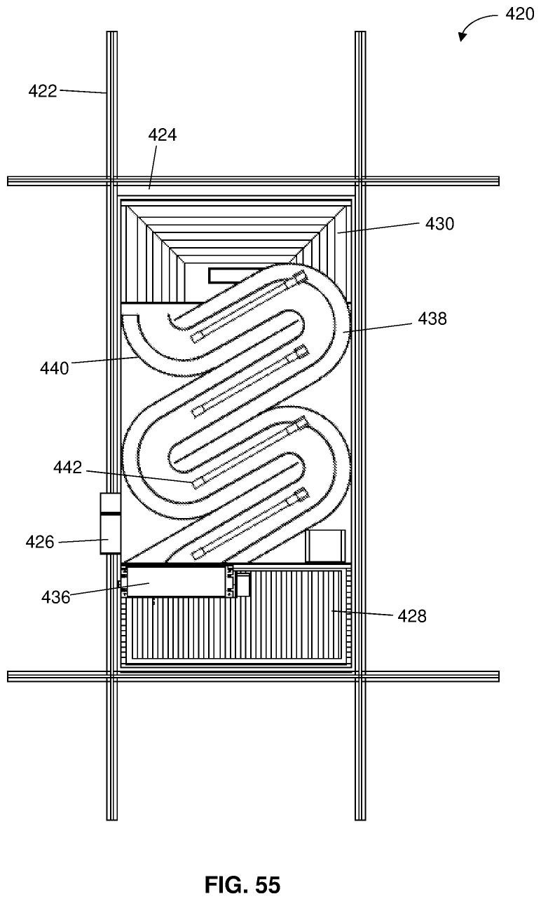

FIGS. 53-55 are perspective and cross-sectional views of an exemplary air purifier system 420 in the form of an in-ceiling unit. The in-ceiling mounted air purifier includes a serpentine path especially designed for a 2′×4′ ceiling grid. Such a device can serve as a single unit for rooms up to about 10×12×9′ or about 1,080 cubic feet. Output can be approximately 120-170 cfm, which enables the system 420 to completely clean the air in a room in about 5 to 7 minutes. The unit can be placed in a dropped or hung ceiling. Air is sucked in through an intake panel on one side of the unit. The air passes through a flat HEPA pre-filter before entering a serpentine air track. Particles are exposed to several high intensity UV-C bulbs before exiting the unit opposite from where the air entered the unit. to the system 420 can be used in any commercial setting (e.g., medical, educational, institutional, or the like) where air treatment is desired. Several units can be placed in the ceiling of large rooms to handle a high volume of air or particularly pathogen laden air. In some embodiments, the device can be configured to be installed in a 2′×2′ ceiling grid. Such unit would use a similar arrangement, including a filter to clean the air, and a fan for suction upward and exit of the air along and through the UV-C light's radiation to deactivate germs and viruses. The design can use a flat or round helical arrangement to increase dwell time along the UV-C light sources. The fan and lamp strength can be designed for larger and smaller rooms. In some embodiments, the system 420 can be used in, e.g., school corridors, classrooms, any large open space, offices, hospitals, or the like.

The system 420 can be installed in-between support beams 422 of a drop-ceiling installation, and can therefore be dimensioned complementary to panels of such installations. The system 420 includes a housing 424 with a junction box 426 positioned on an outer surface of the housing 424. The bottom or exterior surface of the system 420 (e.g., the surface facing the interior space for which purification is to be performed) includes an intake grid, louvers or openings 428, an output grid, louvers, or openings 430, and a recessed casing 432 with LED lights 434 (e.g., three LED tube lights) for illuminating the space below the system 420.

On the opposing side, the system 420 includes a hollow interior configured to encase the purification chamber. The system 420 includes a fan 436 for drawing air into the system 420 through the openings 428. The output of the fan 436 directs air into a serpentine or maze passage formed by curved and linear sections of inner walls 438, 440. In some embodiments, the walls 438, 440 can be substantially U-shaped and positioned adjacent to each other in a staggered and opposing orientation to form the continuous, curving passage for airflow towards the openings 430. Within the linear sections of the passage, the system 420 includes light sources 442 (e.g., LEDs or UV-C lamps) for killing of pathogens in the airflow.

In some embodiments, four UV-C lamps with 16 Watts each can be used in the system 420. In some embodiments, the effective length along the lamps can be about 31.64 inches. In some embodiments, the output of the system 420 can be about 140 cfm. The system 420 can be used to kill aerosolized pathogens in a room with a hung or dropped ceiling, by drawing in air at the ceiling level from one side of the unit and producing irradiated air from the opposite side of the unit, distributing clean air at the ceiling level. The air enters though the intake, is drawn through a serpentine chamber with UV-C irradiance, then exits through a ceiling level outlet.

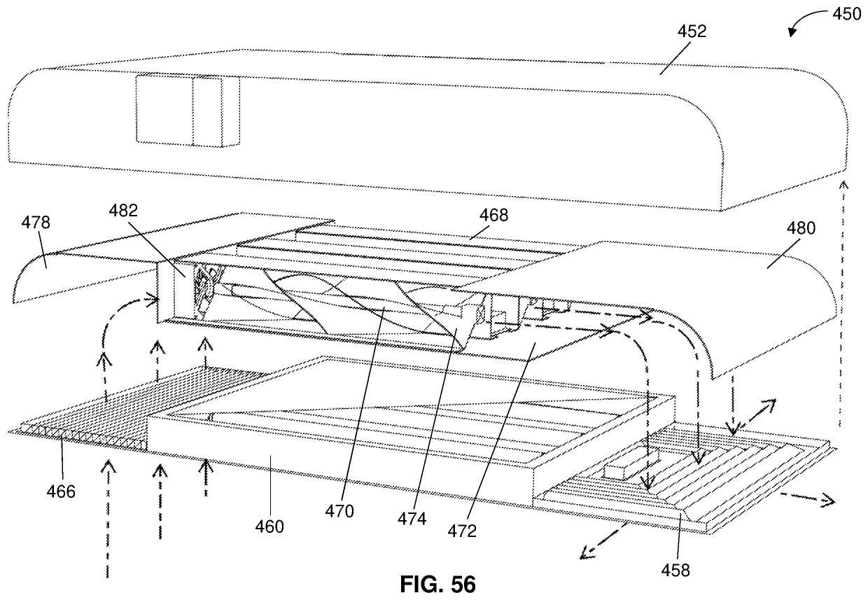

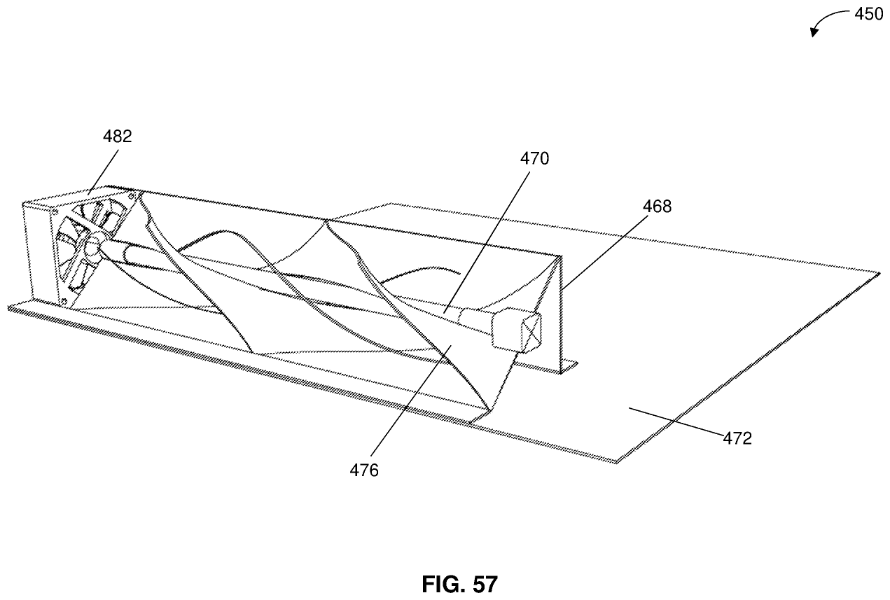

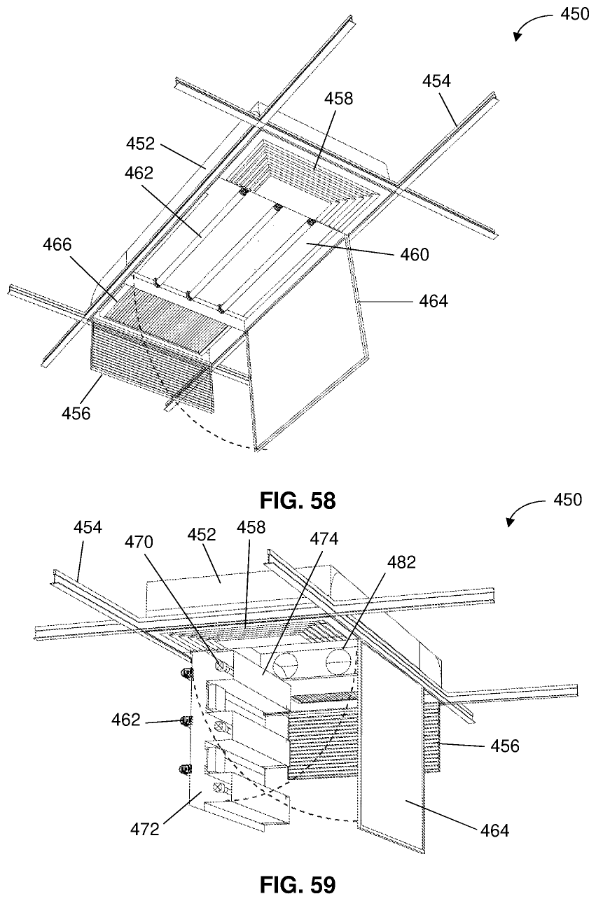

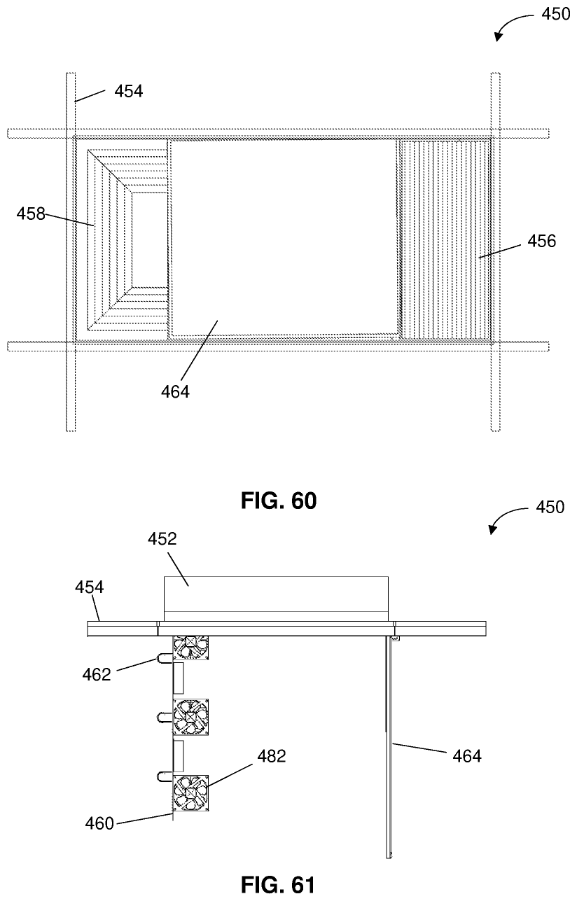

FIGS. 56-61 are perspective, partial and cross-sectional views of an exemplary air purifier system 450 in the form of an in-ceiling unit. The system 450 has a top, primary housing 452 that encases the internal components of the system 450. The housing 452 includes a generally rectangular configuration with curved side corners. The curved side corners define curved inner surfaces that assist with guiding the airflow through the purification chamber or section. The system 450 is configured to be installed between framing 454 of a drop-ceiling installation. The bottom of the system 450 includes intake louvers or openings 456, outlet louvers or openings 458, and a recessed light section 460 with lights 462 (e.g., LED tubes) extending between the openings 456, 458. The system 450 can include a filter 466 positioned adjacent to the openings 456 to filter air initially drawn into the system 450.

The openings 456 can be formed in a frame hingedly attached to the housing 452. The light section 460 can include a cover 464 capable of being pivoted into an open position to change the lights 462. As illustrated in FIG. 59, the light section 460 can be pivoted down from the assembly to expose the purification chamber to allow for changing of purification components. In particular, the top of the light section 460 can include a peaks and valleys configuration with a hollow interior 468 at the peaks to accommodate light sources 470. The peaks and valleys along with a planar base 472 form three independent purification chambers 474 extending between the openings 456, 458. Each chamber 474 includes the light source 470 extending the length of the chamber 474, and air guides 476 oriented in a helical manner around the light source 470 to create two helical pathways around each of the respective light sources 470. The system 450 includes curved top covers 478, 480 positioned above the chambers 474 to guide airflow towards the chambers 474 and towards the openings 458. Fans 482 are positioned at a proximal end of each of the chambers 474 to draw air into each of the respective chambers 474. Air drawn into the system 450 is therefore initially filtered, then passes through one of the chambers 474 for purification/irradiation, and is output from the openings 458.

In some embodiments, the system 450 can provide about 330 cfm, using three 48 or 21 Watt UV-C lamps. All air can be irradiated by about 17 mJ/cm². Three double helix purification chambers can be used. The curved top covers 478, 480 provide intake and output scoops for guiding the flow of air through the system 450. In some embodiments, the lights for illuminating the space below the system 450 can be 24 inch LED downlights. In some embodiments, the openings 458 can be in the form of 3 way outlet louvers. Each purification chamber has dual air paths, each about 16.27 in length along an arc length of about 13.78 inches, ensuring that all air is irradiated to 17 mJ/cm² in a single pass.

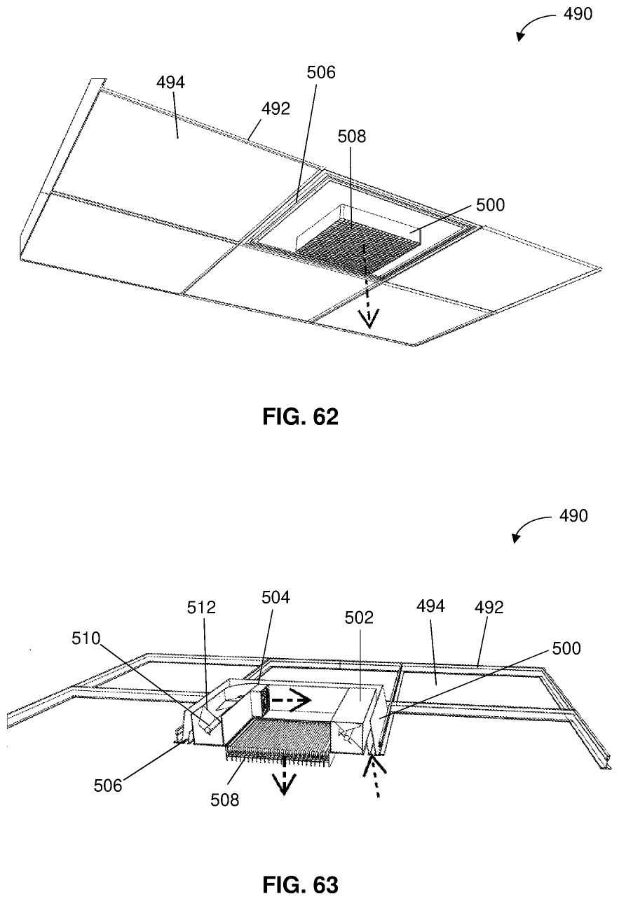

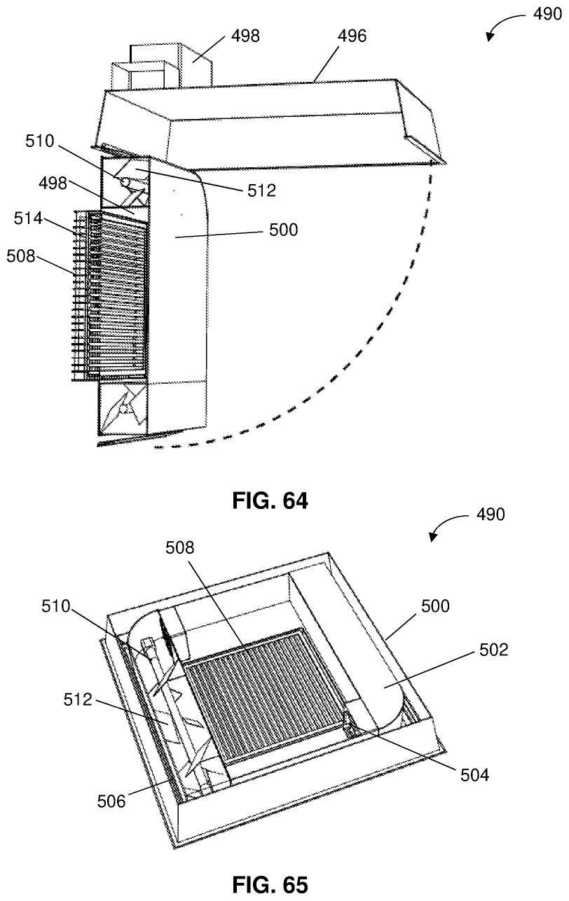

FIGS. 62-65 are perspective and cross-sectional views of an exemplary air purifier system 490 in the form of an in-ceiling unit. The system 490 can be incorporated into a drop ceiling and can be disposed at partially in and/or at least partially below the ceiling. The unit is designed to kill aerosolized pathogens in a room with a hung or dropped ceiling by drawing in air at the ceiling level from a continuous perimeter intake and producing irradiated and filtered air from the bottom of the apparatus. The unit distributes a down draft of clean air from the ceiling level. The air enters though the intake, is drawn through one of two helical ramp chambers with UV-C irradiance, passes through a MERV (13 minimum) or HEPA filter, and then exits through a central ceiling level outlet. The unit does not have an integral ceiling light. In some embodiments, the system 490 can output about 180 cfm using two 48 Watt light sources.

The system 490 is configured to be installed in-between frame structures 492 of a drop ceiling installation, and therefore defines dimensions substantially similar to a tile 494. In some embodiments, the system 490 can be installed within an opening of a tile 494, with the system 490 partially extending below the plane defined by the ceiling. The system 490 includes a primary housing 496 configured to surround all internal components from at least the sides and top. The internal components can be configured to pivot out from the housing 496 and, in some embodiments, can be completely removed as an assembly from the housing 496. The system 490 includes a junction box 498 at the top of the housing 496 for operating the system 490. The internal components are surrounded by a secondary inner housing 500 which is joined to two purification chambers 502 to define an airflow passage within the system 490.

The two chambers 502 are positioned on opposing sides of the inner housing 500, with each chamber 502 associated with a respective fan 504. A gap 506 between the housings 496, 500 acts as a continuous, perimeter intake opening for drawing air into the system 490. A substantially square grid or array of louvers or openings 508 is positioned between the chambers 502 and defines the outlet of the system 490. A filter 514 can be positioned within the structure of the openings 508 to filter the output air. Each chamber 502 includes an elongated light source 510 extending the length of the chamber 502. Each chamber 502 includes air guides 512 positioned radially around the light source 510. In some embodiments, the air guides 512 can be in a substantially continuous helical configuration. In some embodiments, the air guides 512 can be formed as spiral fins, planes or deflectors radially spaced from each other to create turbulent airflow within the chambers 502. The spiraling array of inclined air guides 512 surrounding the light source 510 deflect approximately 15% of the air at each location and redirect the air to mix with the central air flow. Such design can define a static mixer configuration.

In some embodiments, the system 490 can be about 24 inches×24 inches in side. The system 490 can include two 48 Watt GPH436 T5 bulbs, and can provide about 180 cfm downward through a central 12×12 inch grille. The perimeter intake can feed two inlets with 3.625 inch square aluminum chambers of about 19 inches long. The UV-C lamps can be in aluminum chambers containing fins for air turbulence along the path. Two DC PWM axial fans (80×80×38 mm each) can pull air through the chambers, with each fan capable of about 120 cfm each. The output grille can provide for laminar airflow of about 100 fpm. The unit can swing downward for filter and lamp changing.

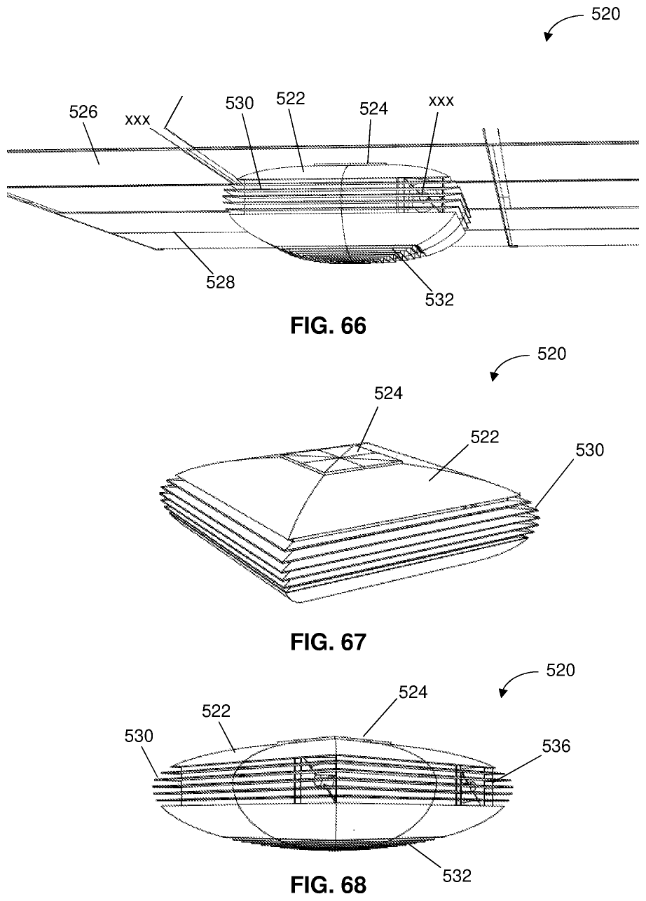

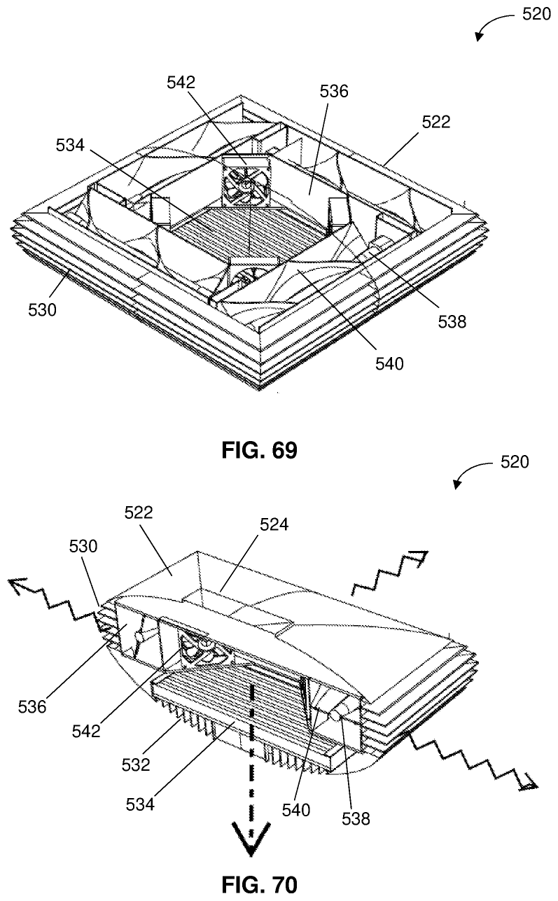

FIGS. 66-70 are perspective and cross-sectional views of an exemplary air purifier system 520 in the form of a below ceiling unit. The system 520 can incorporate a helical ramp internal configuration with four 35 Watt light sources, capable of outputting about 280 cfm. The system 520 includes an outer housing 522 with an attachment section 524 at the top of the housing 522 for mounting the system 520 to the ceiling. In some embodiments, the system 520 can be secured to a tile 526 of a drop ceiling framework 528. The housing 522 can define a substantially rectangular or square configuration. Louvers 530 extending around the perimeter of the housing 522 at a central location (relative to the top and bottom of the housing 522) can provide for an outlet of purified air in directions substantially perpendicular to the central longitudinal axis of the system 520. The system 520 can also include louvers 532 at the bottom of the housing 522 for output of purified air through an additional opening in a downward direction. In some embodiments, a filter 534 can be positioned adjacent to the louvers 532.

Within the hollow interior of the housing 522, the system 520 includes four substantially rectangular chambers 536 positioned at 90 degrees relative to each other and positioned over and around the louvers 532. The chambers 536 together form a space around the entire inner perimeter for circulation of air. Each chamber includes a light source 538 extending the length of the respective chamber 536, and air guides 540 in the form of continuous helical structures positioned over the light sources 538. Four fans 542 can be positioned adjacent to respective corner connections between chambers 536. The chambers 536 extend to the louvers 530 at each corner of the system 520. The fans 542 draw air into the respective chambers 536 through the louvers 530, the air is purified in the chambers 536 and is subsequently released through the louvers 532 and/or louvers 530. In some embodiments, the system 490 can provide for a downdraft and upper level UV-C air purifier. The system 520 can use four 16 Watt GPH287 bulbs, equaling 64 Watts total. The system 520 can use four DC PWN fans, each about 60 cfm and variable speed, totaling about 100 to 200 cfm for the system 520. The unit can be about 19 inches×19 inches, and about 8 inches high.

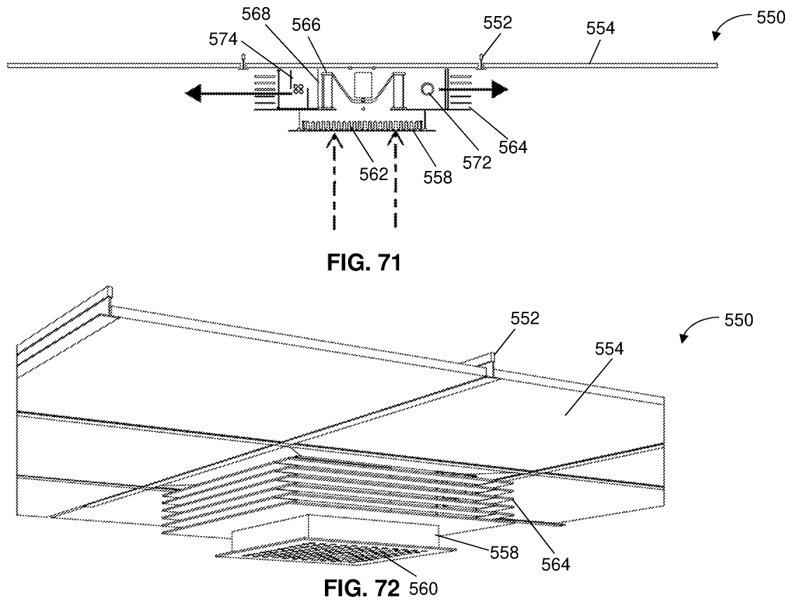

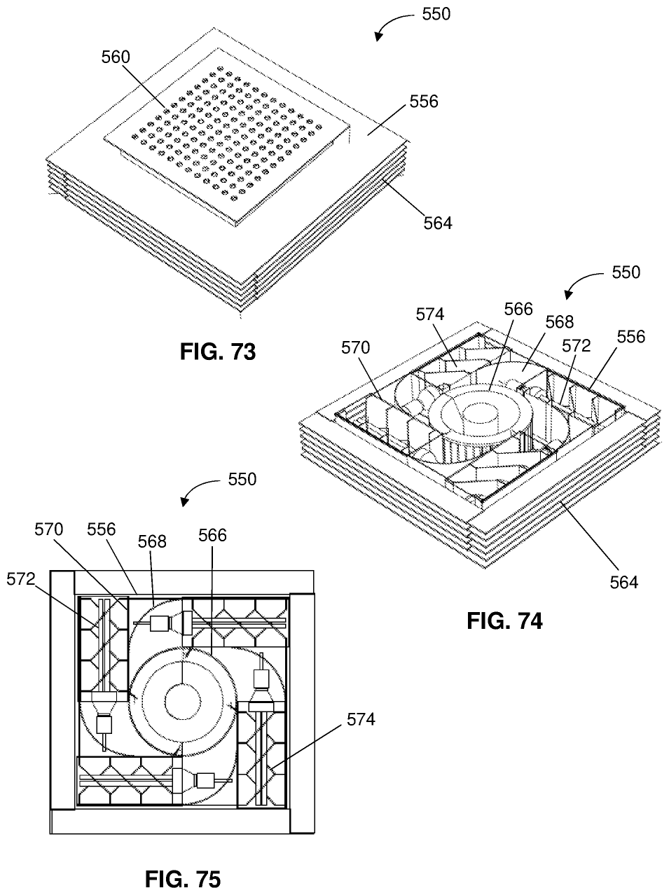

FIGS. 71-78 are perspective and cross-sectional views of an exemplary air purifier system 550 in the form of a below ceiling unit. The system 550 can be a fan drive UV-C device using four 35 Watt 120 Volt tube lamps. Each chamber or cell can output about 20 cfm outward with 80-90 cfm total for the system 550. Each cell wall can include a quartz side wall allowing UV-C radiation to go outward through louvered sides. Such radiation therefore illuminates at least a portion of the upper level of the room surrounding the system 550 to further assist in purifying the air in the room. The system 550 includes air guides in either a flat, ramped helix configuration in a round tube housing or a round helix configuration in a square tube housing. The system 550 can be secured to framing 552 of a drop ceiling installation and/or against a ceiling tile 554.

The system 550 includes a housing 556 enclosing all internal components. The bottom of the system 550 includes a filter housing 558 extending from the bottom of the housing 556, the filter housing 558 including intake louvers or openings 560 (e.g., an array of circular holes). The interior of the housing 558 is configured to support a filter 562. The entire perimeter or sides of the housing 556 include outlet louvers or openings 564. Air can thereby be drawn into the system 550 from the bottom of the system 550, and is expelled substantially horizontally or parallel to the ceiling plane. Centrally disposed within the housing 556 is a fan 566 which draws air into the system 550.

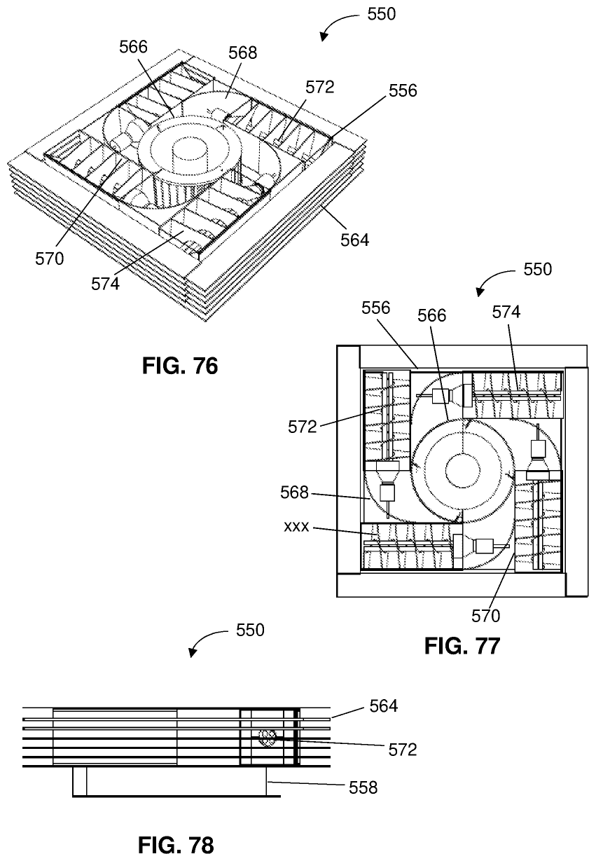

Within the housing 556, the system 550 includes inner walls 568 (e.g., curved walls that extend from the fan 566 and linear walls extending from the curved walls), which define the purification chambers 570. The system 550 can include four chambers 570 oriented about 90 degrees from each other, with the inlet of the chambers 570 oriented towards the fan 566 and the output of the chambers 570 oriented towards the openings 564. Each chamber 570 includes a light source 572 extending at least the linear extension of the chamber 570. The distal end of the light source 572 is positioned adjacent to the openings 564 such that at least some of the UV-C light is emitted out of the openings 564. The chambers 570 include air guides 574 positioned around the light sources 572 to create a curved or helical pathway around the light sources 572. In some embodiments, the air guides 574 can be in the form of a flat, ramped helix configuration forming two opposing direction pathways (see, e.g., FIGS. 74-75). In some embodiments, the air guides 574 can be in the form of a round, continuous helix forming a single unidirectional pathway (see, e.g., FIGS. 76-77).

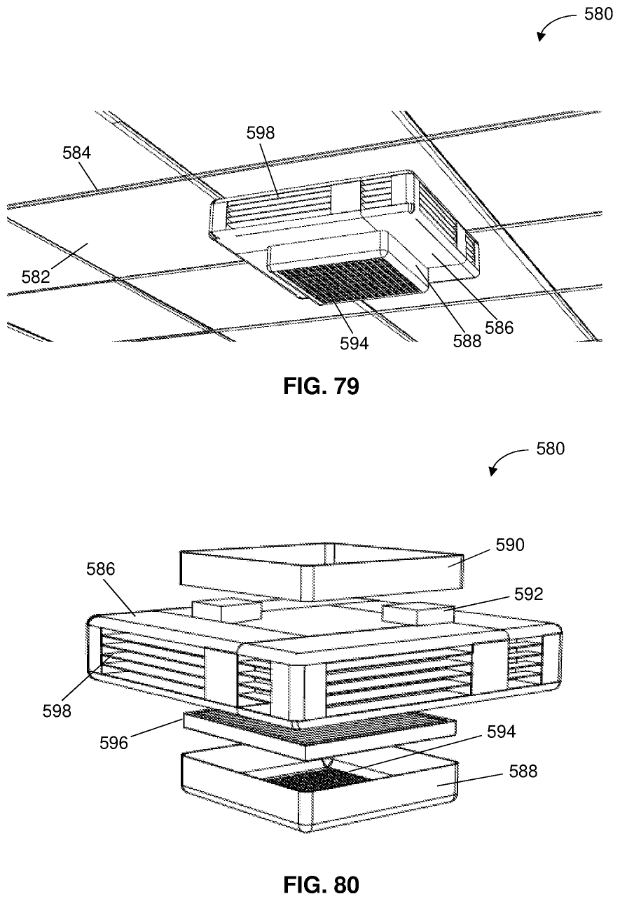

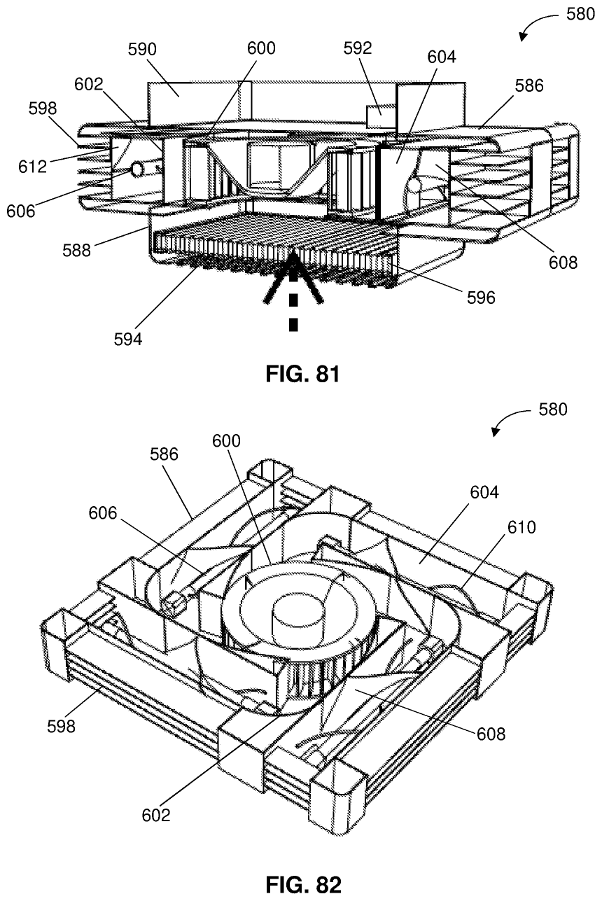

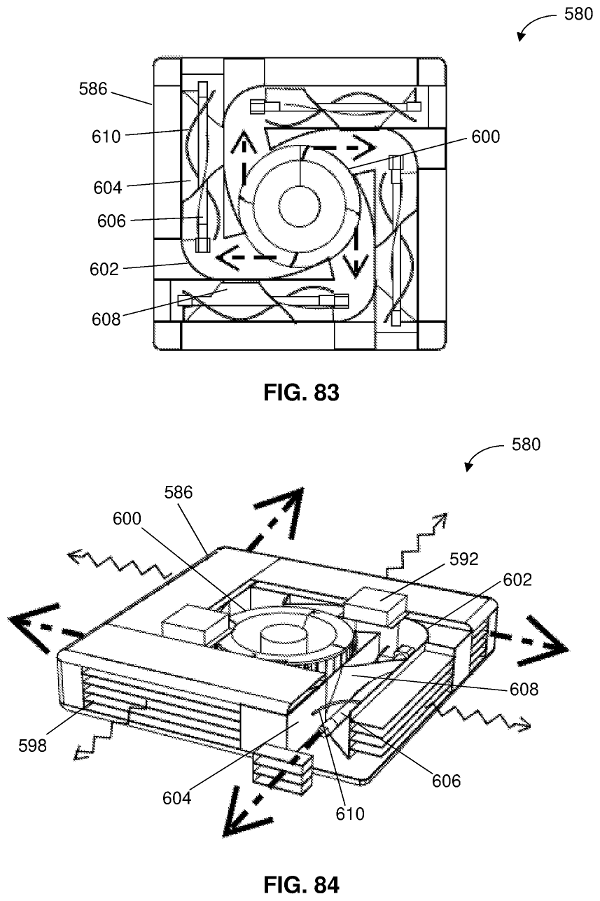

FIGS. 79-84 are perspective, exploded and cross-sectional views of an exemplary air purifier system 580 in the form of a below ceiling unit. The system 580 can be an upper level air purifier with a blower and helix. The system 580 can include four 16 Watt GPH287 four pin lamps, and can achieve about 280 cfm with air irradiation through the sides. In some embodiments, four 35 Watt lamps can be used with a 100 cfm output. The unit can be pendant mounted to bring the unit lower, although it is illustrated on a 9 foot high ceiling herein. Air enters the unit from below and a single helix in each chamber around a 16 Watt lamp provides purification of the air. The unit can include an attachment canopy for attachment to the ceiling. UV-C light can be emitted outward through side louvers due to quartz glass sides of the unit (e.g., side louvers formed from quartz glass).

The system 580 can be mounted to a ceiling or tiles 582 supported by framework 584. The system 580 includes a primary housing 586, a filter housing 588 coupled to the bottom of the housing 586, and a mounting canopy 590 coupled to the top of the housing 586. The canopy 590 can include blocks 592 configured to assist with mounting of the system 580 to the ceiling. The filter housing 586 includes louvers or openings 594 on a bottom surface for intake of air, and supports a filter 596 within the interior of the housing 586 adjacent to the openings 594. The housing 586 includes side walls with louvers or openings 598 formed therein for output of purified air and at least a portion of the UV-C light.

A fan 600 is positioned centrally within the hollow interior of the housing 586. Inner walls 602 (both curved and linear) surround the fan 600 and define four individual and independent purification chambers 604, each oriented about 90 degrees from the other chambers 604. The curved inner walls 602 direct air from the fan 600 to the purification chambers 604, and the linear inner walls 602 define the primary purification section before expelling the purified air from the distal end of the purification chamber 604. Thus, the fan 600 directs air into four different directions to their respective chambers 604 for purification. Each chamber 604 includes a light source 606 extending the length of at least the linear section of the chamber 604, and air guides 608 positioned around the light source 606 to create a helical pathway 610. In some embodiments, at least a portion 612 of the outer wall of the chambers 604 can be fabricated from quartz to allow for projection of the UV light outward from the chamber 604 through the louvers 598. Such quartz design can be incorporated into other systems discussed herein.

In some embodiments, one or more of the below ceiling systems can be a true helix, ceiling-mounted, fan-assisted UV-C air purifier. The units use four square chambers, each having a helical or flap ramp around a 35 watt UV-C lamp. The size assures a tight path several times around the lamp for complete deactivation of the pathogens. In some embodiments, the maximum distance from the lamp can be equal to or less than 2.5″. The increased dwell time, the short distance from the bulb and the radiance of the lamp assure at least 99% deactivation. Approximate output of the systems can be about 400 CFM, enough to clear a 20′×20′ room, 10′ high every 6 minutes.

In some embodiments, one or more of the below ceiling systems can be a flat-helix, ceiling-mounted, fan-assisted embodiment for an UV-C air purifier. The unit can use four square chambers, each with a flat, pseudo helical ramp around a 35 watt UV-C lamp. The size assures a tight path several times around the lamp for complete deactivation of the pathogens. The maximum distance from the lamp can be equal to or less than 2.5″. The increased dwell time, the short distance from the bulb and the radiance of the lamp assure at least 99% deactivation. Approximate output can be about 450 is CFM, which is enough to clear a 20′×20′×10′ room every 5 minutes.

In some embodiments, one or more of the below ceiling systems can be an upper level fan driven, filtered, embodiment for an UV-C air purifier. The unit can use laminar airflow around a horizontal lamp to deactivate pathogens. The air is drawn through the filter from below and distributed to four openings open to the sides. The open louvers allow the UV-C rays to extend horizontally and interact with all of the upper level air in the room which circulate by convection currents. The combination of forced air circulation and static UV-C light has a symbiotic effect. The maximum distance from the lamp is equal to or less than 1.5″. Despite the relatively short dwell time, the close proximity to the bulb and the radiance of the lamp assure at least 99% deactivation. The approximate output can be about 450 CFM, enough to clear a 20′×20′×10′ room every 5 minutes.

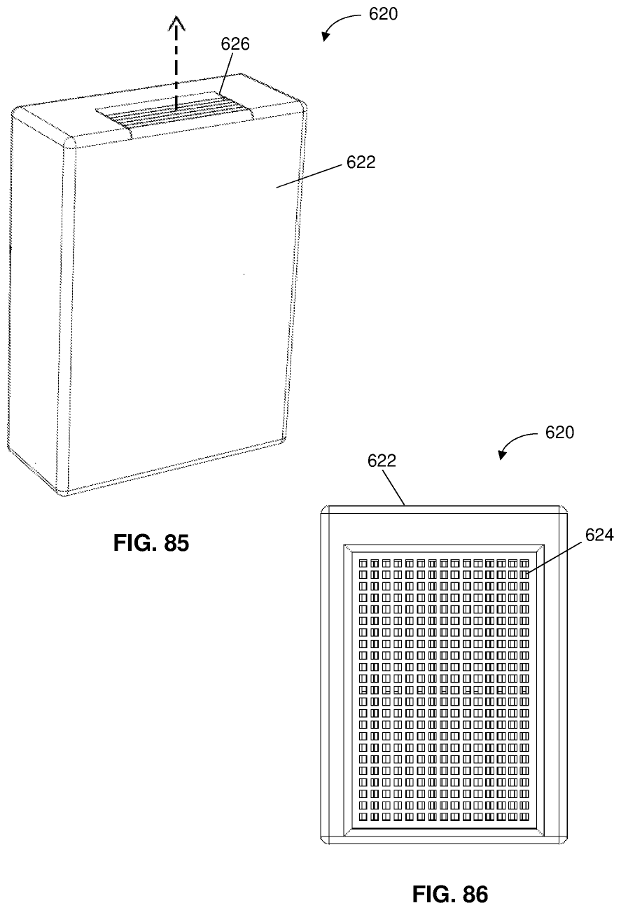

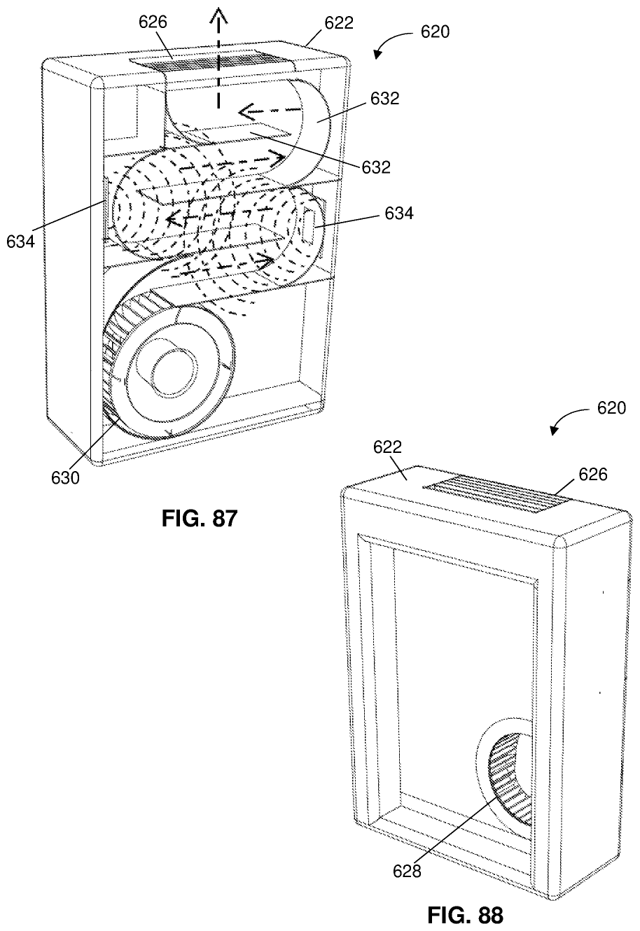

FIGS. 85-88 are perspective and cross-sectional views of an exemplary air purifier system 620 in the form of a standalone unit. The system 620 can use microwave deactivation of viruses in a fan driven filtered air purifier arrangement. Viruses can be deactivated in laboratory settings using microwaves, RF waves of other wavelengths, and possibly acoustic waves. FIGS. 85-88 illustrate a design using directed microwaves in a serpentine waveguide to deactivate the viruses which pass through the filter. Recent designs of solid state microwave transducers allow for smaller emitters than the magnetrons used in kitchen microwaves. Thus, a maze or serpentine inner chamber design can be used in combination with microwave emitters tuned to specific wavelengths to inactivate viruses passing through the air. In some embodiments, a VDMOS/LDMOS solid state microwave emitter can be used.

In some embodiments, the system 620 can be used in institutional, commercial, or residential settings. The unit can be designed to capture and kill aerosolized pathogens circulating in a room by drawing in air at the floor level from the bottom of the unit and producing irradiated air from the table height outlet on the top of the apparatus; distributing clean air at face level. The air enters though the intake, is drawn through a serpentine air chamber with microwave irradiance, and then exits through the top level outlet. The unit can be mounted on wheels for easier temporary application.

The system 620 includes an outer housing 622 defining a substantially rectangular configuration. The front or rear surface of the housing 622 includes a filter 624 for filtering of intake air. The top surface of the housing 622 includes louvers or openings 626 for output of purified air into the surrounding space. The housing 622 includes an intake opening 628 formed in the front or rear surface corresponding with a position of a fan 630. The fan 630 draws air into the opening 628 through the filter 624. The hollow interior of the housing 622 includes inner walls 632 (e.g., curved and linear walls) that generally define a U-shaped configuration. Multiple walls 632 positioned adjacent to each other and in opposing relationship define an inner serpentine or maze channel extending from the fan 630 to the openings 626. Mounted along inner surfaces of the housing 622 are microwave emitters 634 that are programmed to emit a predetermined bandwidth of microwaves for purification of the air flowing through the system 620. In some embodiments, the microwave emitters 634 can be combined with the UV-C and/or LED light sources discussed herein.

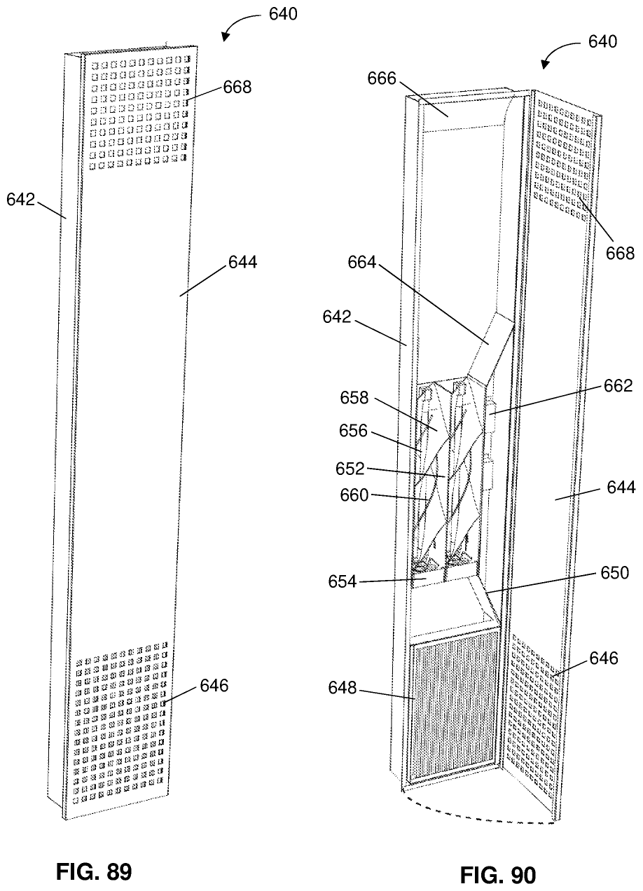

FIGS. 89-92 are perspective views of an exemplary air purifier system 640 in the form of an in-wall unit. The system 640 can be an in wall fan driven filtered UV-C air purifier. The unit is designed to be recessed into an approximately 2×3 or 2×4 stud wall, typically found in offices, schools, entry areas, hospital corridors and residential facilities. is the unit can be powered by 120 volt AC, and runs silently, sucking air from the bottom, starting about 6″ off the floor, filtering the air and then irradiating the air with two 35 watt UV-C lamps in a double helix to deactivate pathogens which are not stopped by the filter. The air exits at the top of the unit. The unit can clear the air in a 1,800 cubic feet space every six minutes. In deeper walls, a larger unit can be made with more fan depth and greater output.

In some embodiments, the system 640 can output about 240 cfm using two 100 cfm DC PWN variable speed fans. In some embodiments, two 48 Watt GPH436 T5 bulbs can be used. The system 640 can include a door capable of pivoting outward by about 90 degrees. The system 640 can include a scoop within the housing to deflect air outward. The system 640 can include an 18 inch vertical clearance zone to remove and relamp bulbs. An aluminum purification chamber can be used for the light sources. A 12″×16″×1″ HEPA or MERV 13 filter can be used. Ballasts, low voltage transformers, junction box, speed controls, and general controls can be provided at a user interface panel. The unit is designed to capture and kill aerosolized pathogens circulating in a room, by drawing in air at the floor level from the bottom of the unit and producing filtered and irradiated air from the face level outlet on the front of the apparatus. The air enters though the intake, is drawn through a HEPA filter, through one of two helical ramp air chambers with UV-C irradiance, and then exits through face level. The unit can be mounted in any standard framed wall deeper than 3″, and can be used in institutional, commercial, office or hotel settings.

The system 640 includes a housing 642 with a front panel or door 644 capable of being pivoted out into an open position to expose internal components of the system 640. At or near the bottom of the front face of the housing 642, an array of intake openings 646 is formed to correspond with a filter 648 size disposed within the hollow interior of the housing 642. Behind the filter 648 can be space formed by walls of the housing 642 and guiding air into a duct or passage 650 (e.g., narrowing ramp section) towards the purification chambers 652. Fans 654 for each of the chambers 652 can be positioned adjacent to the proximal or bottom end of the chamber 652 to draw air into the chamber 652.

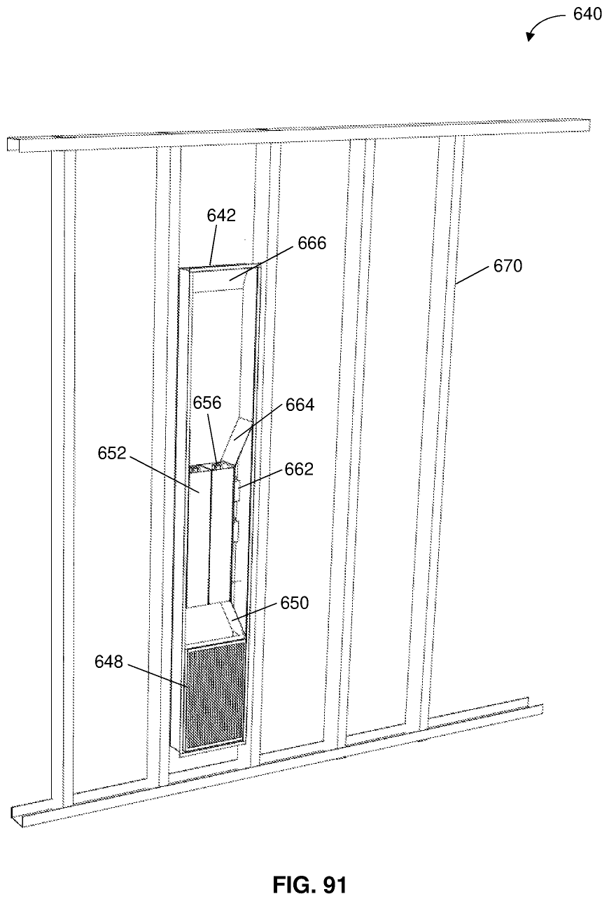

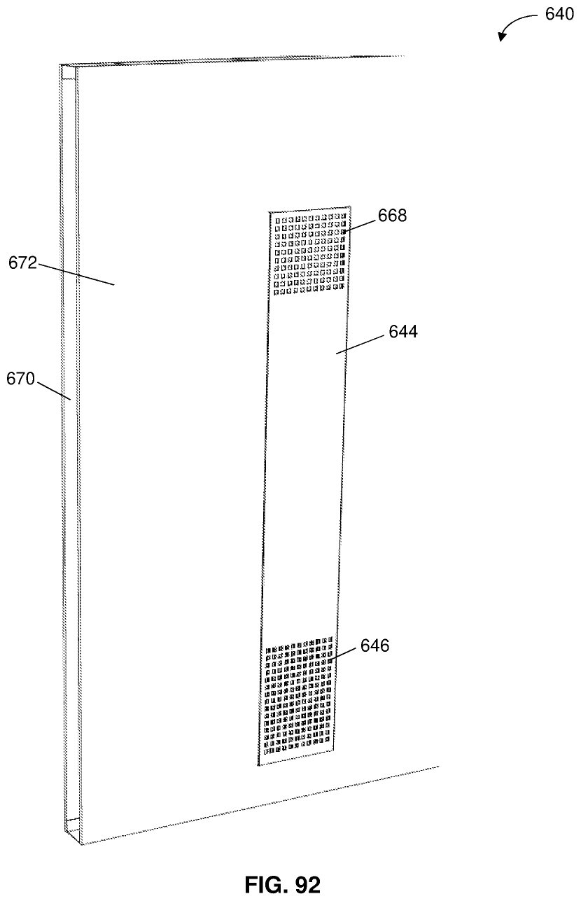

Each chamber 652 defines an elongated, linear passage with a light source 656 extending the length of the chamber 652. An aluminum air guide 658 curves around the light source 656 to define a helical pathway 660 within the chamber 652. Electronics or controls 662 for operating the system 640 can be disposed in an adjacent, separated chamber of the system 640. The interior of the housing 642 includes an expanding ramp section 664 for directing purified air into the open space of the housing 642. A curved or scoop section 666 at the inner top area of the housing 642 guides purified air outward through an array of outlet openings 668 formed at or near the top of the door 664. FIGS. 91 and 92 show the system 640 installed between wall studs 670 and sheetrock 672 installed over the studs 670, resulting in a door 644 that is substantially in-line with the plane defined by the outer surface of the sheetrock 672.

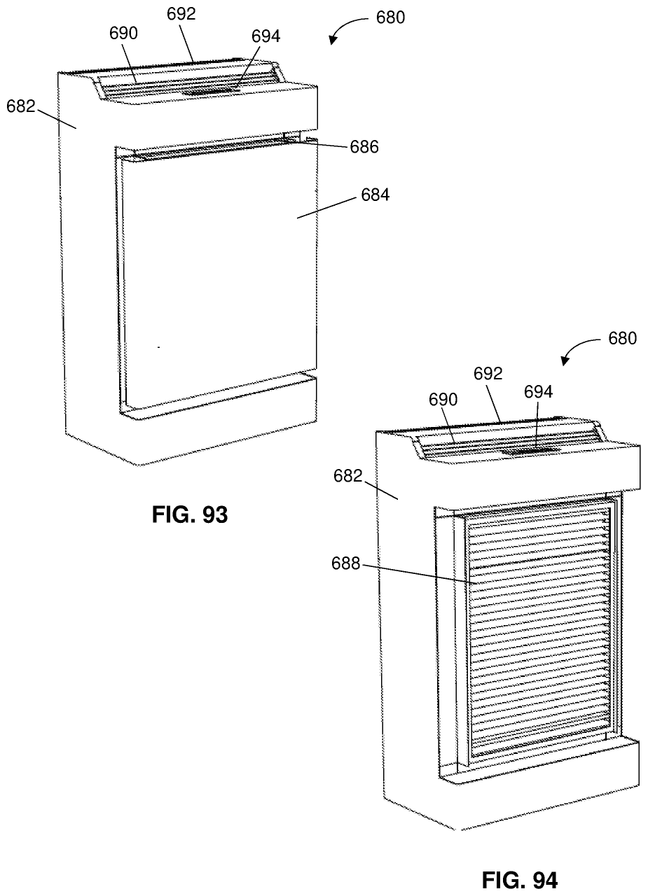

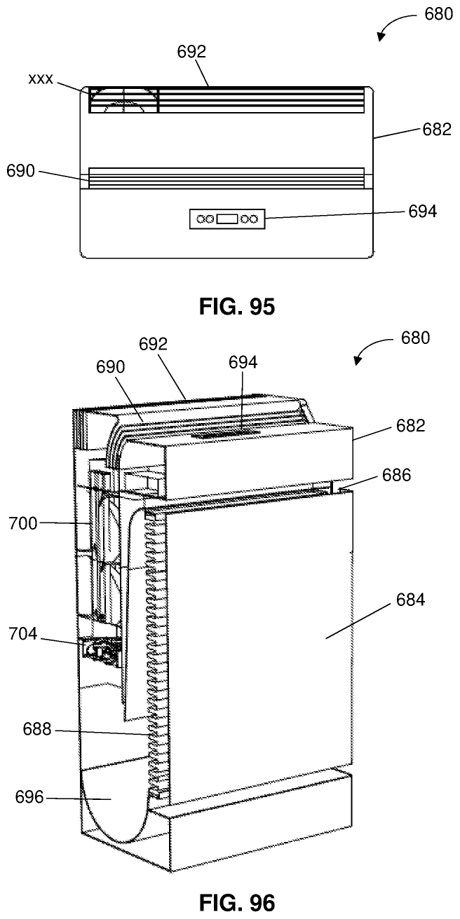

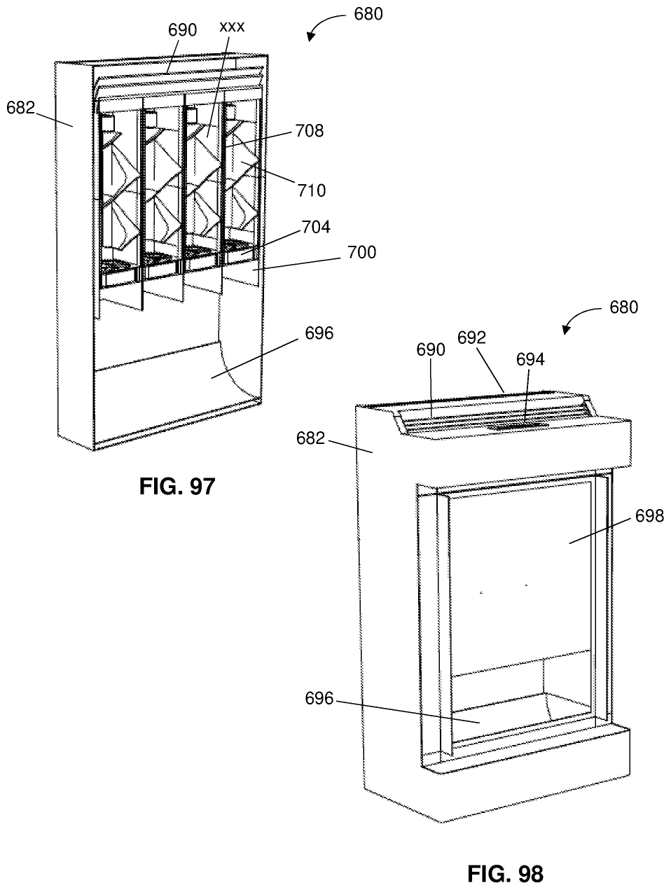

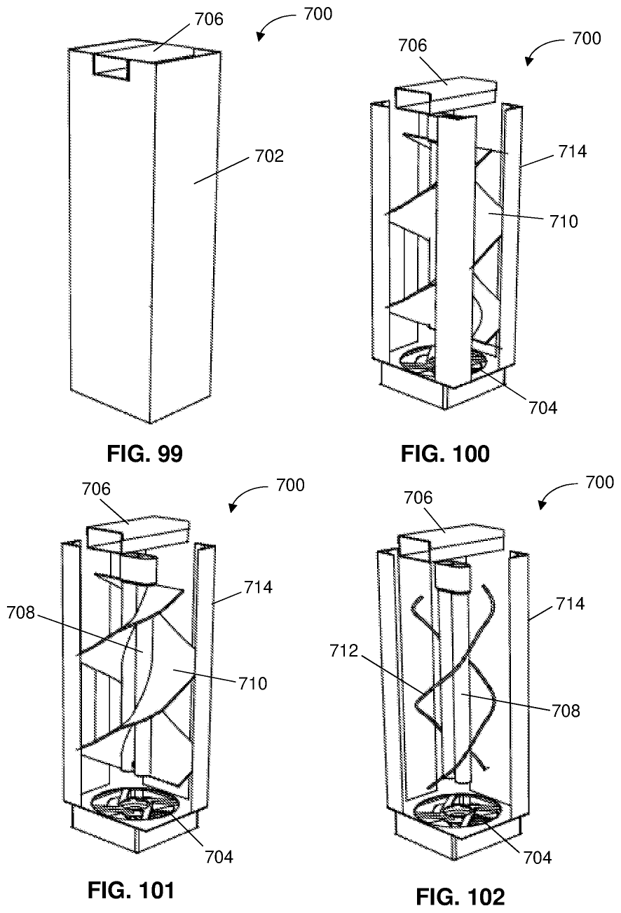

FIGS. 93-102 are perspective, partial and cross-sectional views of an exemplary air purifier system 680 in the form of a standalone unit. The system 680 can include dual helical paths in each of four chambers. Each chamber height can be about 3.776 inches. In some embodiments, the system 680 can be used to serve a space of about 400 sq/ft (about 25′×16′×10′), having an output of about 400 cfm and using four 18 Watt lamps. However, it should be understood that the square footage values for the space served and the cfm output of this system 680 (as well as other systems discussed here) are only estimates, and the systems can be used to purify air in a variety of spaces. The unit is designed to capture and kill aerosolized pathogens circulating in a room by drawing in air at the floor level from the face of the unit and producing filtered and irradiated air from the table height outlet on the top of apparatus, distributing clean air at face level. The air enters though the intake, is drawn through a HEPA filter, passes through one of four helical ramp air chambers with UV-C irradiance, and then exits through a top level outlet. The unit can be mounted on wheels for easier temporary application and transport.

The system 680 includes a primary housing 682 defining a substantially rectangular configuration and including a front, removable panel or cover 684 at the front. The cover 684 fits such that a perimeter gap 686 is formed between the outer edge of the cover 684 and the recessed front surface of the housing 682. The gap 686 serves as an intake of air into the system 680. In particular, the housing 682 supports a filter 688 in the recessed front surface directly behind the cover such that any air drawn in through the gap 686 passes initially through the filter 688. The top of the housing 680 includes one set of output louvers or openings 690 along an angled surface (relative to horizontal) and a second set of output louvers or openings 692 at or near the back of the top surface and along a flat area of the top surface. Such double louver configuration allows for some purified air to be output vertically out of the unit and another portion of the purified air to be output at an angle towards the front of the system 680. A user control panel 694 can be positioned at the top surface near the front of the housing 682 to allow for convenient operation of the system 680.

Behind the filter 688, the hollow interior of the housing 682 includes a duct or passage 696 at the bottom of the system 680 with a scooped or curved section to direct air upwards into an inner housing 698 having purification chambers 700 therein. Each chamber 700 can be formed from substantially flat or planar walls 702 (supported by corner struts 714) that form an elongated, rectangular inner passage. At the bottom of each chamber 700, the system 680 includes a circumferential fan 704 dedicated to serving the respective chamber 700. The fans 704 work together to draw air into the system and direct air through the chambers 700 for purification prior to outputting the air through both openings 690, 692. At the top of each chamber 700, the system 680 includes a hollow block 706 extending perpendicularly relative to the central longitudinal axis of the chamber 700. The block 706 can provide a wireway or conduit for passage of electrical wires for one or more of the components of the system 680. Each chamber 700 includes an elongated light source 708 extending the length of the chamber 700, and air guides 710 curved in a helical manner around the light source 708 to form two helical pathways 712 through the chamber 700. The four chambers 700 therefore work together to purify air passing through the system 680, and output purified air in two directions to serve the surrounding space.

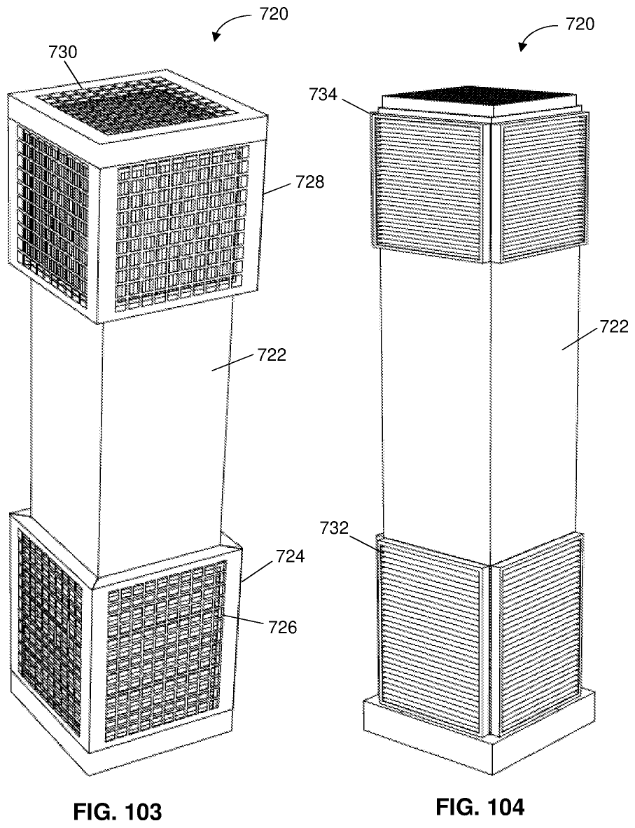

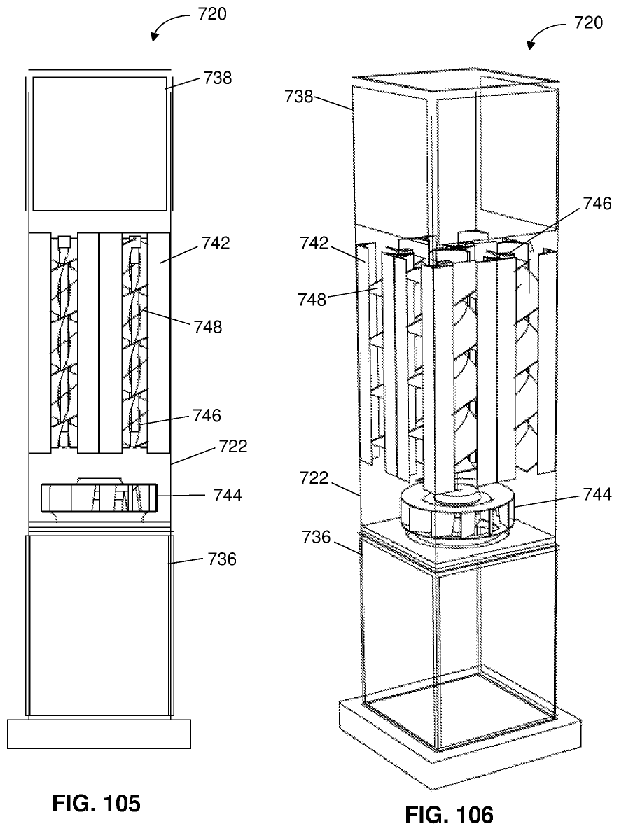

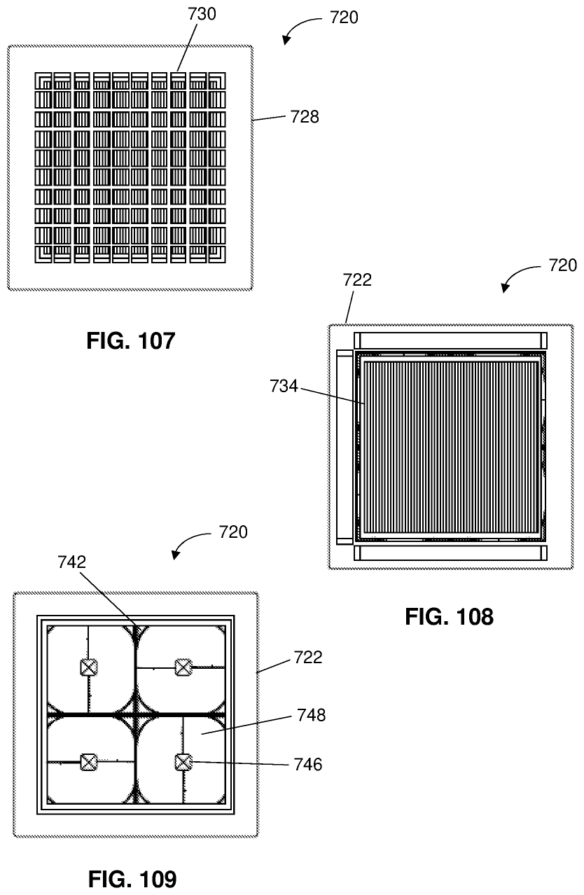

FIGS. 103-113 are perspective, partial and cross-sectional views of an exemplary air purifier system 720 in the form of a vertical, large room unit. In some embodiments, the helical ramp configuration of the system 720 can be used to serve a space of about 680 sq/ft (about 32′×21′×10′) with an output of about 680 cfm, using four 48 Watt lamps. The system 720 can be used in, e.g., institutional, commercial, classroom, boardroom settings, or the like. The unit is designed to capture and kill aerosolized pathogens circulating in a large room by drawing in air from three sides at the floor level from the bottom of the unit and producing filtered and irradiated air from the head height four outlets on the top and sides of the apparatus, distributing clean air at face level. The air enters though the intake, is drawn through HEPA filters, passes through one of four helical ramp air chambers with UV-C irradiance, and then exits through top level outlets.

The system 720 includes a housing 722 in the form of a vertically oriented, substantially rectangular post. At or near the base of the housing 722, the system 720 includes a filter cover 724 with an array of openings 726 on at least three sides of the cover 724. In some embodiments, each of the four sides of the cover 724 includes the array of openings 726 which serve as an inlet for air. At or near the top of the housing 722, the system 720 includes a second filter cover 728 with an array of openings 730 on at least three sides of the cover 728. In some embodiments, each of the four sides of the cover 728, as well as the top of the cover 728, includes the array of openings 730 which serve as outlets for purified air. Air to be purified is therefore drawn in at or near the floor level, and purified air is output at face level in horizontal and vertical directions. Behind the respective covers 724, 728, the system 720 includes filters 732, 734 (e.g., HEPA, MERV 13, or the like) for filtering air both at the intake and output. Behind the filters 732, 734 are openings 736, 738 leading to the hollow interior of the housing 722. The hollow interior has a bottom volume for filtered, unpurified air and a top volume for filtered and purified air.

In-between these volumes and substantially centrally positioned within the housing 722, the system 720 includes four purification chambers 740 positioned adjacent to each other. Each chamber 740 defines a substantially elongated, rectangular configuration and includes mounting corner struts 742 for mounting to inner walls of the housing 722. Below the chambers 740 is a fan 744 for drawing air into the system 720 and directing air out of the system 720. In some embodiments, each of the chambers 740 can include a dedicated fan. Each chamber 740 includes a light source 746 extending the length of the chamber 740 and aligned along a central longitudinal axis of the chamber 740. Each chamber 740 includes air guides 748 forming a continuous, helical pattern around the light source 746 such that two helical pathways 750 in opposing directions (clockwise and counterclockwise) are formed in each chamber 740.

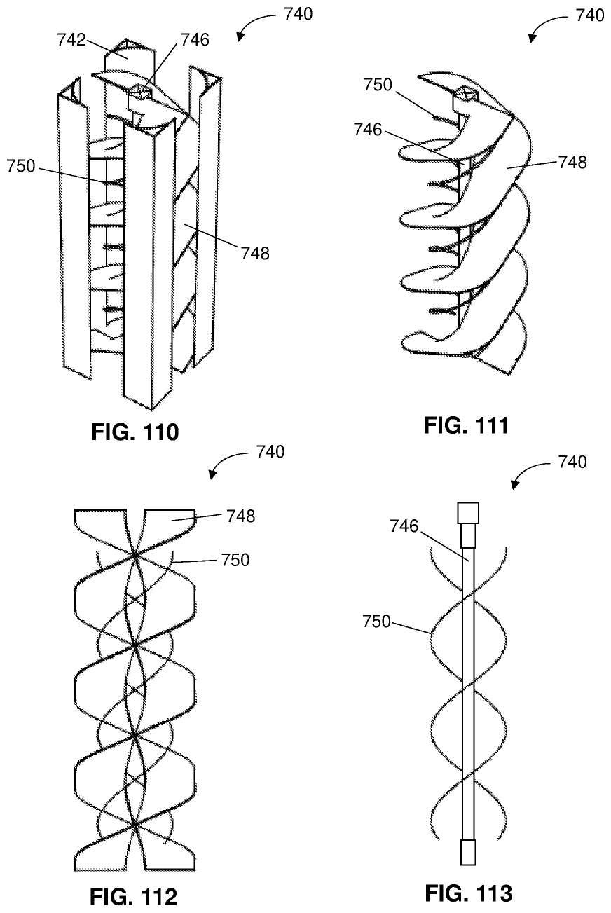

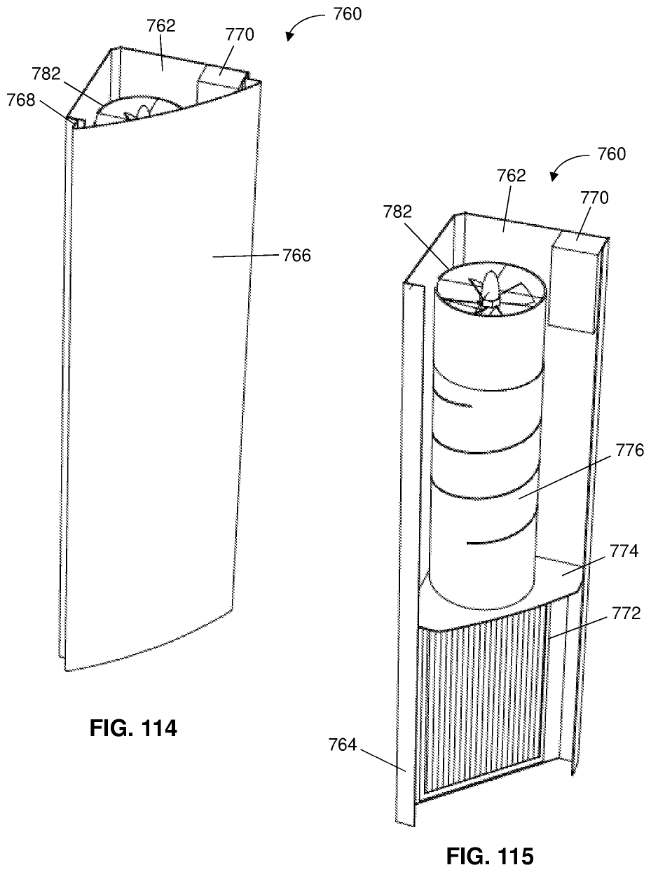

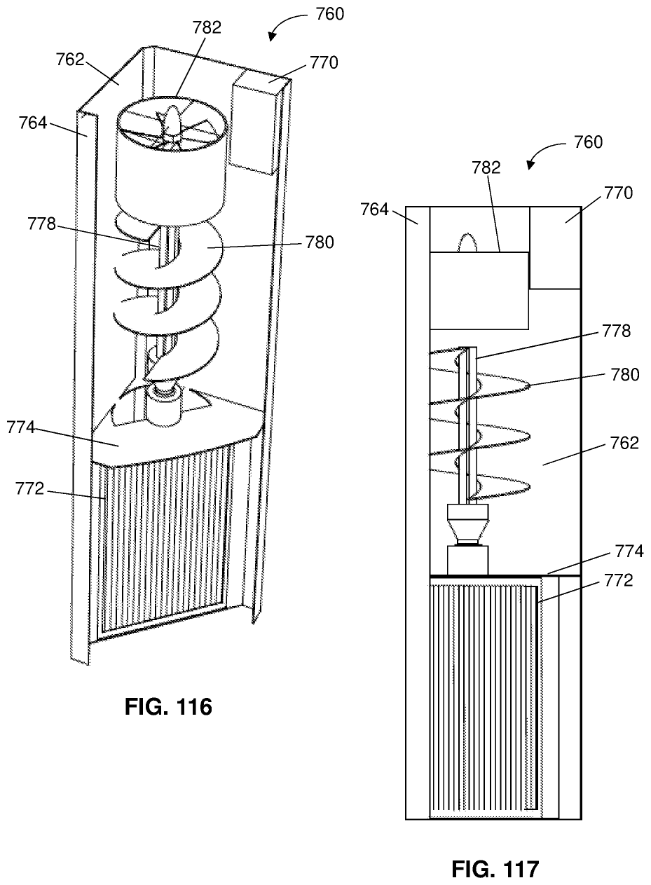

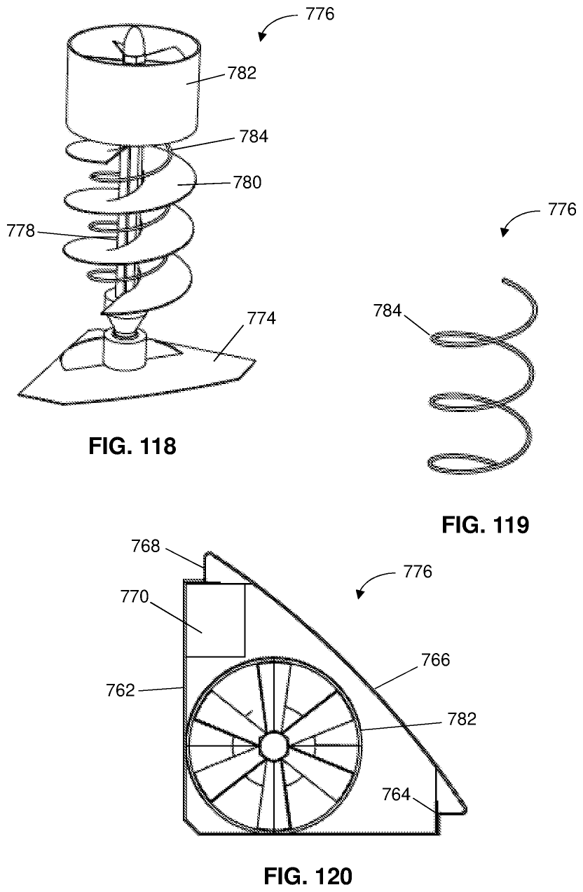

FIGS. 114-120 are perspective, partial and cross-sectional views of an exemplary air purifier system 760 in the form of a corner unit. In some embodiments, the system 760 can be mounted in the corner of a commercial or residential elevator. However, the system 760 can be used in different environments where corner installation is preferable. The internal helical path formed in the purification chamber can be about 34.7 inches long. The unit is designed to capture and kill aerosolized pathogens circulating in an elevator car by drawing in air from the bottom of the unit and producing filtered and irradiated air from a ceiling height outlet on the top of the apparatus, distributing clean air to the car. The air enters though the intake, is drawn through HEPA filters, passes through a helical ramp air chamber with UV-C irradiance, and then exits through a top level outlet. The unit is designed to be mounted in a corner of the elevator car approximately at head height.

The system 760 includes a housing 762 formed by two substantially flat or planar sections angled by about 90 degrees relative to each other such that that housing 762 can be installed in a corner. The ends of each of the planar sections include a planar flange 764 extending the height of the housing 762 and protruding perpendicularly relative to the planar sections. The system 760 includes a removable front panel or door 766 having an outwardly curved front face. Side edges of the door 766 include inwardly directly flanges 768 configured to engage with the flanges 764 of the housing 762 such that the door 766 can be removably secured to the housing 762. A junction box 770 can be mounted to one of the inner walls of the housing 762.

The bottom of the housing 762 includes a filter 772 positioned in the hollow interior. Air can be drawn into the system 760 from the bottom to initially pass through the filter 772 before entering into the hollow interior of the housing 762. Above the filter is a platform 774 supporting the purification chamber 776. The platform 774 directs air from the hollow interior of the housing 762 behind the filter 772 into the purification chamber 776. The chamber 776 is fabricated from, e.g., aluminum, sheet metal, or the like, and defines a substantially cylindrical, elongated configuration with a hollow interior. The chamber 776 includes a light source 778 extending substantially the entire length of the chamber 776 and aligned along a central longitudinal axis of the chamber 776. An air guide 780 in the form of a continuous helical configuration extends around the light source 778 to guide air in a helical path 784 around the light source 778 for purification. A fan 782 is positioned above the light source 778 and acts to draw air into the system 760, as well as outputting purified air from the open top of the housing 762. In some embodiments, the system 760 can include a secondary filter or louvers at the top of the housing 762.

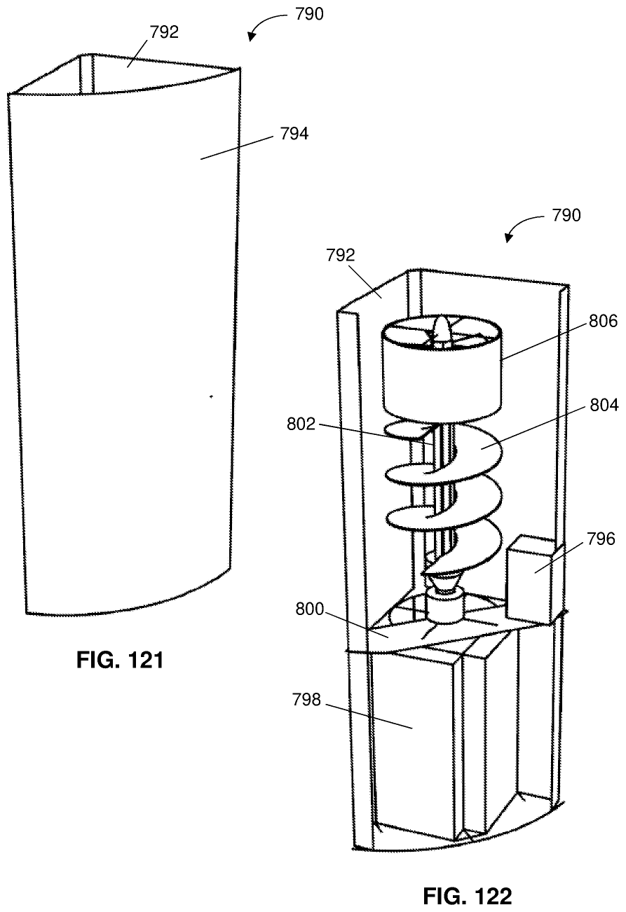

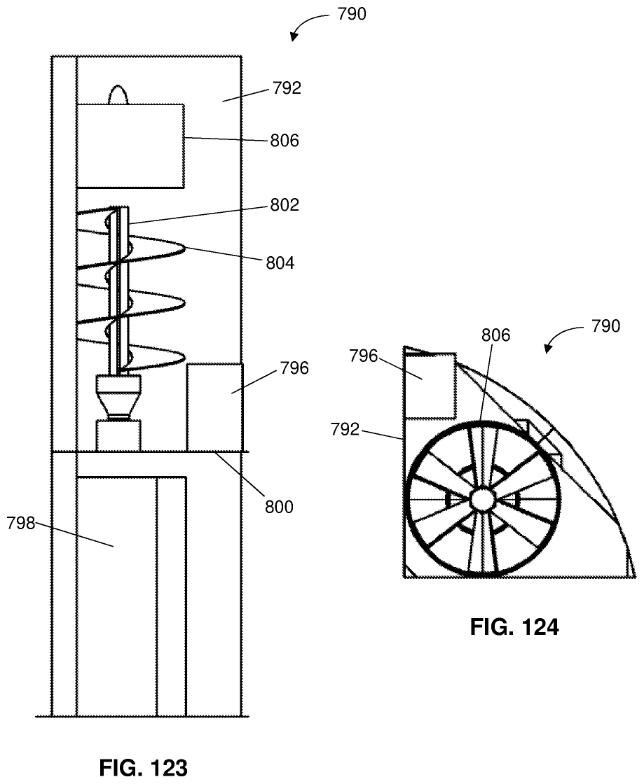

FIGS. 121-124 are perspective, partial and cross-sectional views of an exemplary air purifier system 790 in the form of a corner unit. The system 790 can be substantially similar to the system 760, except for the distinctions noted here. The system 790 includes a similar housing 792 with curved door 794. A junction box 796 is mounted to the housing 792 inner wall. Rather than a single filter, the system 790 includes two filters 798 positioned at about 90 degrees relative to each other for filtering of intake air. The platform 800 supports the purification chamber and guides air into the purification chamber. The purification chamber includes a light source 802 with an air guide 804 forming a helical configuration around the light source 802. A fan 806 is positioned over the light source 802 to guide air through the system 790.

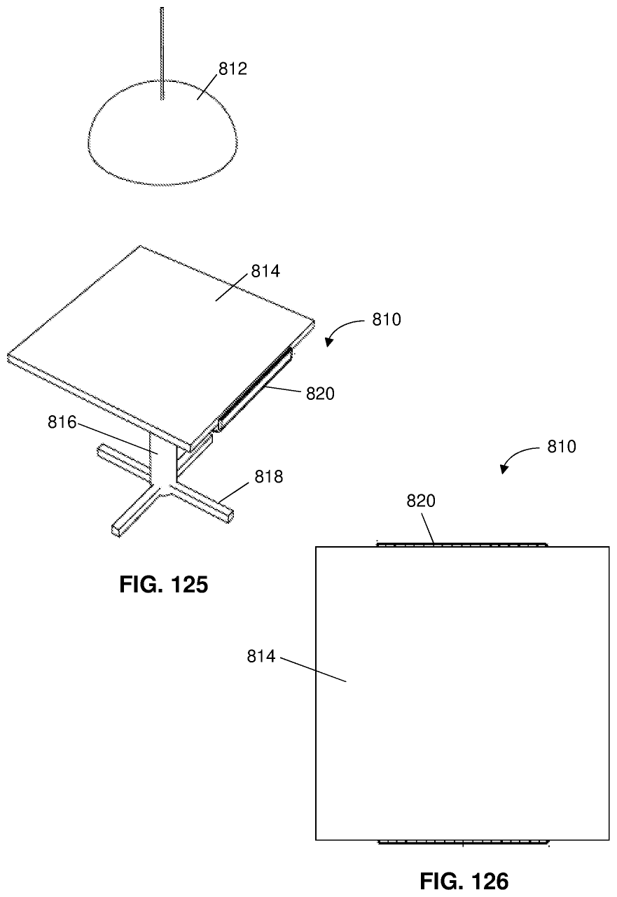

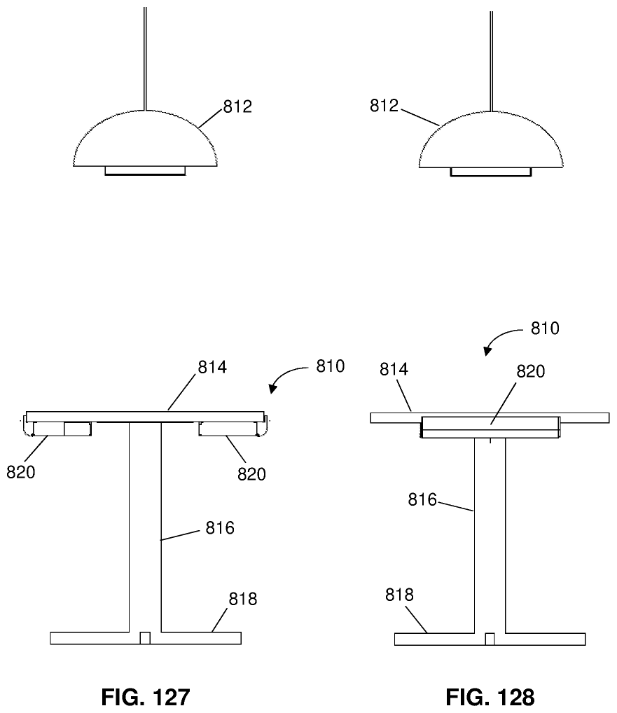

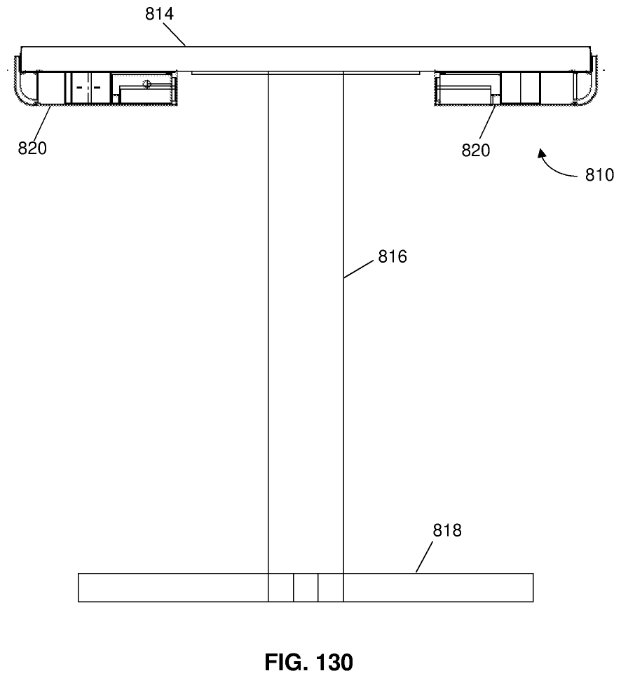

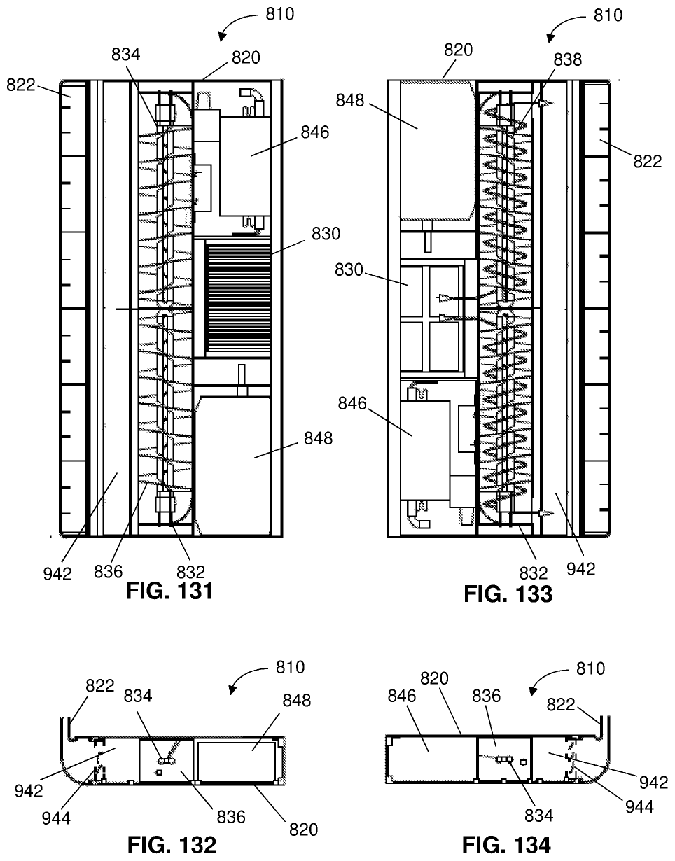

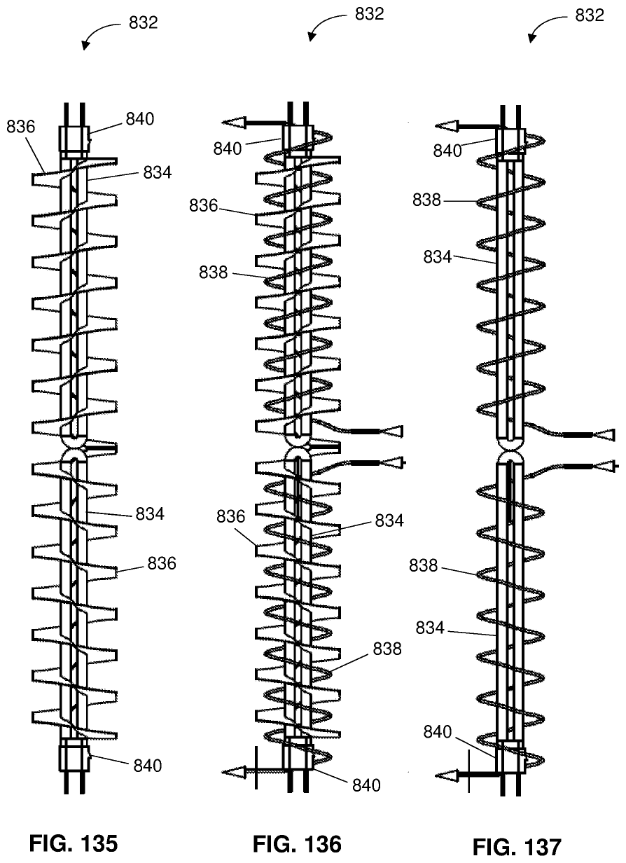

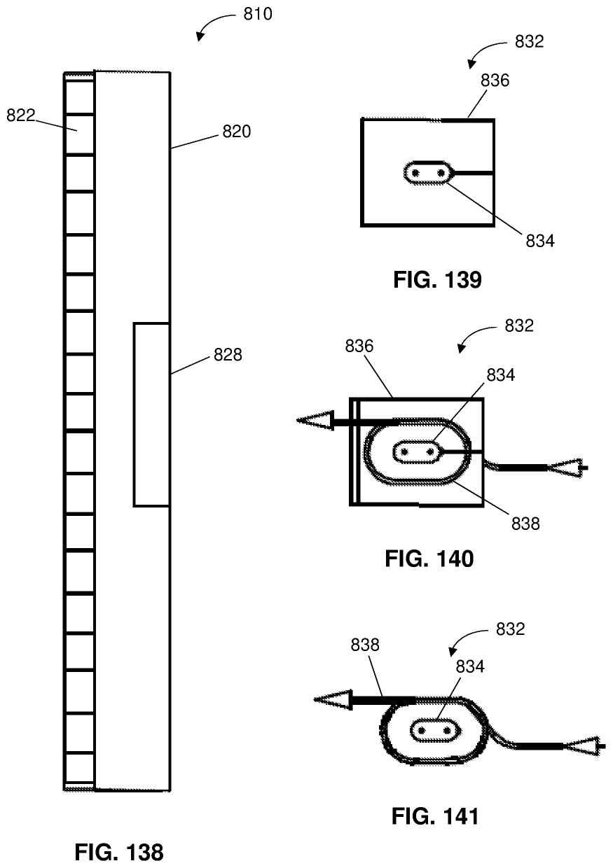

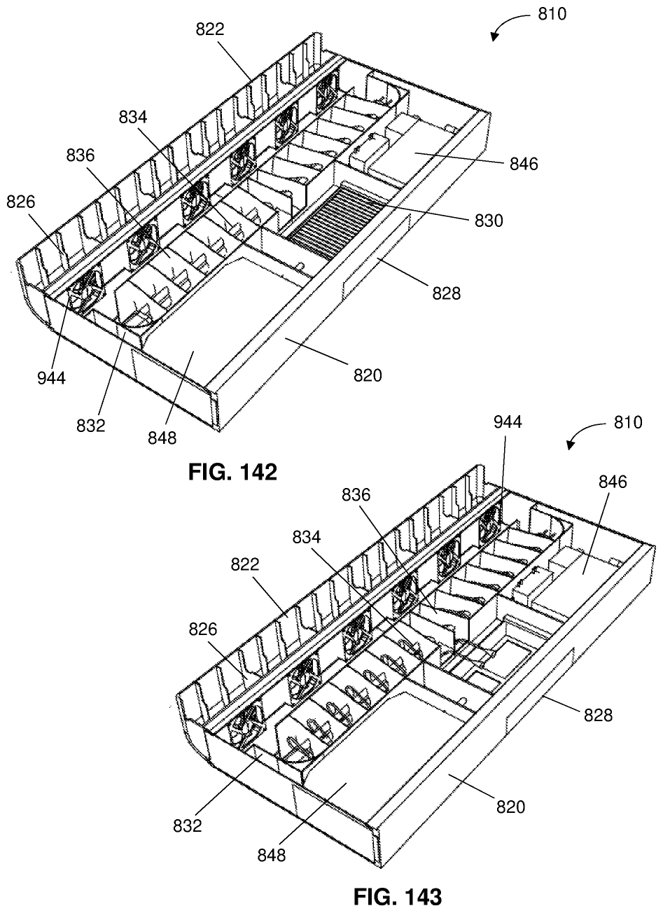

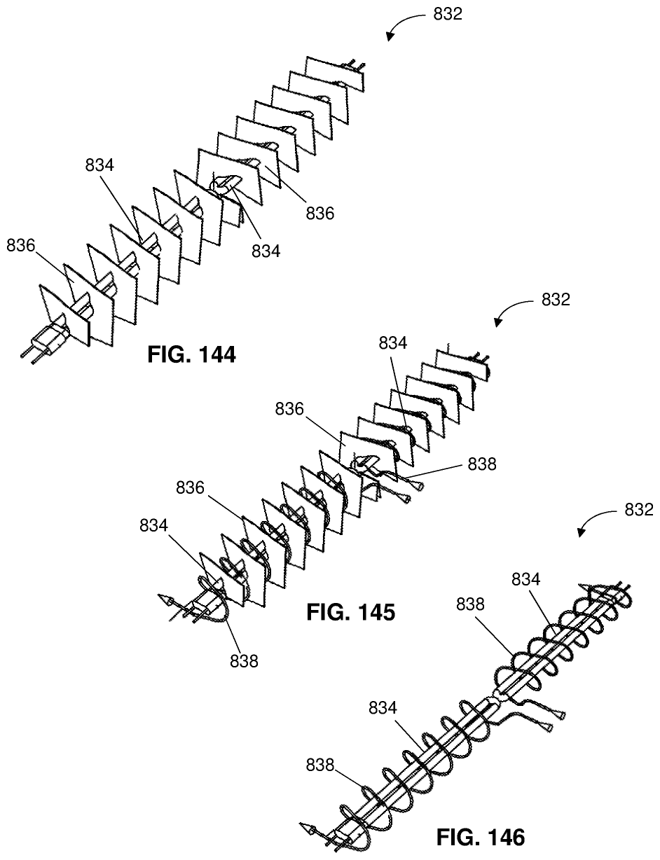

FIGS. 125-146 are perspective, side, front, partial and cross-sectional views of an exemplary air purifier system 810 in the form of an under table unit. For example, the system 810 can include two units installed on opposing sides of a table to purify air above the table where individuals may be sitting. In some embodiments, a unit can be installed on each side of the table to accommodate individuals sitting on all sides of the table. A light 812 can positioned over the table 814 (which generally includes top, side and bottom surfaces), a support post 816, and support legs 818. A system 810 can be installed such that the majority of the system 810 is positioned against the bottom surface of the table 814, and a portion of the system 810 extends over the bottom edge and against the side surface of the table 814. The system 810 does not extend beyond the plane defined by the top surface of the table 814, thereby preventing interference with normal use of the table 814.

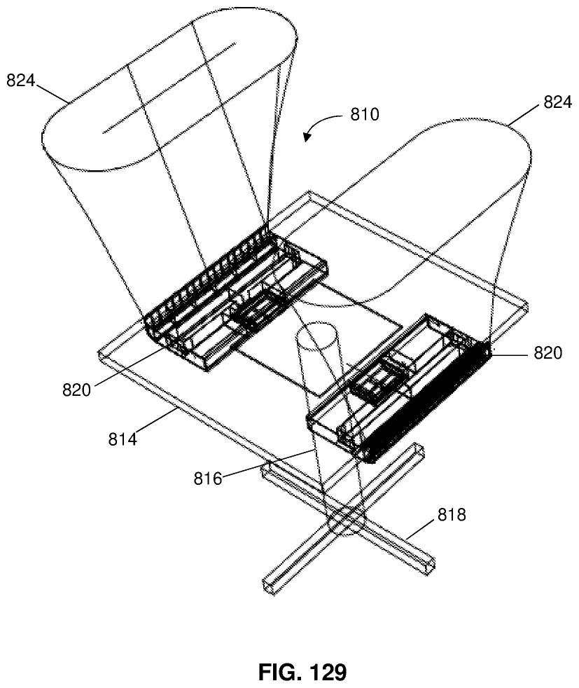

The system 810 includes a housing 820 that defines an L-shaped configuration which allows for positioning of the housing 820 around the bottom edge of the table 814 and against both bottom and side surfaces. The system 810 can be configured to intake air from below the table 814, purify the air, and output the purified air through outlet louvers or openings 822 such that the purified air is directed upwardly from the side edges of the table 814 and over the table 814 where individuals are seated. The area 824 of purified air is diagrammatically illustrated in FIG. 129. The openings 822 can be formed on the upwardly directed portion of the housing 820 extending substantially perpendicularly from the horizontally directed portion of the housing 820 which encloses the purification components. The openings 822 can include louvers 826 to guide the direction of the output air.

The housing 820 includes an intake port or opening 828 at the rear surface of the housing 820. In some embodiments, additional intake ports can be added along the perimeter of the housing 820. The drawn in air is initially purified by a filter 830 (e.g., a HEPA or MERV 13 filter), and subsequently enters the purification chamber 832. The chamber 832 extends the width of the housing 820 and is defined by, e.g., sheet metal or aluminum inner walls. In some embodiments, two chambers 832 extending from the side edges to the central point of the housing 820 can be combined to form a chamber that extends the entire inner width of the housing 820. The chamber 832 includes a light source 834 and an air guide 836 in the form of planar, ramped surfaces positioned around the light source 834 to define a continuous, helical pathway 838 for the airflow. Connector pins 840 at the end of each light source 834 can electrically connect the light source 834 to a corresponding power socket in the housing 820.

As illustrated in FIG. 133, after filtering, air travels towards the chambers 832 at a central area of the housing 820, and enters each respective chamber 832 in a perpendicular direction relative to the longitudinal axis of the chamber 832. The air guides 836 direct air in opposing directions within each chamber 832 such that purified air exits one chamber 832 on one side of the housing 820 and purified air exits the second chamber 832 on the opposing side of the housing 820. Such purified air enters into the same output space 842 that includes multiple fans 844 positioned in a spaced manner along the width of the housing 820. The fans 844 direct the purified air into the openings 822 for output by the system 810. The system 810 includes electrical components 846 and a power source 848 for operation of the system 810. Thus, the system 810 can draw in air around and below the table 814, purifies the air, and outputs the purified air over the table 814 such that individuals sitting at the table can breathe in the purified air.

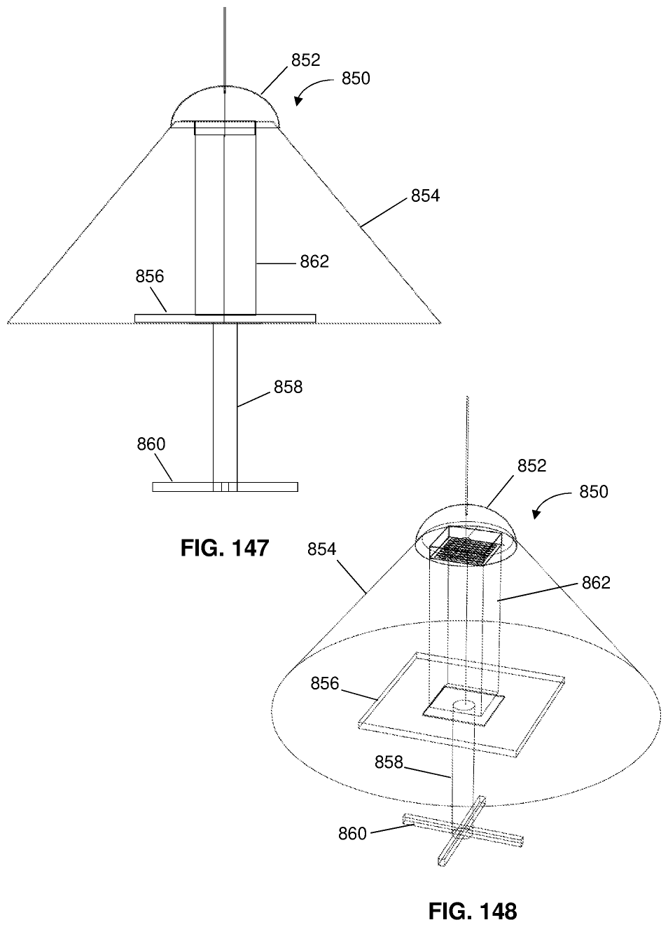

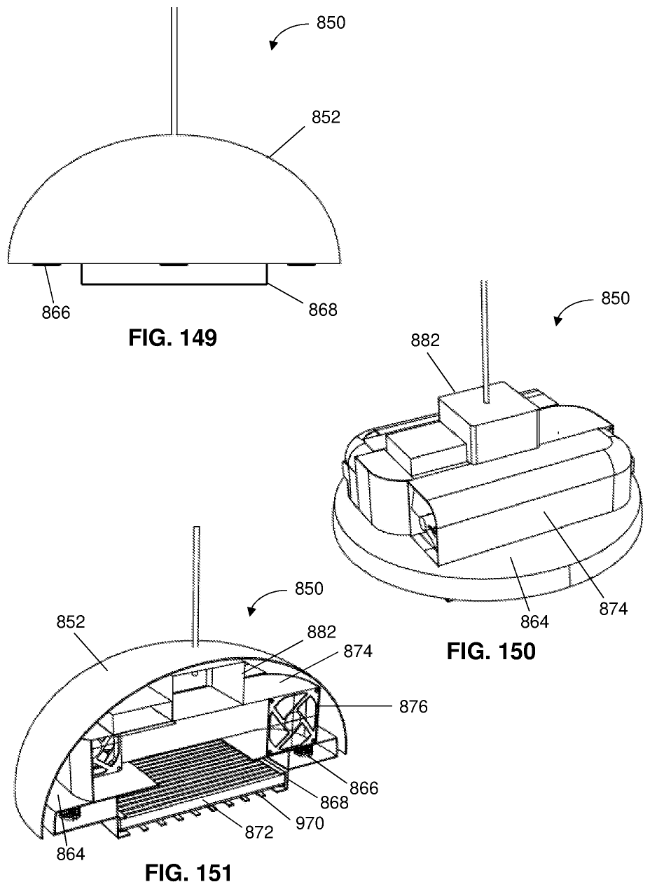

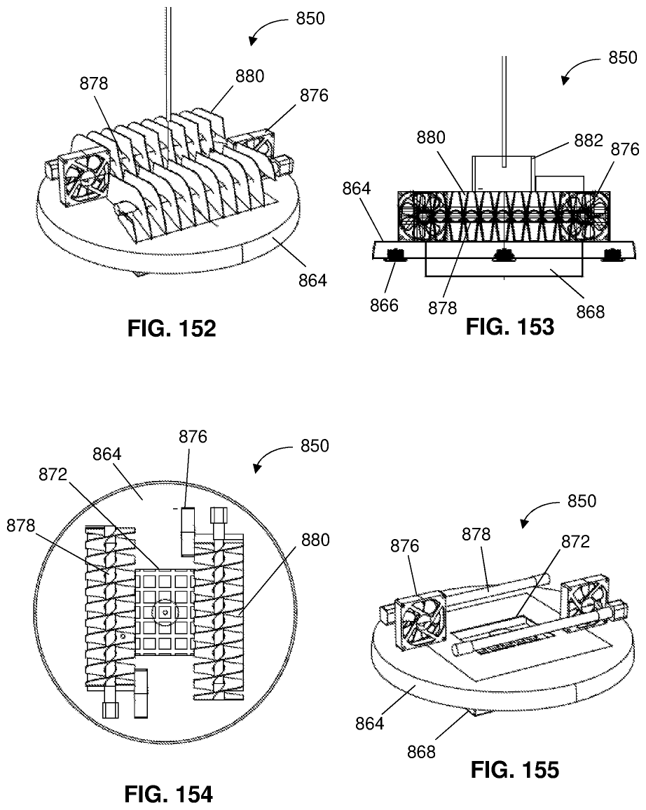

FIGS. 147-155 are perspective, partial and cross-sectional views of an exemplary air purifier system 850 in the form of an over table unit. In some embodiments, the system 850 can serve a table capable of accommodating 4 individuals, approximately 70 sq/ft. The output of the system 850 can be about 20 cfm and the light source can include four 18 Watt lamps. The system 850 can be hung over a table at a house, office, or restaurant. The unit is designed to capture and kill aerosolized pathogens circulating close to an individual by drawing in air from the bottom of the unit and producing filtered and irradiated air from one of two outlets on the bottom of the apparatus, distributing clean air to the mouth of a seated person. The air enters though the intake, is drawn through a HEPA filter, passes through one of four helical ramp air chambers with UV-C irradiance, and then exits through a bottom outlet. The unit can be hardwired or plugged into a power source/outlet. The system 850 can incorporate six LED downlights for illumination of the table below.

The system 850 can be installed into a light 852 capable of being connected to a ceiling. As illustrated in FIGS. 147-148, the light 852 provides an area 854 of illumination over the table 856 and the surrounding area. The table 856 includes a support 858 and legs 860. The system 850 provides an area 862 of purified air down and over the table 856. Although illustrated as being directly over the table 856, it should be understood that the area 862 can extend beyond the edges of the table 856 to provide purified air to individual sitting at the table 856. The lamp 852 acts as a housing for the system 850, enclosing all purification components within its hollow interior.

The system 850 includes a base 864 having a hollow interior with sockets 866 capable of at least partially receiving LED light bulbs radially positioned along the outer section of the base 864. The LED light bulbs can therefore illuminate the area below the system 850. The base 864 includes a radial, downward extension 868 (e.g., a filter housing) with an array of openings 870 for intake of air into the system 850. The extension 868 is configured to support a filter 872 adjacent to the openings 870 for filtering air entering the system 850. Mounted over the top surface of the base 868 and over the filter 872 are two purification chambers 874. The chambers 874 are formed from curved and linear sheet metal walls to guide air from the space over the filter 872 into the respective purification passages.

Each chamber 874 includes a dedicated fan 876 mounted at the entry point to the chamber 874. Each chamber 874 includes a light source 878 extending the length of the linear section of the chamber 874, and an air guide 880 forming a double helix pathway around the light source 878. Air is thereby drawn into the system 850 from the bottom surface directly over the table, filtered, purified in the respective chamber 874, and output from the distal ends of the chambers 874 on opposing sides of the lamp 852. The inner surface of the lamp 852 is curved and provides guidance for the purified air to be directed downward over the table. A junction box 882 or electronics enclosure can be provided above the chambers 874.

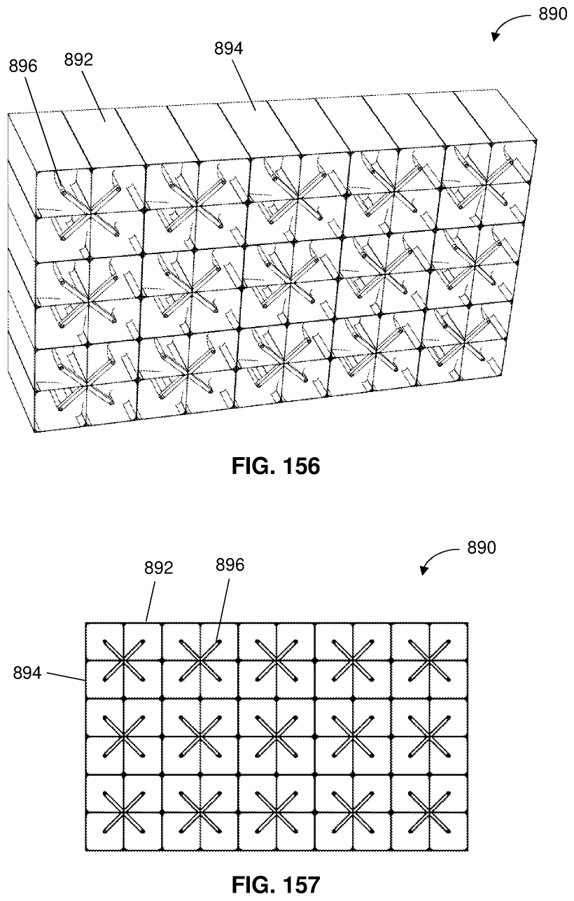

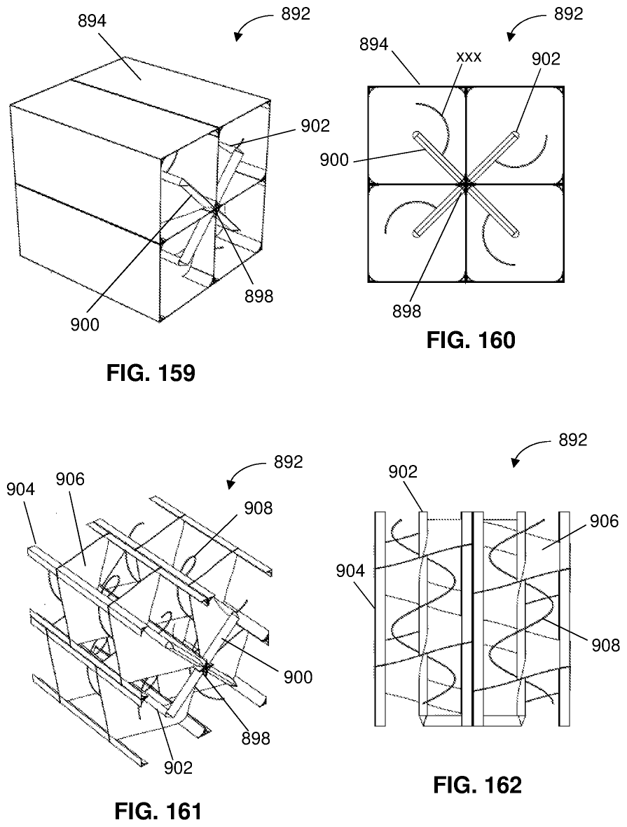

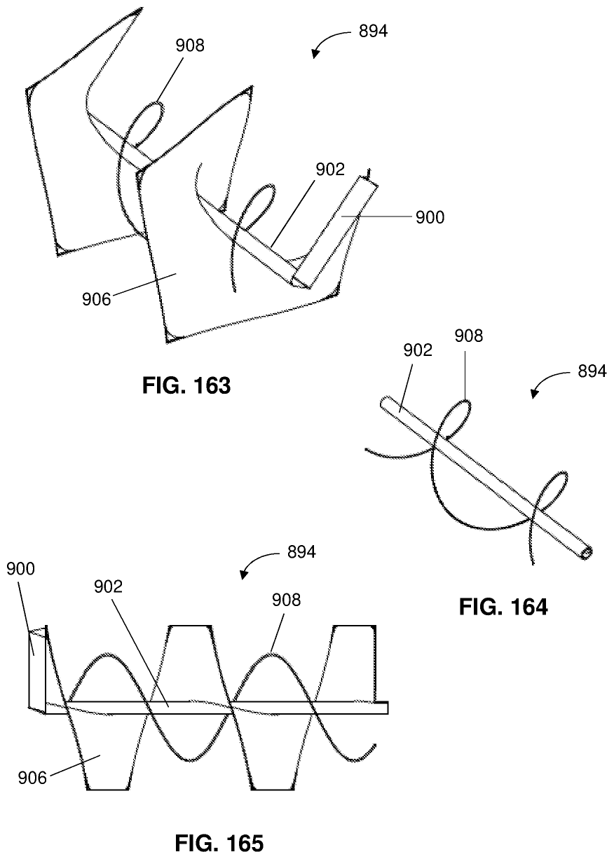

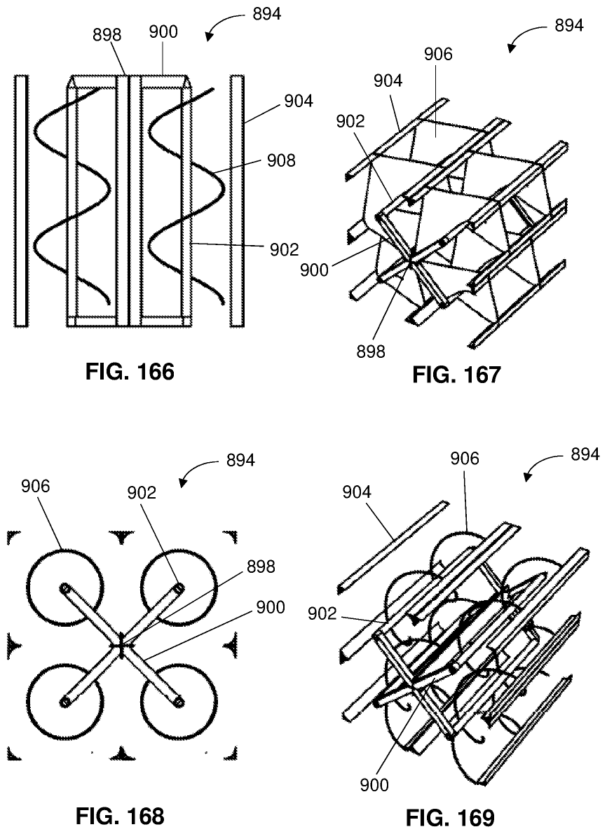

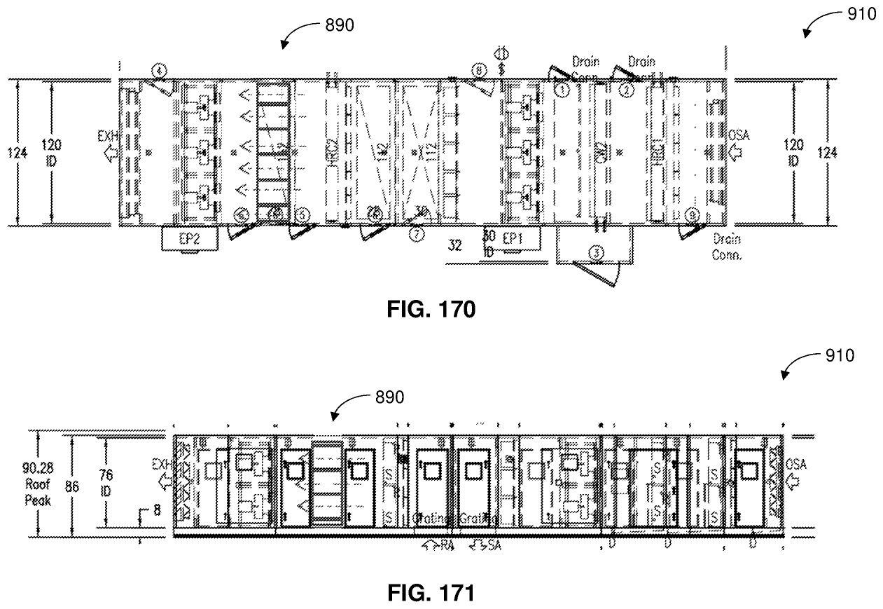

FIGS. 156-171 are perspective, partial and cross-sectional views of an exemplary air purifier system 890 in the form of a high output unit. The system 890 includes an array of fans and purification chambers that can be about 120″×72″×27″ in size. In some embodiments, the system 890 can be in the form of three modules high by five modules wide. Each light source can be about 24 inches in length and can be a GML435 high output lamp, e.g., GPH610T5L/HO four pin 16.2 Watt UV with 175 μW/cm² at 1 m. The minimum area of the duct can be about 5.5″×12″ (about 66 sq. in.) with an average path length of about 51 inches. Four units can be used to define a 24″×24″ set for 264 sq. in. open area. Assuming 800 ft/min, the system 890 can achieve about 23.1 mj/cm² for a 99.9999% kill rate. In some embodiments, one lamp can be used for each 24″×24″×27″ module. In some embodiments, the module's housing or case can be aluminum to increase reflectivity of the lamp by 30-60%. In some embodiments, a four helix sub-module of 12″×12″ can be used. In some embodiments, four two turn helical paths can be formed by the air guides.

The system 890 can include any number of modules 892, with each module 892 defined by four purification chambers 894 connected together to form a square arrangement. Each chamber 894 defines a substantially square cross-section and rectangular configuration with a hollow interior. Each module 892 includes a light source assembly 896. The assembly 896 includes a central strut 898 that connects each of the innermost corners of the chambers 894 together. From the central strut 898, the system 890 includes four extensions 900 at each of the opposing ends of the central strut 898. The extensions 900 extend perpendicularly from the central strut 898 and are angled about 90 degrees from each other, thereby forming an X-shaped configuration at both ends of the strut 898. The distal ends of the extensions 900 receive and support a light source 902. In particular, the extensions 900 substantially align the light source 902 with a central longitudinal axis of the respective chamber 894. Each chamber 894 includes corner support brackets 904 for supporting assembly of the walls of the chamber 894.

Each chamber includes an air guide 906 positioned radially around the light source 902 to form a helical pathway 908 for air flowing through the system 890. In some embodiments, the air guide 906 can be in the form of a flat ramped structure. In some embodiments, the air guide 906 can be in the form of a round ramped structure. Each module 892 therefore defines four separate pathways 908 along which air is purified, and the array of modules 892 (modifiable to include more or less modules 892) can be used to purify a large amount of air. In some embodiments, the 890 can be incorporated into an HVAC unit 910 such that a fan associated with the unit 910 drives air through the system 890. A filter associated with the unit 910 can also provide filtration of the air in addition to the purification provided by the system 890.

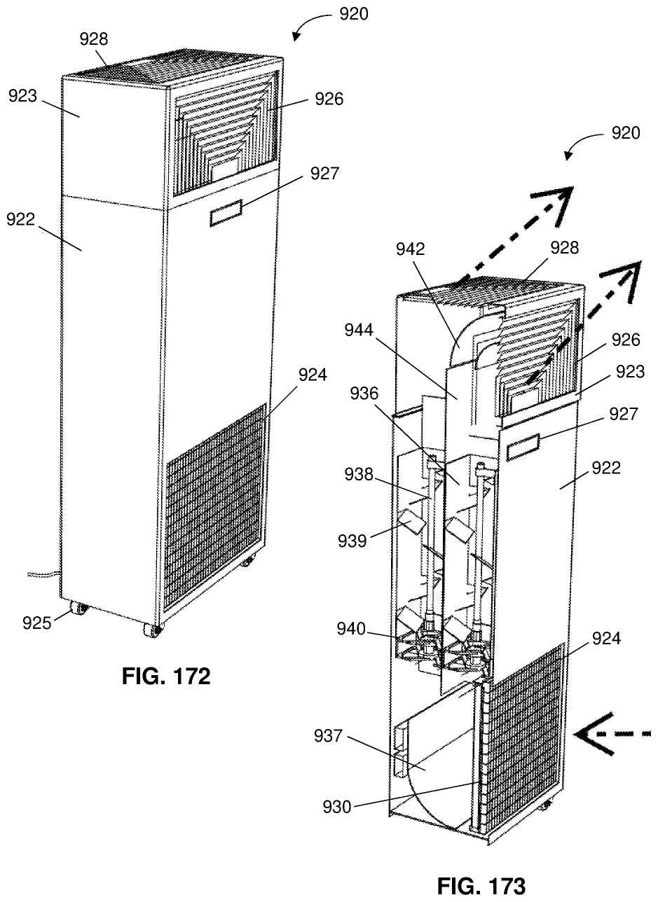

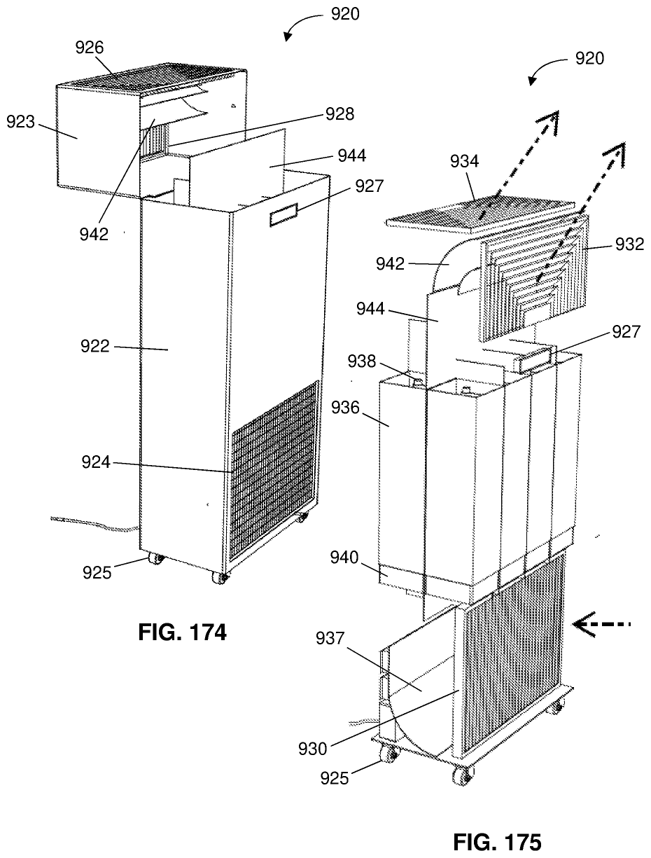

FIGS. 172-175 are perspective, partial and cross-sectional views of an exemplary air purifier system 920 in the form of a standalone or wall hung unit. In some embodiments, the system 920 can be an eight lamp system with an output of about 1,000-1,600 cfm (e.g., about 1,360 cfm). The system 920 can either be positioned on the floor or be mounted to a wall. Air outlets can face upward and forward for better room distribution. In some embodiments, eight 48 Watt germicidal UV-C lamps (GPH436T5/HO/4P) operating at 0.12 mW/cm² at 1 m can be used. In some embodiments, four or eight tubes can be used. A continuously variable 141×51 mm DC PWN fan offering 0-238 cfm can be used, with an assumption of about 125 cfm providing for continuous quiet operation. Such operation would kill about 99.9999% of COVID-19 and other viruses/pathogens in the air. A standard 15×20×1 inch MERV 13 filter can be used.

In some embodiments, the system 920 can be an approximately 1,000 cfm air purifier including eight aluminum purification chambers, each with one 48 Watt GPH436/T5 four pin single ended UV-C bulb and a 140×10×38 mm DC PWM axial fan with variable speed control and capable of 250 cfm each. The system 920 can be operated with four or eight chambers, and can continuously vary speeds of the fans to tune the unit to the room's size and/or air changes. The overall unit size can be about 12 inches (depth)×24 inches (width)×58 inches (height), including the casters. The top and front face louvers can include an open area of about 3 sq/ft, allowing the outlet velocity to be low (e.g., about 330 ft/min) to distribute air upward and outward across a large area without strong air currents. An internal plenum can be used to distribute the flow of air evenly to the front and top grilles or louvers. Each chamber can be about 140 mm in height with a spiral array of deflectors around the lamp to create turbulent flow within the chamber and around the light source. A detailed discussed of the deflectors is provided herein with reference to corresponding figures. Eight DC PWM axial fans of about 140×38 mm can be used in a dedicated manner for each chamber, each capable of about 250 cfm. Ballasts can be used for UV-C lamps, and one or more scoops within the housing can be used to direct the flow of intake air through the system 920. A filter of about 16×20 inches of 1″ or 2″ depth can be used for an open intake area of about 2.4 sq/ft. The system 920 includes a user interface at a front face to allow for control of the system 920 and to provide status indicators to the user.

The system 920 can be used in a commercial, institutional, office, hotel or school setting, as an example. The unit is designed to capture and kill aerosolized pathogens circulating in a room by drawing in air from the bottom of the unit and producing filtered and irradiated air from outlets on the top and side of the apparatus, distributing clean air to the room. The air enters though the intake, is drawn through a HEPA filter, is drawn through one of six or eight high speed mini fans, passes through one of six or eight helical ramp air chambers with UV-C irradiance, and then exits through the outlets. The unit can be mounted on a wall of most constructions, or can remain as a floor standing unit. The unit can be controlled individually or as part of an array when used in large spaces.

The system 920 includes a housing 922 defining a substantially rectangular configuration. The housing 922 includes an array of intake openings 924 formed in the front surface at or near the bottom of the housing 922. In some embodiments, the housing 922 can include a removable panel or door to provide access to internal components of the system 920. In some embodiments, the system 920 can include a top housing 923 pivotably connected to the housing 922 such that the top housing 923 acts as a lid to expose internal components for maintenance. In some embodiments, the housing 922 can include casters 925 mounted to the bottom surface to allow for convenient transport of the system 920. The system 920 can include a user interface 927 (e.g., a graphical user interface) at the front surface of the housing 922 to allow for control of the system 920 operation and to provide visual indicators to the user regarding the status of operation. The housing 922 includes an array of outlet openings 926 at or near the top of the housing 922 in the front surface, and can optionally include additional outlet openings 928 in the top surface of the housing 922. A filter 930, 932, 934 can be positioned within the housing 922 adjacent to each of the respective openings 924, 926, 928 for filtering both intake and outlet air. In some embodiments, only the intake air can be filtered. Once filtered, the intake air enters a space below the purification chamber 936 array. The housing 922 can include an internal scooped louver or panel 937 curving upward towards the chambers 936 to direct flow of intake air upward and into the respective chambers 936.

The system 920 can include eight chambers 936 joined together and sharing inner walls. Each chamber 936 can define a substantially rectangular, hollow structure oriented vertically within the housing 922. Each chamber 936 includes a light source 938 vertically positioned and aligned along the central longitudinal axis of the chamber 936. The chambers 936 each include air guides 939 in the form of deflectors for deflecting at least a portion of the air traveling through the chamber 936 from a linear path along the light source 938. The air guides 939 therefore increase the pathway of the air traveling through the chamber 936 by introducing turbulent flow, resulting in mixing of the airflow. Such increase in the pathway increases the dwell time, which results in a higher rate of purification. An array of fans 940 dedicated to each specific chamber 936 is positioned below the chambers 936 and above the filter 930. After purification, the fans 940 drive the air upwards for output from the system 920. The system 920 includes a central, planar wall 944 extending vertically in-between the groups of chambers 936, such that purified air from four chambers 936 flows on one side of the wall 944 and purified air from the other four chambers 936 flows on the opposing side of the wall 944. A curved or scooper louver 942 connects to the top of the wall 944 and directs purified air from one group of chambers 936 out of the openings 926, while the remaining purified air on the opposing side of the wall travels out of the openings 928. Purified air can thereby be provided from both the top and front of the system 920 to reach multiple areas in the surrounding space (e.g., substantially evenly distribute purified air in the surrounding space).

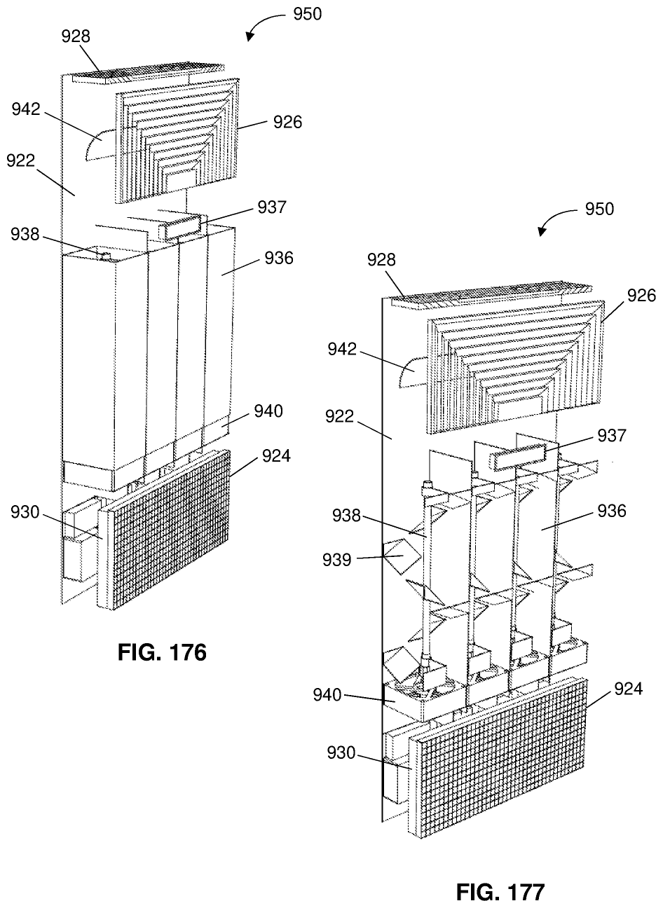

FIGS. 176-177 are perspective and partial views of an exemplary air purifier system 950 in the form of a standalone or wall hung unit. The system 950 can be substantially similar to the system 920, except for the distinctions discussed herein. Thus, similar reference numbers refer to like structures. Rather than eight light sources, the system 950 can include four 48 Watt light sources and provides an output of about 680 cfm. The array of purification chambers 936 is therefore smaller, with only four chambers 936 aligned in a row (as compared to eight chambers 936 in the system 920). Although not fully illustrated, the system 950 can include a housing 922 with a top housing section pivotably connected to the housing 922 for access to the internal components of the system 950.

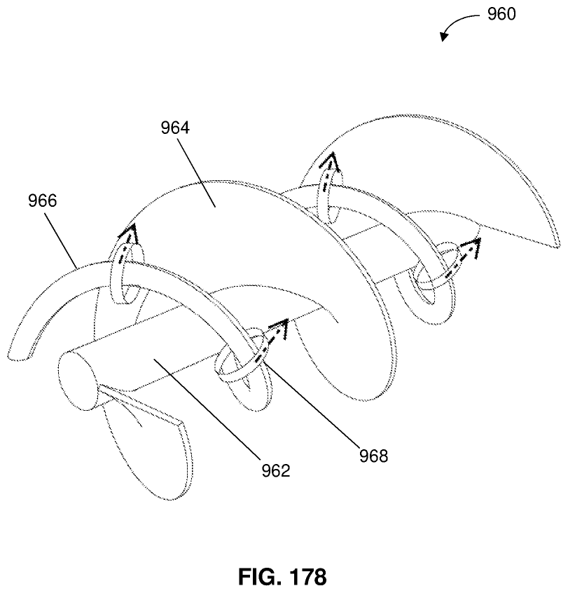

FIG. 178 is a perspective view of a static mixer 960 (e.g., air guide assembly) capable of being incorporated into any of the exemplary air purifier systems discussed herein. The mixer 960 includes a light source 962 and a helical air guide 964 radially positioned around the light source 962 such that the air travels in a helical pathway 966. As the air travels along the pathway 966, the mixer 960 creates tumbling 968 of the air (e.g., in directions perpendicular or tangential to the pathway 966), bringing the outer air to the center and the inner air to the outside of the pathway 966. The mixer 960 therefore ensures air traveling along the pathway 966 is shifted sufficiently to maximize exposure of the air to UV illumination. Such tumbling 968 occurs in each of the air guide configurations discussed herein, and is not limited to the cylindrical, helical configuration.

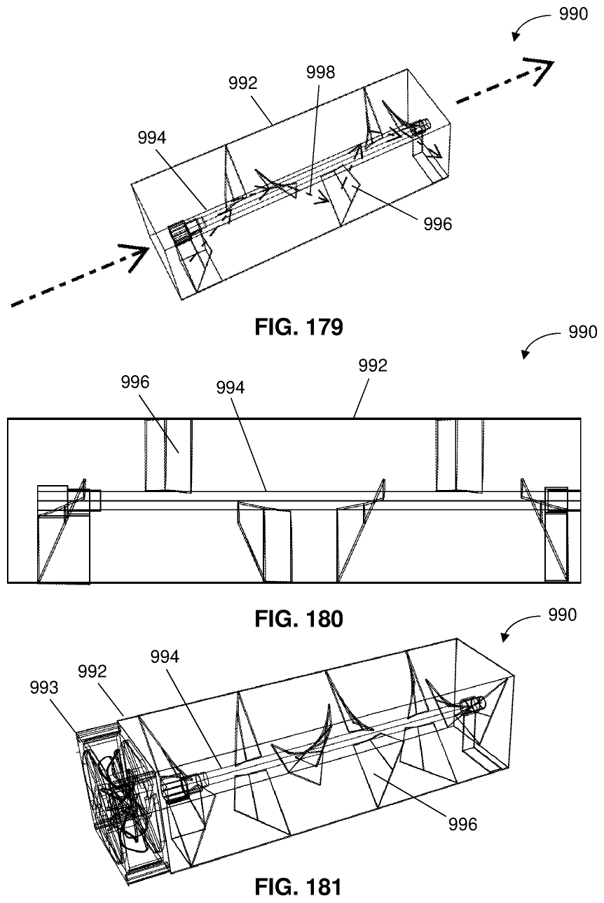

FIGS. 179-181 are perspective and side views of an exemplary purification chamber 990 that includes air guides to create swirling airflow in the pathway. The chamber 990 can replace any of the purification chambers discussed for the systems herein. The chamber 990 includes a housing 992 defining a hollow interior, and an axial fan 993 positioned at one end of the housing 992 and aligned with the central longitudinal axis of the housing 992. A light source 994 extends along the central longitudinal axis of the housing 992. Air guides 996 in the form of spiral fins are mounted to the inner walls of the housing 992. Rather than surrounding the light source 994, the air guides 996 are radially positioned around the light source 994 at different angles to create swirling in the airflow pathway 998. The air guides 996 can extend from the inner housing wall to the light source 994, abutting at least a portion of the light source 994. However, each air guide 996 can be both radially and laterally offset from the next adjacent air guide 996.

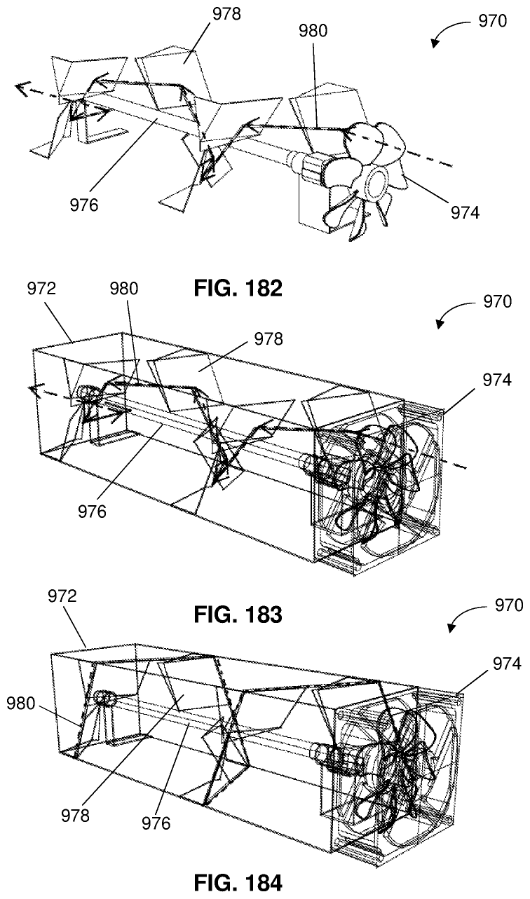

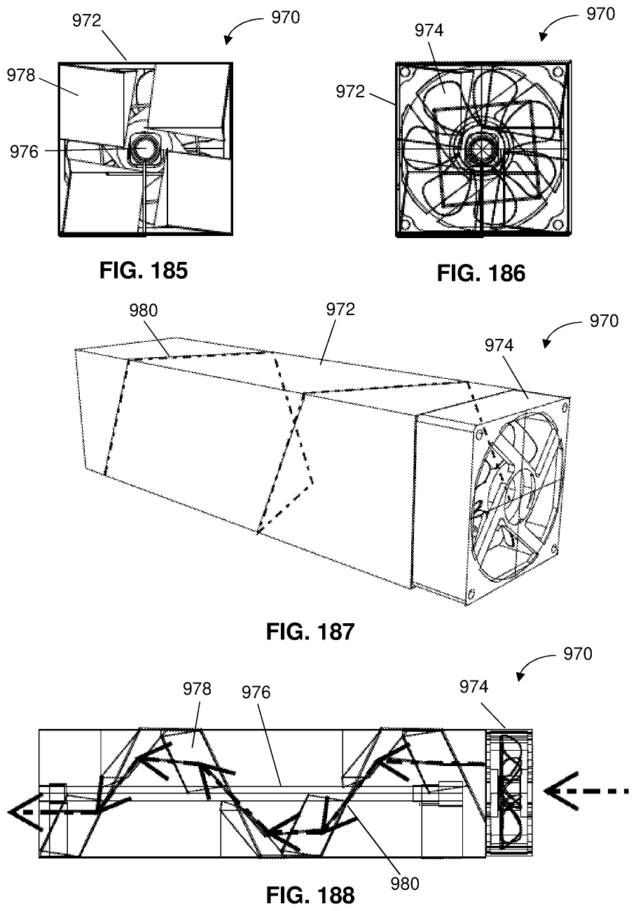

In some embodiments, the faceted spiral planes of the air guides 996 can be at angles of about 24 degrees from the axis that will create a swirling effect (e.g., relative to the central longitudinal axis of the housing 992 along which airflow passes). The spiral fins can be less obstructive and smoother than the deflectors of FIGS. 182-188 (which have an angle of about 26 degrees) to provide for a smoother, spiral effect in the airflow rather than a turbulent mixing of the airflow. The air guides 996 can be doubled and rotated about 180 degrees along the central longitudinal axis of the housing 992 to elongate the dwell time and mix the air. For example, FIGS. 179-180 show single-sided air guides 996 which extend from the inner wall of the housing 992 to the light source 994, and FIG. 182 shows double-sided air guides 996 which extend from the inner wall of the housing 992 to the light source 994, and further extend around the light source 994 to the opposing inner wall of the housing 992. Adding more fins can be dependent on the velocity and fan power required under different circumstances or applications.

FIGS. 182-188 are perspective, partial, front, rear and cross-sectional views of an exemplary purification chamber 970 that includes air guides to create turbulent airflow in the pathway. The chamber 970 can replace any of the purification chambers discussed for the systems herein. The chamber 970 includes a housing 972 defining a hollow interior, and an axial fan 974 positioned at the proximal end of the housing 972. A light source 976 extends along a central longitudinal axis of the chamber 970. Air guides 978 in the form of inclined planes or deflectors that are mounted to the inner walls of the housing 972 and are spaced from the light source 976. Thus, rather than surrounding the light source 976, the air guides 978 are radially positioned around the light source 976 at different angles to create turbulence in the airflow path 980. In some embodiments, the air guides 978 can extend from a section being adjacent to the light source 976 (e.g., a corner of the substantially square or rectangular panel), and away from the light source 976.

The air guides 978 provide a spiraling array of inclined planes surrounding the light source 976 inside of a reflective chamber 970, deflecting approximately 15-20% of the air at each location and redirecting the air to mix with the central air flow. At least a portion of the straight flow path is therefore redirected with the air guides 978 to create turbulent flow, thereby encouraging mixing and increasing dwell time within the chamber 970. The inclined planes direct airflow across the straight flow path and create turbulence to mix the air and completely irradiate all of the air passing through the chamber 970. For example, the substantially central air flow travels the closest to the light source 976 and a portion of such central air flow may travel a straight path along the light source 976. However, due to the proximity of the pathogens in such air flow to the light source 976, a higher dose of the UV light ensures all pathogens are killed. Simultaneously, the air guides 978 ensure mixing of air traveling through the chamber 970 which may be further spaced from the light source 976, thereby increasing dwell time and varying the proximity of the pathogens to the light source 976. Air can enter through the DC PWM axial fan, but could be used with a remote blower or duct in other applications. The geometry of the square spiral air guides 978 determines the location of the angled planes, which act as deflectors of 15-20% of the air. The fins deflect flow and create turbulence to mix air in the chamber around the central UV-C bulb.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. An air purifier system, comprising:
a housing including at least one intake opening and at least one outlet opening;
a light source disposed within the housing, the light source defining a light source length and configured to emit light of a wavelength capable of killing pathogens in air passing the light source; and
an air guide positioned around the light source, the air guide redirecting flow of air around the light source in a pathway having a length longer than the light source length.

2. The system of claim 1, wherein the at least one intake opening and the at least one outlet opening is an array of circular openings, an array of rectangular openings, an array of elongated slots, an individual circular opening, or an individual rectangular opening.

3. The system of claim 1, wherein the light source is an ultraviolet (UV-C) lamp or a light-emitting diode (LED).

4. The system of claim 3, wherein the wavelength is 253 nm to 280 nm, inclusive.

5. The system of claim 1, comprising a high efficiency particle air (HEPA) filter or a minimum efficiency reporting value (MERV-13) filter disposed within the housing.

6. The system of claim 1, comprising a fan disposed within the housing and configured to draw the air into the housing through the at least one intake opening, and output purified air out of the at least one outlet opening.

7. The system of claim 1, comprising a microwave emitter configured to emit microwaves into the housing at a frequency capable of killing the pathogens in the air passing through the housing.

8. The system of claim 1, wherein the air guide is one or two continuous helical ramps surrounding the light source, the air guide extending along the light source length.

9. The system of claim 8, wherein the pathway created by the air guide is a helical pathway.

10. The system 8, wherein the two continuous helical ramps form a clockwise helical pathway and a counterclockwise helical pathway around the light source.

11. The system of claim 1, wherein the air guide is a first set of baffles extending in a spaced manner from one inner wall of the housing, and a second set of baffles extending in a spaced manner from an opposing inner wall of the housing, the first and second set of baffles staggered around the light source along the light source length.

12. The system of claim 1, wherein the air guide includes a first air guide half and a second air guide half positioned on opposing sides of the light source, wherein each of the first and second air guide halves includes a body with a cutout configured to at least partially receive the light source, a cut extending from the cutout, and a bend line for bending of the first and second air guide halves.

13. The system of claim 1, wherein the housing comprises a door capable of being removed or pivoted to expose the light source and air guide.

14. The system of claim 1, wherein the air guide is internal walls within the housing defining a serpentine pathway for airflow within the housing.

15. The system of claim 1, wherein the light guide is inclined planes or deflectors radially spaced around the light source, the inclined planes or deflectors creating turbulent flow of air around the light source.

16. The system of claim 1, wherein the light source comprises four light sources and the air guide comprises four air guides positioned around the respective light source, the four light sources and air guides oriented at about 90 degrees relative to each other within the housing.

17. The system of claim 1, wherein the housing is configured to be installed (i) within a heating, air conditioning and ventilation (HVAC) unit, (ii) within ductwork, (iii) within a ceiling, (iv) against a ceiling, (v) within a light fixture, (vi) within a wall, (vii) against a corner, (viii) at least partially under a table, or (ix) as a freestanding unit on a floor or table.

18. A method of purifying air, comprising:
drawing air into an air purifier system through at least one intake opening of a housing, the air purifier system including (i) at least one outlet opening formed in the housing, (ii) a light source disposed within the housing, the light source defining a light source length, and (iii) an air guide positioned around the light source;
emitting light from the light source of a wavelength capable of killing pathogens in the air passing the light source; and
redirecting flow of the air around the light source with the air guide in a pathway having a length longer than the light source length.

19. The method of claim 18, wherein the air guide is one or two continuous helical ramps surrounding the light source, and the method comprises creating a helical pathway of air around the light source.

20. The method of claim 18, wherein the air guide is inclined planes or deflectors radially spaced around the light source, and the method comprises creating turbulent flow of air around the light source.
